(19) United States
(12) Patent Application Publication
(10) Pub. No.: US 2011/0238456 A1
(43) Pub. Date: Sep. 29, 2011

(54) Business Automation Techniques

(75) Inventors: Landon Ray, Santa Barbara, CA (US); Steven Schneider, Venice, CA (US)

(73) Assignee: ONTRAPORT INC., Santa Barbara, CA (US)

(21) Appl. No.: 13/071,491

(22) Filed: Mar. 24, 2011

Related U.S. Application Data
(60) Provisional application No. 61/317,295, filed on Mar. 25, 2010.

(51) Int. Cl. G06Q 10/00; G06Q 30/00; G06F 17/00

(52) U.S. Cl. 705/7.13; 705/7.29; 715/236

(57) ABSTRACT

Various technologies and techniques are disclosed for providing business automation. A business automation system is disclosed that provides contact tracking, split testing, landing page creation, tracking of the performance of printed promotions that are sent by direct mail, and automated follow-up, to name a few examples. Points can be assigned to certain activities within the system, and contacts that have the highest scores based upon those activities can be identified for additional follow-up. A browser-based designer allows for the generation of print materials such as post cards. Multiple layers can be added, manipulated, and/or rearranged. A PDF proof can also be generated. A browser based designer is also described that allows for the generation of landing pages.

### CROSS-REFERENCE TO RELATED APPLICATION

This application claims the benefit of U.S. Provisional Application No. 61/317,295, filed Mar. 25, 2010, which application is incorporated by reference herein in its entirety.

### BACKGROUND

In today's world of the Internet, businesses can track their marketing and business processes in numerous ways. For example, autoresponder systems can be used to follow-up with prospects or customers in an automated way based upon certain preferences that have been specified. As another example, there are testing systems that allow different web pages to be tested in comparison with one another, so data can be gathered on which page performed better. Testing of web pages can be useful to determine which sales page has a higher percentage of sales, or otherwise performs better than another page that is being compared.

There are also systems that exist that allow businesses to create marketing materials to send to prospects or customers by direct mail, fax, or email. Examples of direct mail pieces may include brochures, post cards, letters, and the like. Some of the marketing design programs run on the desktop of a computer, such as Adobe Photoshop. There are also some web-based systems that allow for marketing materials to be created. Such web-based marketing design programs are generally limited in their functionality, and do not have the same level of features as what the desktop systems offer.

Business owners are often faced with having to use multiple software programs in order to accomplish these various business, sales, and marketing activities. It can be difficult to get a complete picture of how effective the various activities are, since data has to be shared between separate systems, and each system suffers from its own limitations.

### SUMMARY

Various technologies and techniques are disclosed for providing business automation. In one implementation, a business automation system is disclosed that provides contact tracking, split testing, landing page creation, tracking of the performance of printed promotions that are sent by direct mail, and automated follow-up, to name a few examples.

Points can be assigned to certain activities within the system, and contacts that have the highest scores based upon those activities can be identified for additional follow-up. For example, a tracking code can be installed on each page on a company's web site, and as visitors navigate through the site, their activity is tracked. This can then be correlated with their interest in a particular product, so a sales representative or other system user can follow-up appropriately.

In one implementation, a business automation system includes a tracking module, contacts module, autopilot module, and tasks module. Tracking module is operable to track activity information regarding activities that are performed by visitors to at least one web page being tracked. The tracking module is also operable to track advertising channels that are used to send traffic to the web page(s) being tracked. Contacts module is operable to manage contact information for multiple contacts, and to present a display of the activity information that is related to at least one of the contacts. Autopilot module is operable to generate follow-up messages, including generating follow-up messages to at least one of the contacts. Tasks module is operable to assign at least one task to at least one system user when a pre-defined event occurs.

In another implementation, activity information is tracked regarding activities that are performed by visitors to at least one web page being tracked. When a particular visitor provides at least some contact information, the activity information of the particular visitor is associated with a contact record of the particular visitor. A lead score is assigned to at least a portion of the activity information that is being tracked for the particular visitor, with the lead score being assigned based upon pre-defined scoring criteria. Further action related to the particular visitor can be initiated when the lead score reaches a pre-defined threshold.

In yet another implementation, a browser-based designer allows for the generation of print material such as direct mail post cards. Multiple layers can be added, manipulated, and/or rearranged. A PDF proof can also be generated.

In yet another implementation, a browser-based designer is also described that allows for the generation of landing pages.

Alternatively or additionally, the designer for generating print materials and/or for generating landing pages enables the creation of at least one piece of content using the following process. A collection object is created in a script language and the collection object is used to track the layers of the piece of content. Style tags of cascading style sheets are used to facilitate drag and drop operations. An event listener listens for clicks and drags that occur on any of the layers in the piece of content. The event listener responds with an appropriate action based upon the events that are raised.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a business automation system of one implementation.

FIGS. 2A-2C are simulated screens for one implementation that illustrate a dashboard that provides a summary of various business and marketing activities tracked by the business automation system.

FIG. 3 is a simulated screen for one implementation that illustrates viewing contacts and related details.

FIG. 4 is a process flow diagram for one implementation illustrating the stages involved in categorizing contacts based upon their activities.

FIG. 5 is a simulated screen for one implementation that illustrates assigning contact scoring conditions that determine what points are assigned to various activities performed by contacts.

FIG. 6 is a simulated screen for one implementation that illustrates several examples of the types of contact scoring conditions that can be assigned points.

FIG. 7 is a simulated screen for one implementation that illustrates details about a selected contact record.

FIG. 8 is a simulated screen for one implementation that illustrates using a group manager feature to filter contacts by specified criteria.

FIG. 9 is a simulated screen for one implementation that illustrates viewing tasks that are assigned to various people, and other details about each task.

FIG. 10 is a simulated screen for one implementation that illustrates various activities that are being tracked.

FIG. 11 is a simulated screen for one implementation that illustrates creating a new channel that can be tracked.

FIGS. 12A-12B are simulated screens for one implementation that illustrate various follow-up activities that can be assigned to follow-up with one or more contacts.

FIG. 13 is a simulated screen for one implementation that illustrates adding a new sequence.

FIG. 14 is a simulated screen for one implementation that illustrates adding an email to a sequence.

FIGS. 15A-B are simulated screens for one implementation that illustrate adding split testing to an email of a sequence.

FIG. 16 is a simulated screen for one implementation that illustrates adding a printable piece to a sequence.

FIG. 17 is a simulated screen for one implementation that illustrates adding a task to a sequence.

FIG. 18 is a simulated screen for one implementation that illustrates adding a rule to a sequence.

FIG. 19 is a simulated screen for one implementation that illustrates adding a voice broadcast to a sequence.

FIGS. 20A-20B are simulated screens for one implementation that illustrate adding a fulfillment item to a sequence.

FIG. 21 is a simulated screen for one implementation that illustrates adding a new date sequence.

FIGS. 22A-D are simulated screens for one implementation that illustrate adding a new response.

FIG. 23 is a simulated screen for one implementation that illustrates a list of messages that are used to follow-up with contacts.

FIG. 24 is a simulated screen for one implementation that illustrates viewing details about a selected post card in the list of messages.

FIG. 25 is a simulated screen for one implementation that illustrates viewing details about a selected email in the list of messages.

FIG. 26 is a simulated screen for one implementation that illustrates options for adding a new message.

FIG. 27 is a simulated screen for one implementation that illustrates creating a new email message.

FIG. 28 is a diagrammatic view of a designer that allows certain content for the business automation system to be created in a graphic format.

FIG. 29 is a diagrammatic view of some exemplary ways that cascading style sheets are used by the designer.

FIG. 30A is a simulated screen for one implementation that illustrates a designer that allows a post card or other direct mail piece to be created.

FIG. 30B is a simulated screen for one implementation that illustrates adding a new layer to the post card in the designer.

FIG. 31 is a simulated screen for one implementation that illustrates adding a text layer to a post card.

FIGS. 32A-32B are simulated screens for one implementation that illustrate adding database merge fields, such as a personalized URL, into a selected layer.

FIGS. 33A-33B are simulated screens for one implementation that illustrate changing the color of a selected graphic layer in the designer.

FIGS. 34A-34B are simulated screens for one implementation that illustrates re-ordering the layers in the designer.

FIG. 35 is a process flow diagram for one implementation illustrating the stages involved in generating a PDF proof of the print material from the designer.

FIGS. 36A-36B are simulated screens for one implementation that illustrate creating a proof from the designer and viewing it.

FIG. 37 is a simulated screen for one implementation that illustrates changing the font of selected text in a text layer in the designer.

FIG. 38 is a simulated screen for one implementation that illustrates creating a new graphic layer in the designer.

FIG. 39 is a simulated screen for one implementation that illustrates multiple layers in the designer that can each be edited.

FIG. 40 is a simulated screen for one implementation that illustrates two graphic layers in the designer.

FIG. 41 is a simulated screen for one implementation that illustrates deleting the selected layer from the designer.

FIG. 42 is a simulated screen for one implementation that illustrates changing a rectangle graphic layer to a circle in the designer.

FIG. 43 is a simulated screen for one implementation that illustrates hiding a selected layer in the designer.

FIG. 44 is a simulated screen for one implementation that illustrates adding a graphic layer that has a gradient effect.

FIG. 45 is a simulated screen for one implementation that illustrates selecting an image to insert in the designer.

FIG. 46 is a simulated screen for one implementation that illustrates a list of landing pages that currently exist in the system.

FIG. 47 is a simulated screen for one implementation that illustrates selecting a type of landing page to create.

FIG. 48 is a simulated screen for one implementation that illustrates a designer that can be used for creating a new landing page.

FIG. 49 is a simulated screen for one implementation that illustrates adding a new layer into the designer for the landing page.

FIG. 50 is a simulated screen for one implementation that illustrates adding an HTML layer in the designer for the landing page.

FIG. 51 is a simulated screen for one implementation that illustrates adding HTML code to a selected HTML layer in the designer.

FIG. 52 is a simulated screen for one implementation that illustrates the HTML being added to the layer.

FIG. 53 is a simulated screen for one implementation that illustrates adding a form layer in the designer for the landing page.

FIG. 54 is a simulated screen for one implementation that illustrates selecting a form to assign to the form layer in the designer.

FIG. 55 is a simulated screen for one implementation that illustrates creating a new split test for a landing page.

FIG. 56 is a simulated screen for one implementation that illustrates the new landing page being added for the split test.

FIG. 57 is a simulated screen for one implementation that illustrates creating a new HTML landing page.

FIG. 58 is a simulated screen for one implementation that illustrates creating a new landing page that redirects to one or more other pages.

FIG. 59 is a diagrammatic view of a computer system of one implementation.

### DETAILED DESCRIPTION

The technologies and techniques herein may be described in the general context as an application that automates various business and marketing activities, but the technologies and techniques also serve other purposes in addition to these. In one implementation, one or more of the techniques described herein can be implemented as features within a customer relationship management program, from within an autoresponder follow-up system, or from any other type of program or service that manages contacts and a sales process with those contacts. In another implementation, one or more of the techniques described herein are implemented as features with other applications that deal with designing print materials (e.g. for direct mail) and/or web pages.

A business automation system is disclosed that provides contact tracking, split testing, landing page creation, tracking of the performance of printed promotions that are sent by direct mail, and automated follow-up, to name a few examples. Activities of a visitor can be tracked from the point before the visitor opts in for more information, and all the way through the entire sales process.

For example, points can be assigned to certain activities within the system, and contacts that have the highest scores based upon those activities can be identified for additional follow-up. For example, a tracking code can be installed on each page on a company's web site, and as visitors navigate through the site, their activity is tracked. The pages they visit and information they request and/or buy can then be correlated with their interest levels, so a sales representative or other contact can follow-up appropriately.

In another implementation, a browser-based designer allows for the generation of print materials such as direct mail post cards or newsletters. Multiple layers can be added, manipulated, and/or rearranged. A PDF proof can also be generated. In yet another implementation, a browser based designer is also described that allows for the generation of landing pages.

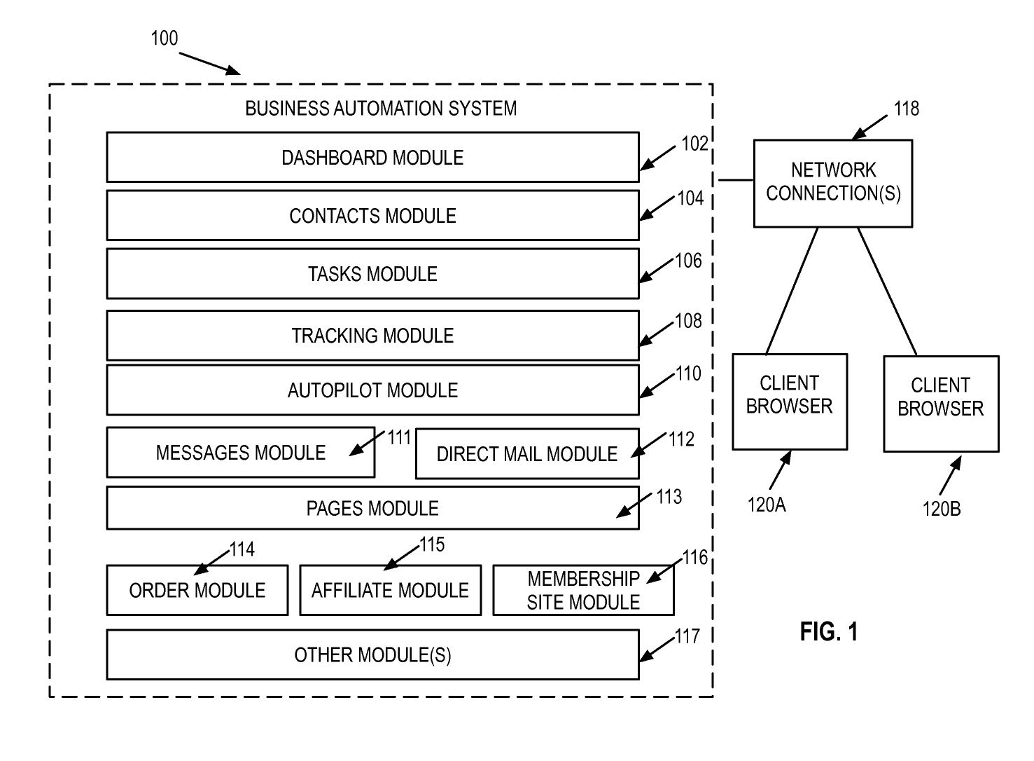

FIG. 1 is a diagrammatic view of a business automation system 100 of one implementation. Business automation system 100 includes several modules, including dashboard module 102, contacts module 104, tasks module 106, tracking module 108, autopilot module 110, messages module 111, pages module 113, and other module(s) 117. Business automation system 100 is accessed over one or more network connections 118 by client browser(s) (120A and 120B, respectively).

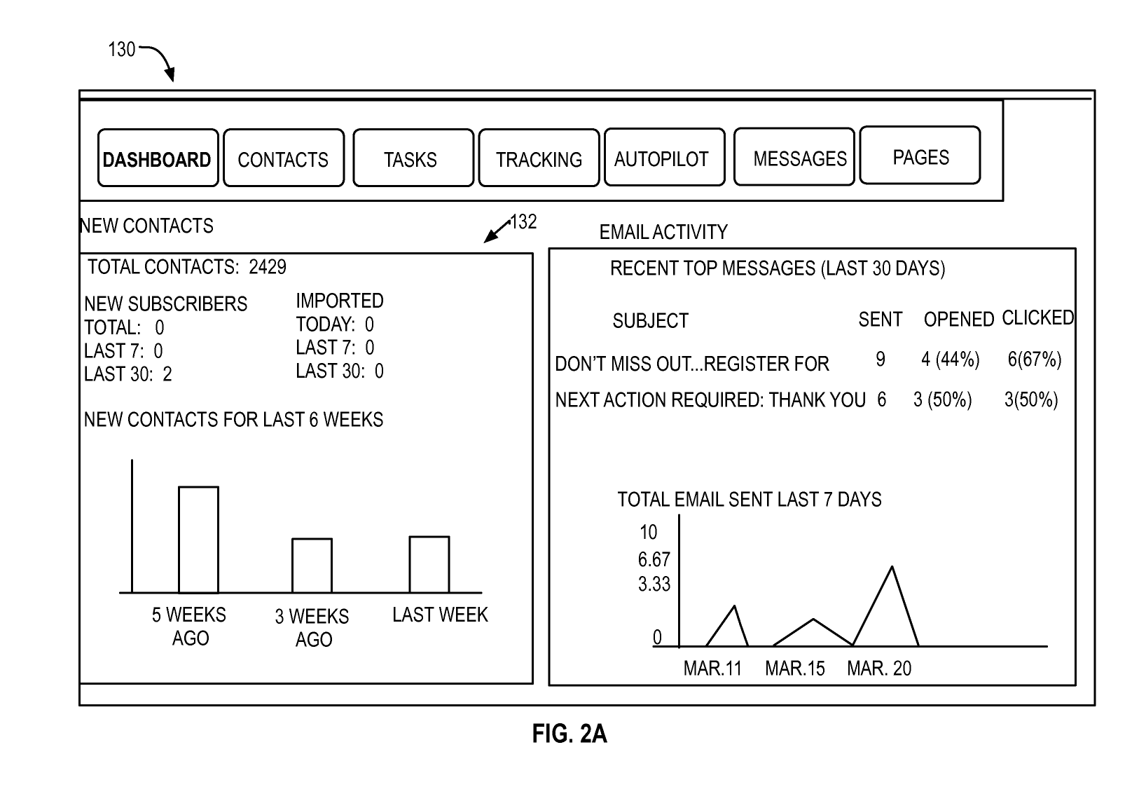

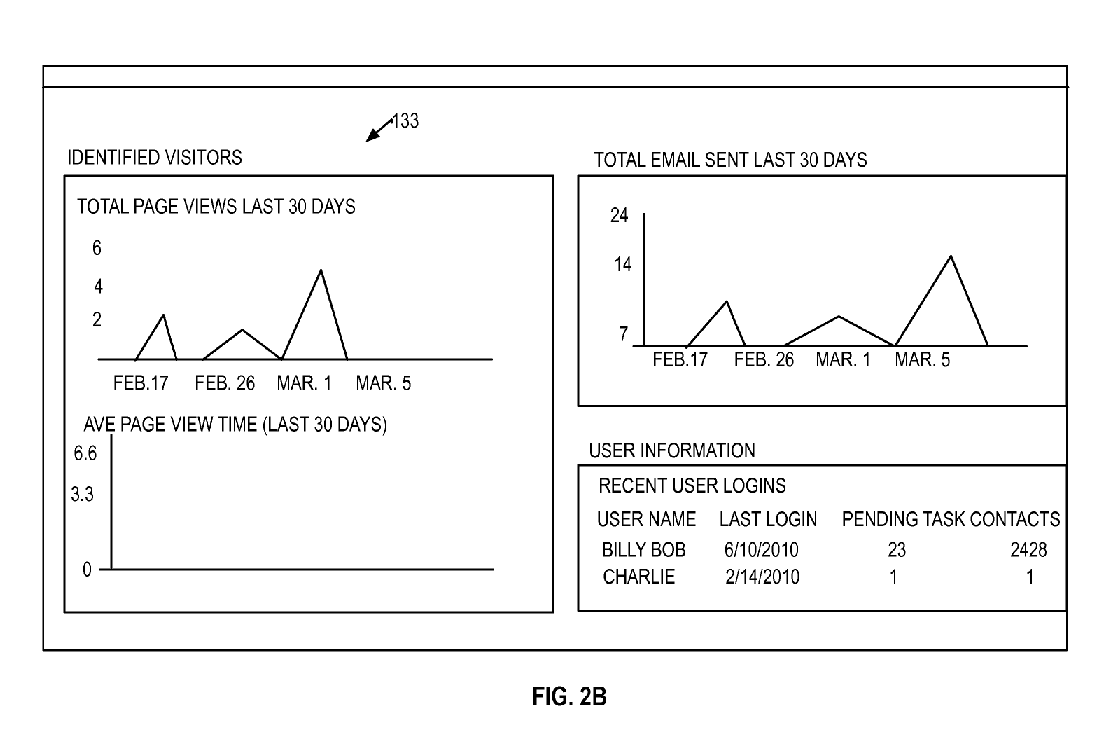

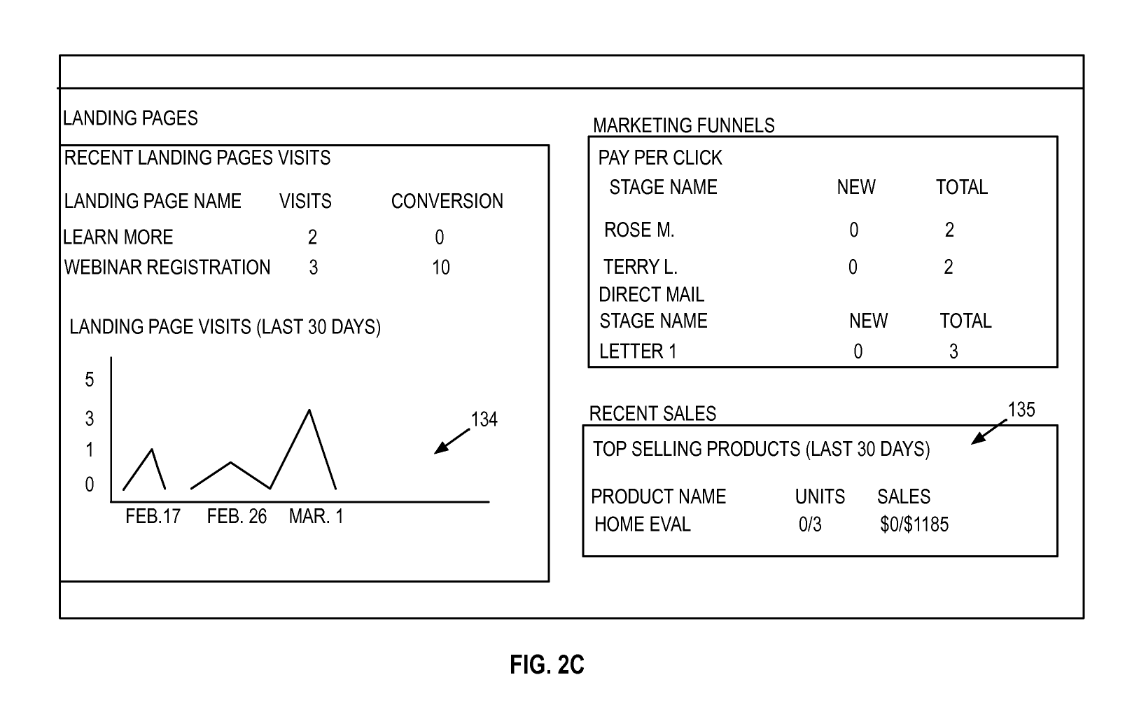

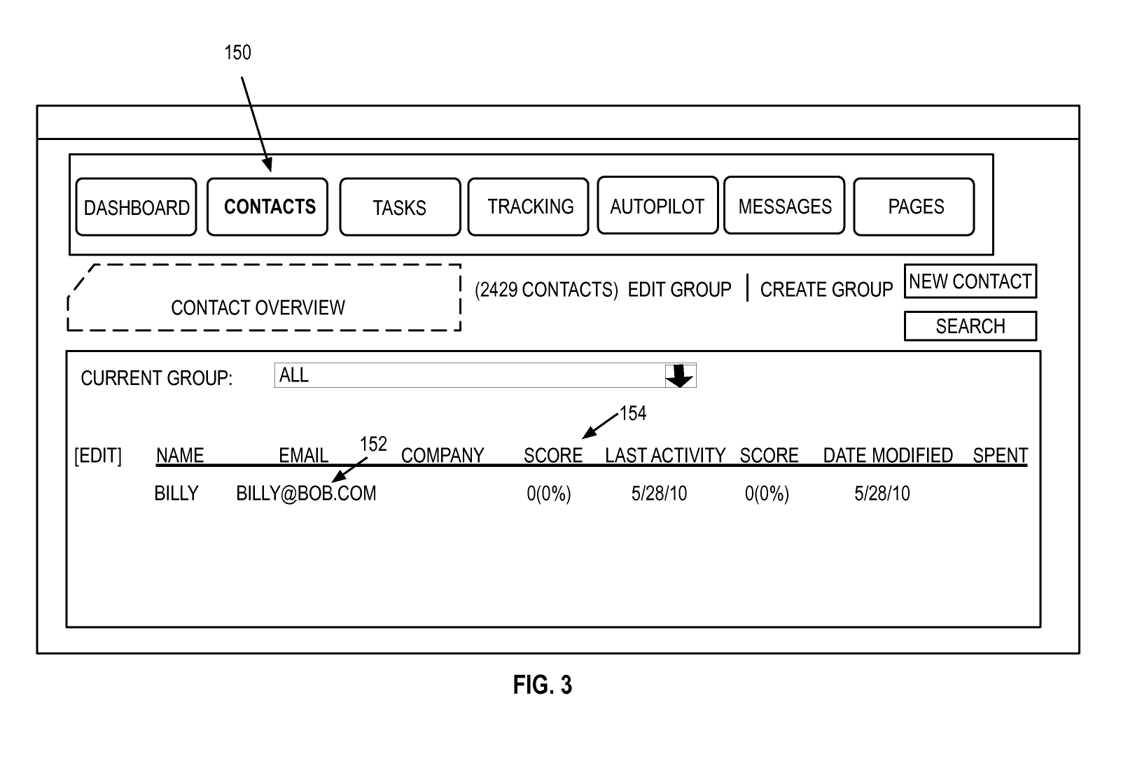

Dashboard module 102 is responsible for providing details about various activities and data from the system in an aggregate view. In one implementation, dashboard module 102 summarizes information from the autopilot module 110, order module 114, and/or other modules. This summary view allows the business owner or other user to easily view the various activities at a glance without having to navigate through the various parts of the system to piece the information together. An example of dashboard module 102 is shown in FIG. 2. Contacts module 104 is responsible for managing the contacts within the system. Contacts can be prospects, customers, or other vendors. Contacts module 104 and its related functionality are described in further detail in FIGS. 3-8.

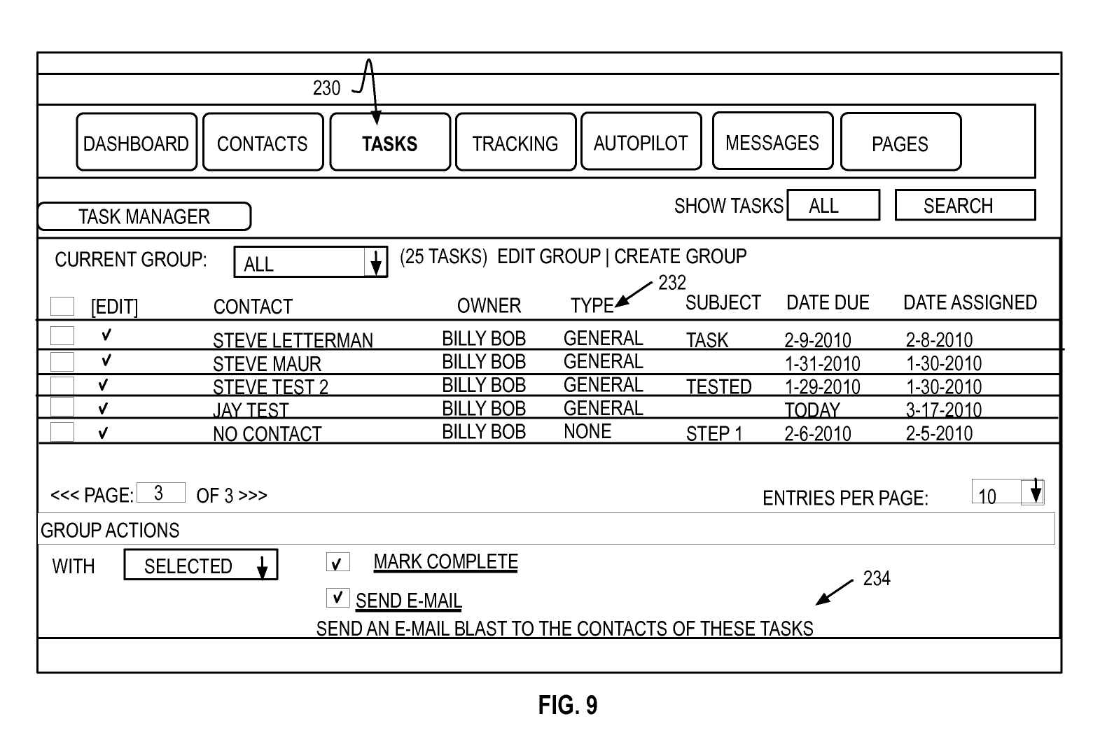

Tasks module 106 is responsible for managing the tasks that have been assigned to various system users, such as those that have been assigned manually, or those that have been assigned programmatically when a pre-defined event occurs. Tasks module 106 is described in further detail in FIG. 9.

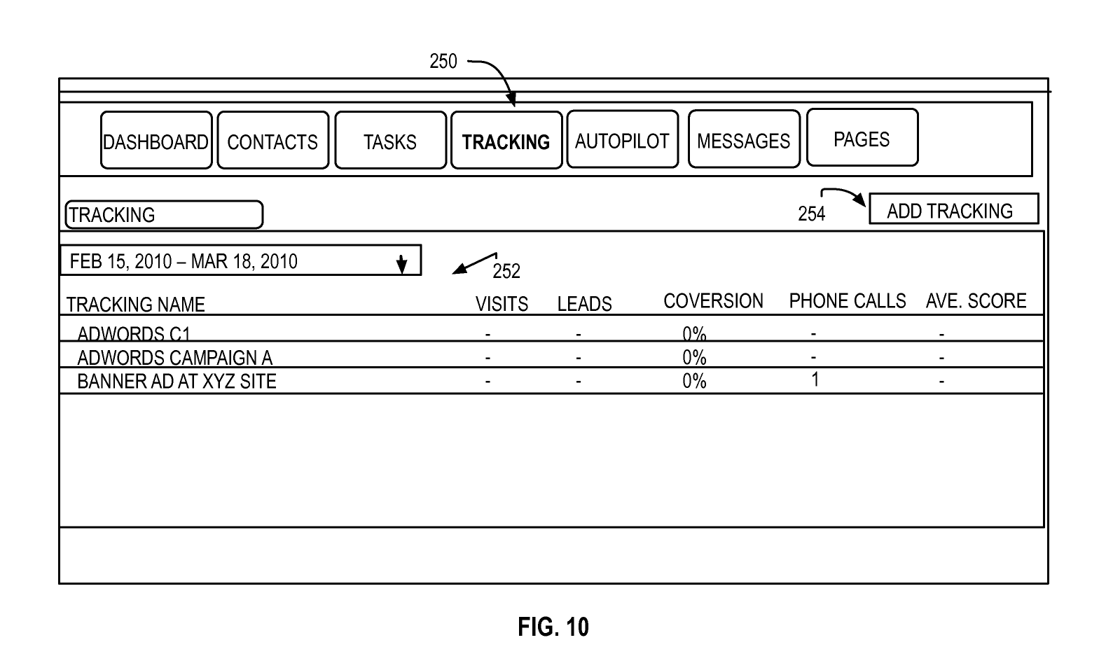

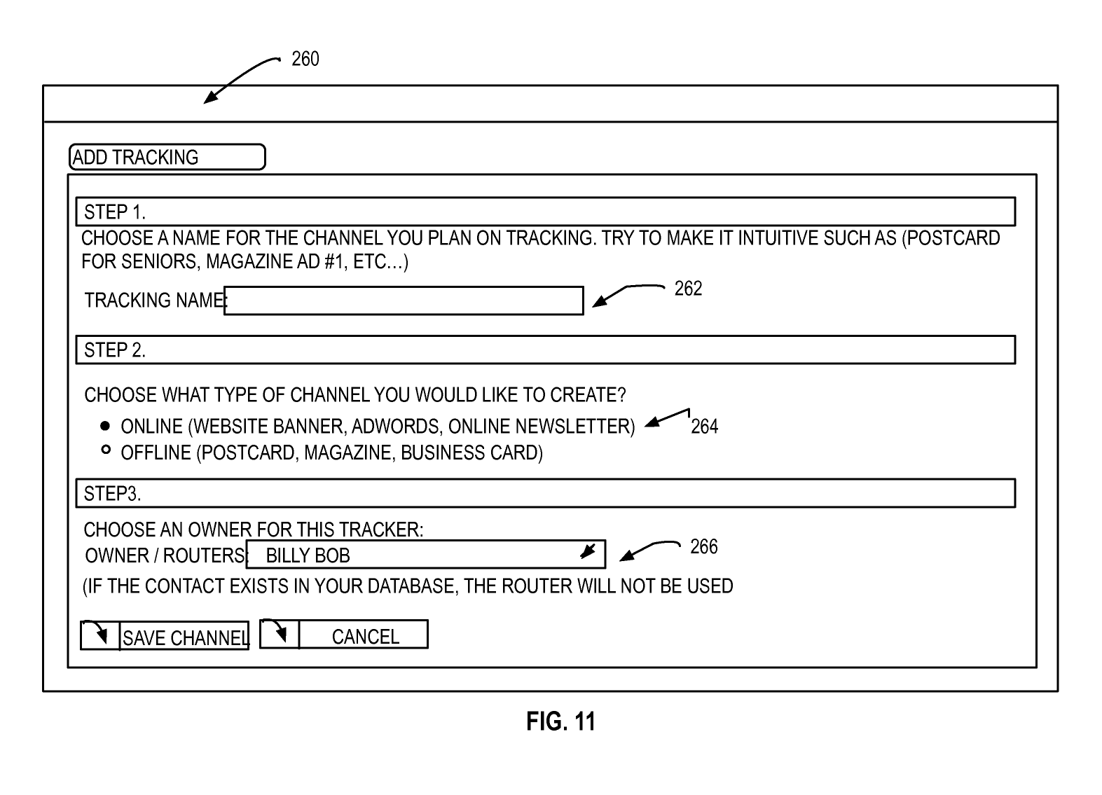

Tracking module 108 is responsible for tracking activity information that describes the various activities that occur as visitors access the web pages on the company's site or click on advertisements that have been set up for the company. One non-limiting example of activity information that can be tracked by tracking module 108 includes advertising channels that are being used to send traffic to at least one web page being tracked. Other non-limiting examples of activity information that can be tracked by tracking module 108 includes web pages visited, incentives that were given in exchange for receiving the contact information in an opt-in form, product purchases, and other actions that a visitor takes while visiting one or more pages that are being tracked by system 100. In one implementation, tracking module 108 tracks activities that were performed by contacts before the contacts have ever provided any contact information. In one implementation, contacts module 104 is also responsible for displaying (or presenting a display of) some or all of the activity information that has been stored for contacts, once the visitor has become a contact of system 100 (such as by providing any of the contact information). Tracking module 108 is described in further detail in FIGS. 10-11.

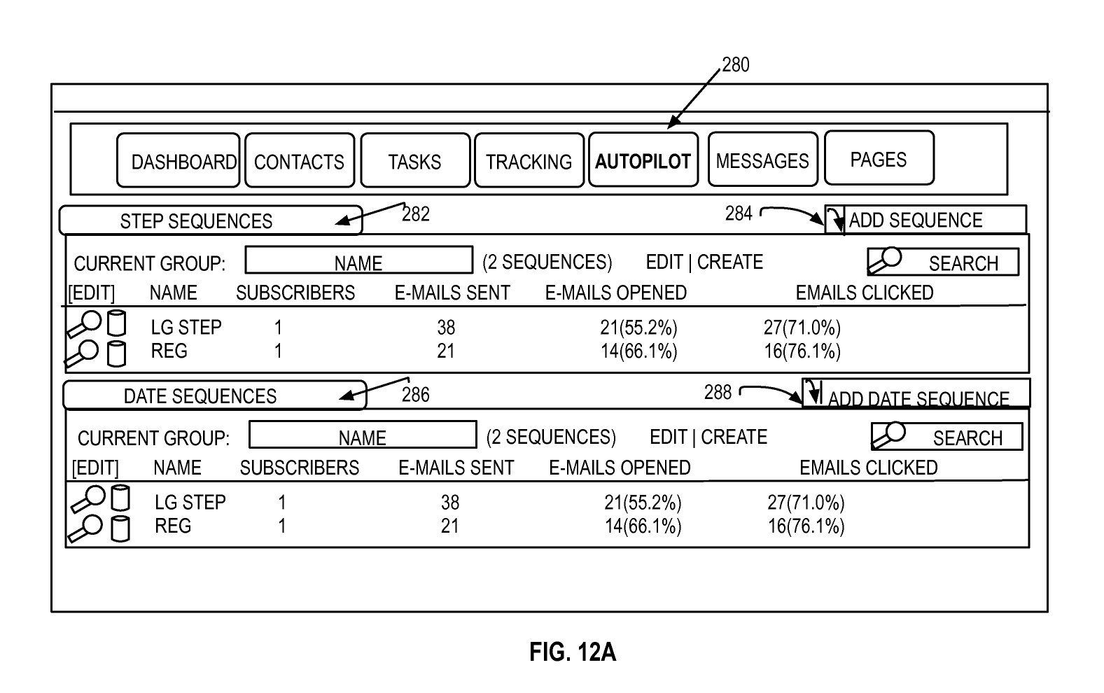

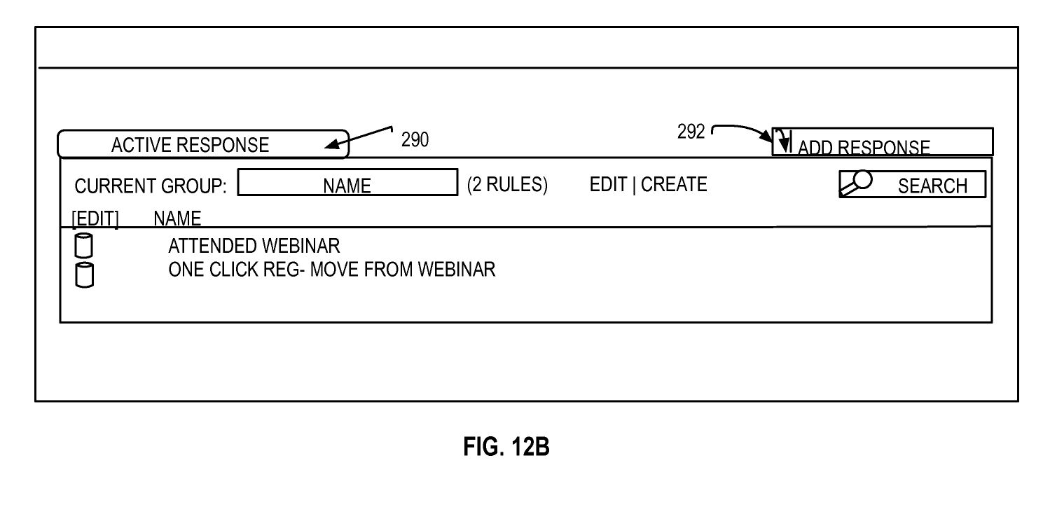

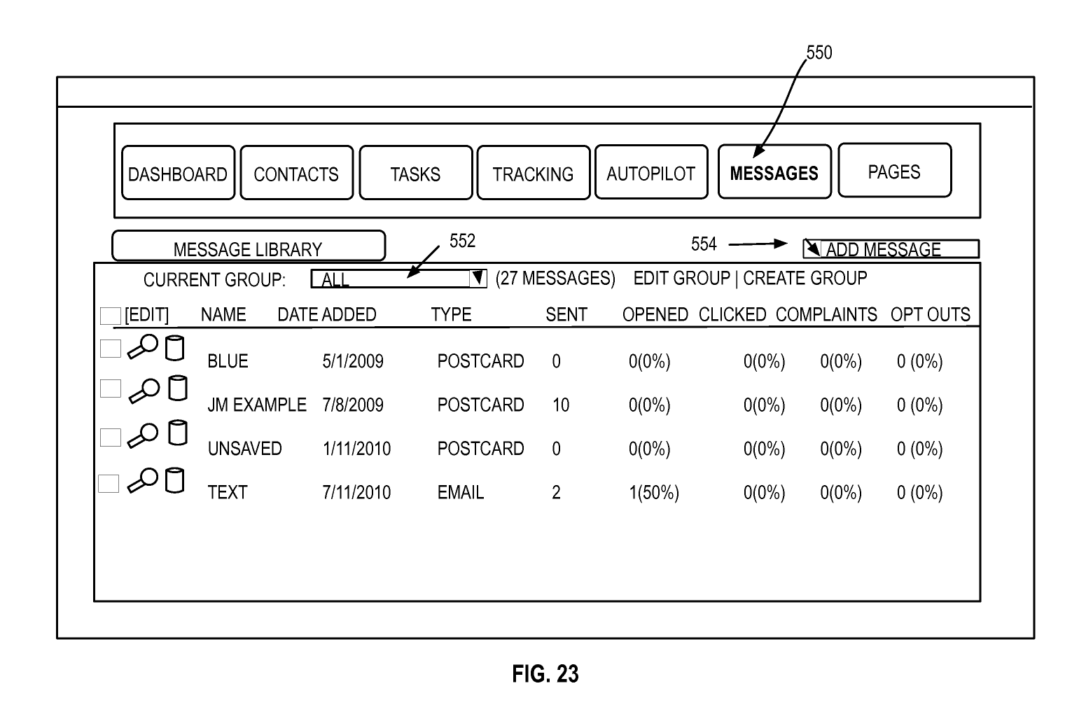

Autopilot module 110 is responsible for following up with contacts and/or system users based upon various follow-up messages that have been setup. A few non-limiting examples of follow-up messages can include email, print, task, rule, voice broadcast, and fulfillment item. In one implementation, autopilot module 110 allows follow-up messages to be split tested so that multiple variations of a particular follow-up messages can be sent to some of the contacts, and the performance of each of the variations that are used in the split test can be tracked. In another implementation, autopilot module 110 is able to use personalized URL's in one or more of the follow-up messages, as described in more detail in later figures. Autopilot module 110 is described in further detail in FIGS. 12-22. Messages module 111 is responsible for managing the various messages that can be sent out to contacts in the system, such as by autopilot module 110. In one implementation, messages that have been defined by messages module 111 can be sent when a pre-defined criteria have been met. Messages module 111 includes a direct mail module 112 with a designer that can be used to design print messages, such as a direct mail post card or newsletter. Messages module 111 and direct mail module 112 are described in further detail in FIGS. 23-45.

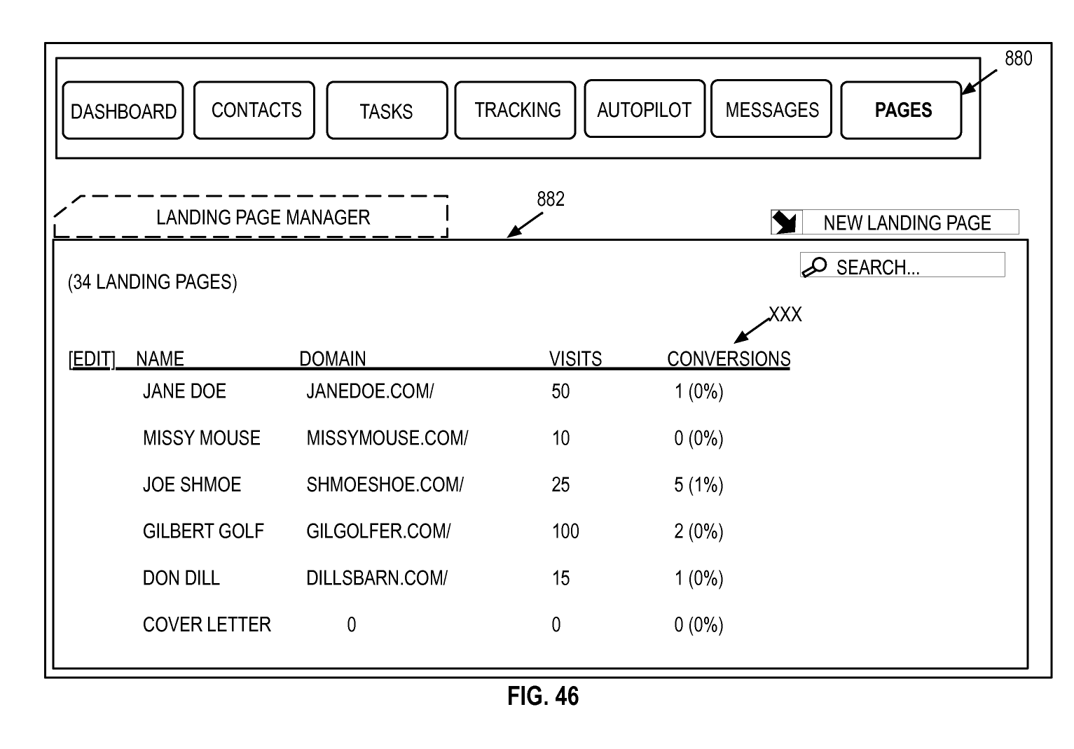

Pages module 113 is responsible for creating and managing the various landing pages of the system. These landing pages can be used to capture contact information and/or other details. Pages module 113 includes a designer that can be used to design landing pages using a graphical user interface, such as in a web browser. Pages module 113 is described in further detail in FIGS. 46-58.

Order module 114 allows products to be offered for sale, and at least one product to be ordered by at least one of the contacts. Follow-up messages can then be sent to customers by autopilot module 110 after one or more products have been purchased through order module 114.

Affiliate module 115 allows at least one affiliate to be credited with a sales commission. Before an affiliate can be credited with a sales commission, the affiliate first creates a new affiliate account, and then uses a dedicated tracking link or other means of advertising that allows system 100 to determine that the visitor was referred by the particular affiliate. Then, if the particular visitor makes a purchase, the affiliate will be given a sales commission based upon the affiliate settings that have been specified in affiliate module 115.

Membership site module 116 allows one or more contacts to access content on at least one membership site. One non-limiting example of how membership site module 116 can be used is to deliver products in a digital format to customers who have placed an order using the order module 114. In other words, the digital products can be delivered behind a secure membership site that is created and/or managed by membership site module 116. Another non-limiting example of how membership site module 116 can be used is to deliver free or paid levels of membership to one or more contacts being managed by system 100.

Other modules 117 are also included for performing other activities of system 100. It will be appreciated that while the term module is used herein to refer to functionality, in some implementations, an actual feature may be located under a different module name than one that is specifically named by a certain module name.

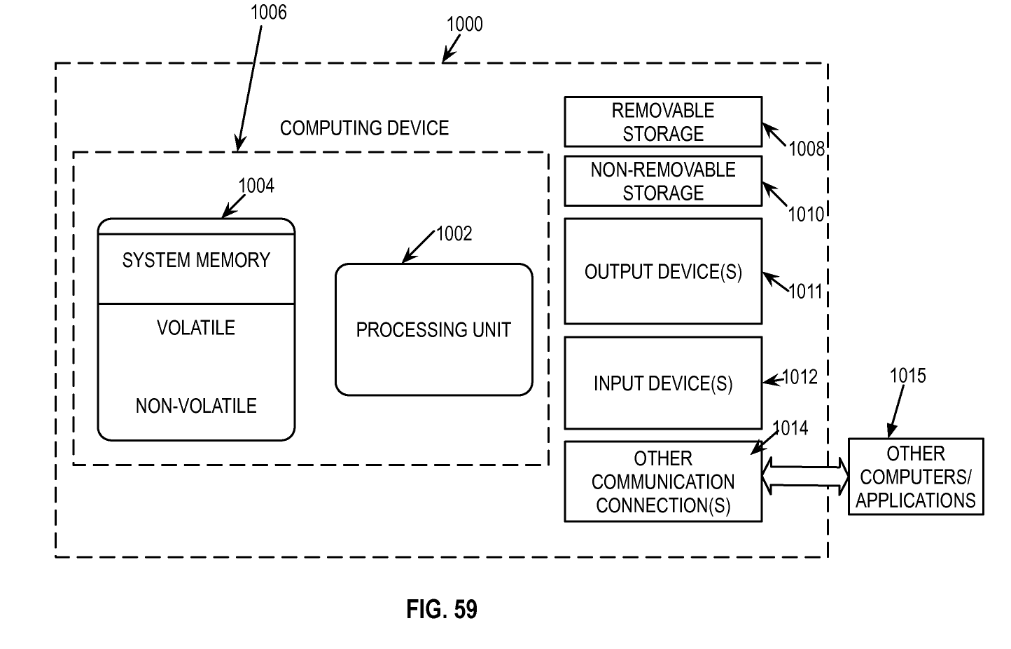

Turning now to FIGS. 2-58, the stages for implementing one or more implementations of business automation system 100 are described in further detail. In some implementations, the processes of FIG. 2-58 are at least partially implemented in the operating logic of computing device 1000 (of FIG. 59).

Simulated screens are shown in several figures to illustrate an exemplary user interface of business automation system 100. These screens can be displayed to users on output device(s) 1011 (of FIG. 59). Furthermore, these screens can receive input from users from input device(s) 1012 (of FIG. 59).

Turning now to FIGS. 2A-2C, simulated screens 130 are shown for one implementation that illustrates a dashboard that provides a summary of various business and marketing activities tracked by the business automation system. In the example shown, various details 132 are shown, such as a summary of new contacts, top messages, identified visitors 133, average page view time, recent user logins, marketing funnel performance, and recent sales 135. Details on recent landing pages that have been visited, as well as total landing page visits 134 for the past 30 days are also displayed. Numerous other types of summary data could also be displayed in other implementations.

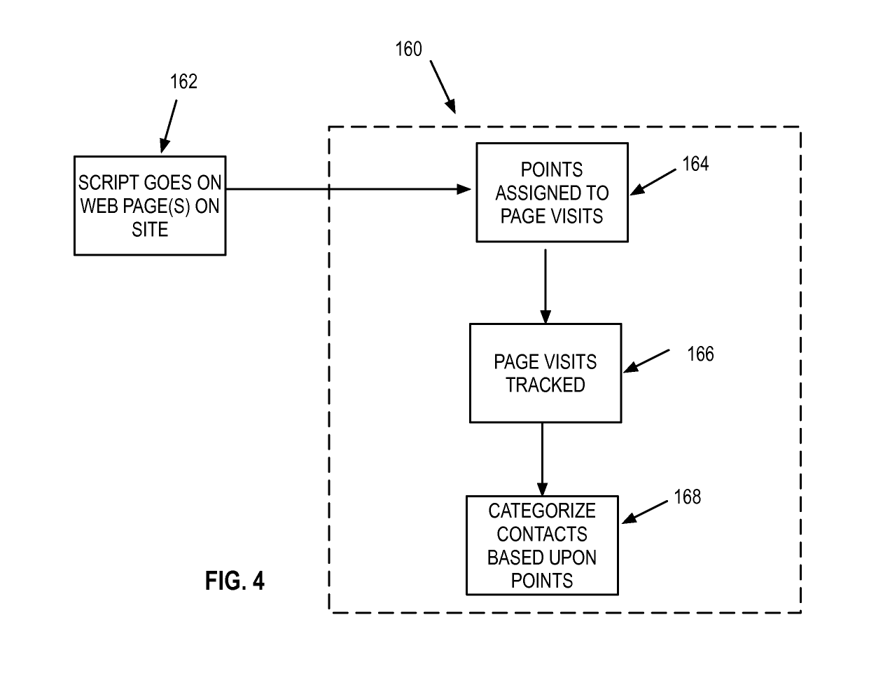

FIG. 3 is a simulated screen 150 for one implementation that illustrates viewing contacts and related details 152. Data such as name, email, company, and other contact information are stored in each contact record. A lead score 154 is also assigned based upon the contact's activities, such as which web pages the contact visited on the company's web site. This lead score allows contacts that may be more interested in the company's products or services to be flagged with a higher score so that sales representatives, agents, or one of the automated follow-up messages can be used accordingly. More details on the scoring of contacts are described in FIGS. 4-6.

FIG. 4 is a process flow diagram 160 that illustrates one implementation of the stages involved in categorizing contacts based upon their activities. A tracking script is added to web pages on the company's web site (stage 162), which can be also used in conjunction with tracking module 108 to assist with tracking Points are assigned to particular page visits (stage 164), such as to rank those that are more important with a higher score. The page visits are tracked as visitors navigate through the site (stage 166), such as upon receiving communication(s) from the tracking script when the web page(s) are accessed by a visitor. The contacts tracked by business automation system 100 are categorized based upon the points (stage 168), such as to be displayed with their respective scores based upon the activities each performed on the company's web site.

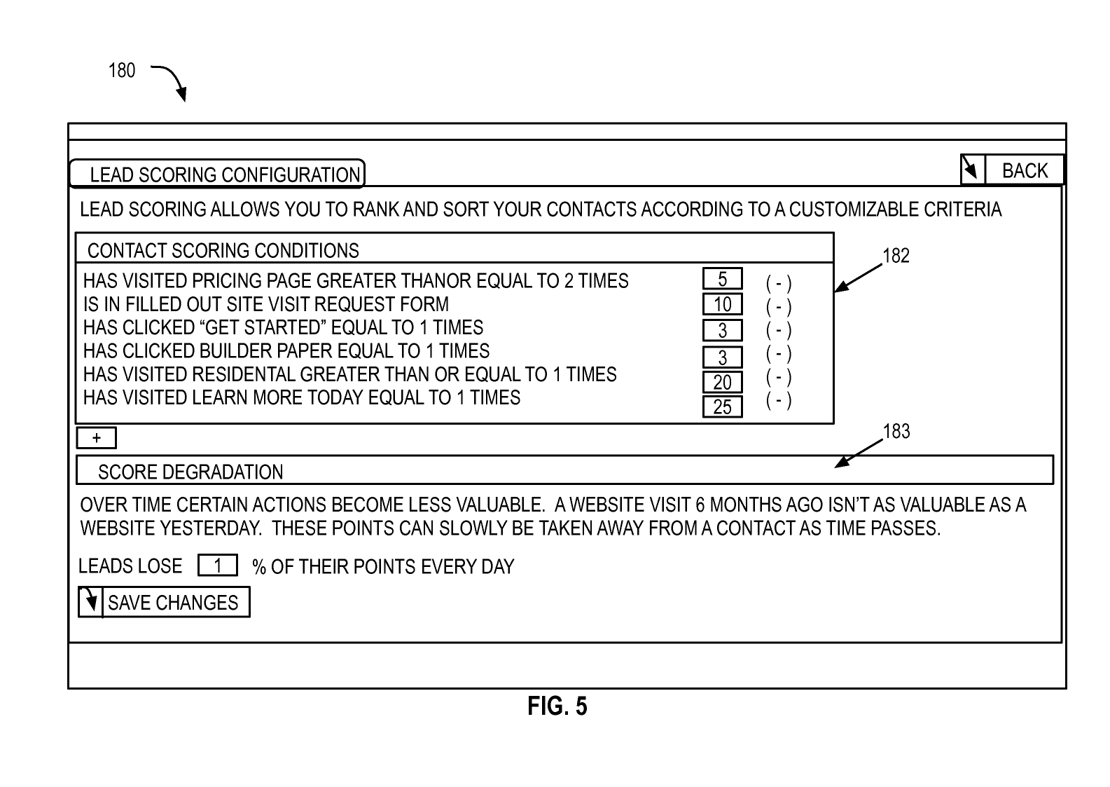

FIG. 5 is a simulated screen 180 for one implementation that illustrates assigning contact scoring conditions 182 that determine what points are assigned to various activities performed by contacts. For example, if someone visits a particular page 2 or more times, they may be assigned a certain lead score. If someone filled out a site visit request form, they may be assigned another lead score. Score degradation 183 can be used to decrease the lead score for a particular contact or visitor over time upon applying the degradation criteria.

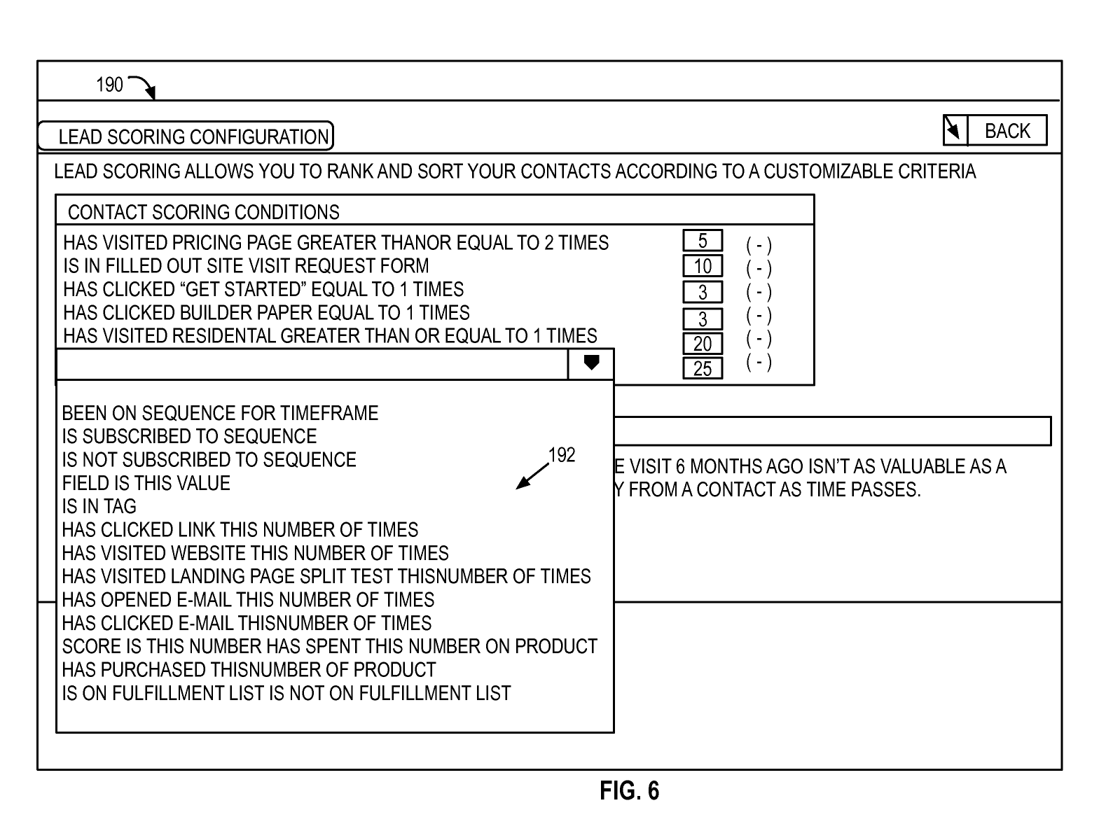

FIG. 6 is a simulated screen 190 for one implementation that illustrates several examples of the types of contact scoring conditions 192 that can be assigned points.

The lead scores can be weighted based upon how important a particular activity is, or how much the activity shows a particular prospect or customer's interest in a certain product or service. In other implementations, various other scoring techniques could be used to rank visitor interest and/or activities. In one implementation, one or more degradation criteria can be specified to decrease the lead score over time, such as to account for a higher value of a recent activity versus an older activity.

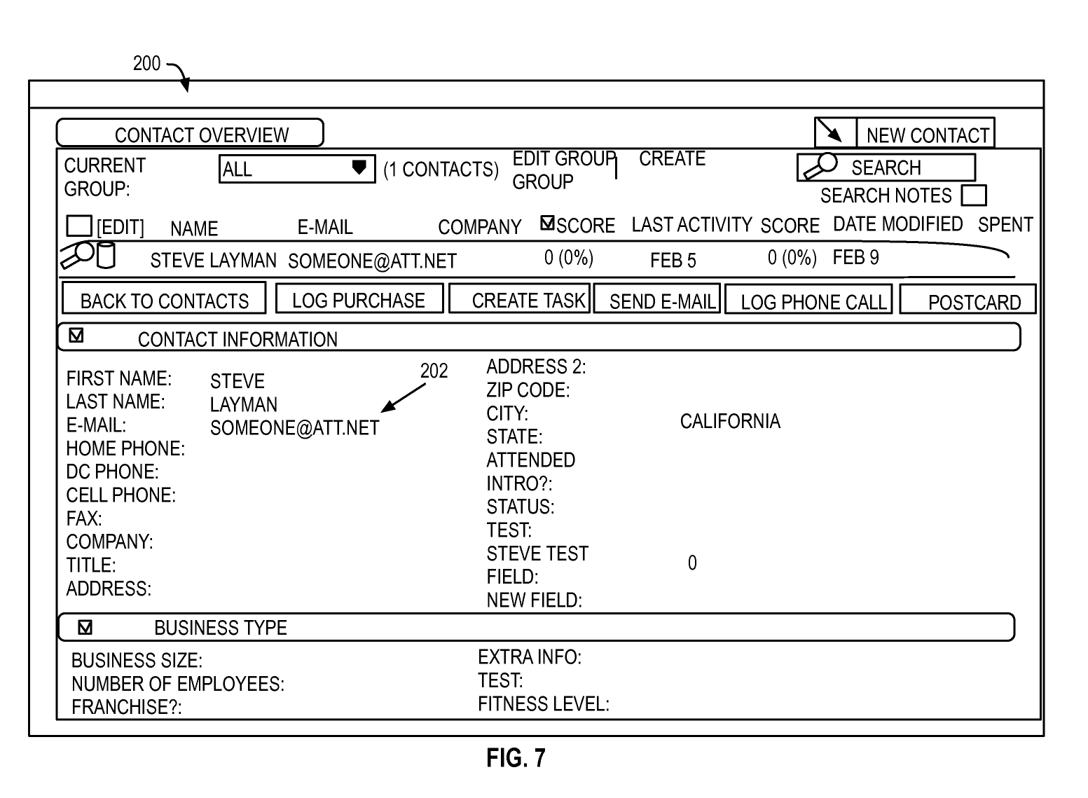

FIG. 7 is a simulated screen 200 for one implementation that illustrates details about a selected contact record. Details 202 such as first name, last name, email, phone, address, etc. are displayed about the contact.

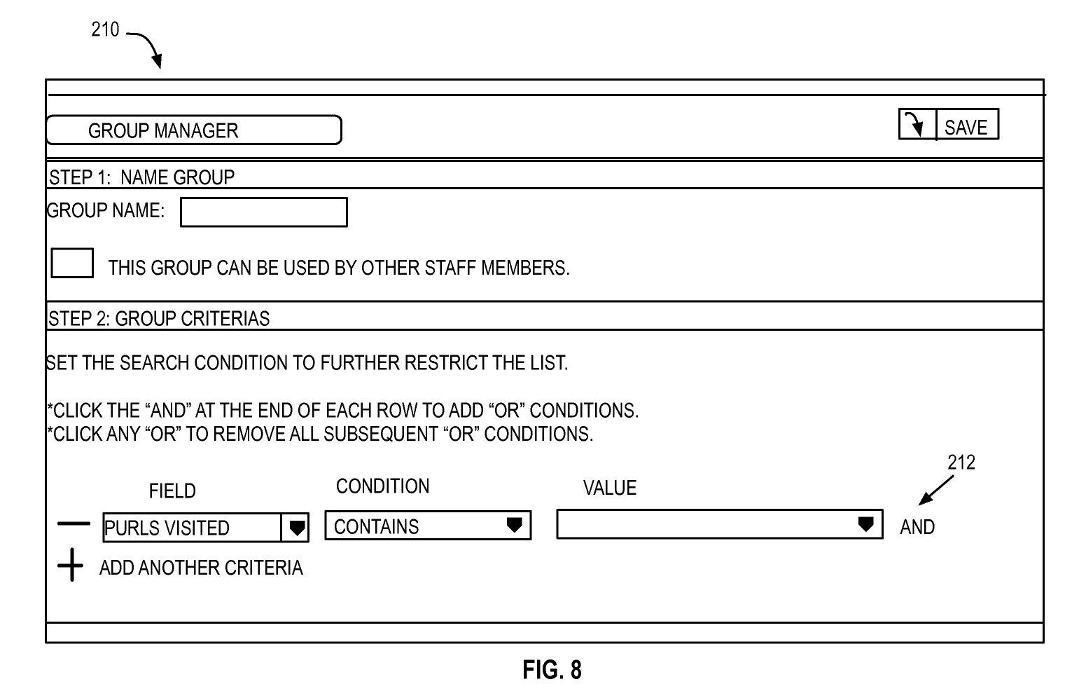

FIG. 8 is a simulated screen 210 for one implementation that illustrates using a group manager feature to filter contacts by specified criteria. A name can be given for the group, and the criteria 212 that should be used to select the contacts to include in the group can also be specified. For example, contacts can be filtered by which personalized URL's were visited that contain certain words or phrases. Once the criteria 212 is specified, the group can then be saved and used to search for contacts in the future that meet the specified criteria.

FIG. 9 is a simulated screen 230 for one implementation that illustrates viewing tasks that are assigned to various people, and other details 232 about each task. For example, the task type, subject, due date, and who the task is assigned to are displayed. A send email option 234 is provided to allow emails to be sent to the contacts that have been assigned one or more tasks.

FIG. 10 is a simulated screen 250 for one implementation that illustrates various activities that are being tracked in business automation system 100. Example activities 252 include various types of marketing campaigns, such as a pay per click campaign that is running on a network such as Google, Yahoo, or Bing. Upon selecting add tracking 254, a new tracking record can be created, as is shown in more detail in FIG. 11.

FIG. 11 is a simulated screen 260 for one implementation that illustrates creating a new channel that can be tracked. The name of the channel being tracked can be specified 262, as well as details about the channel 264, such as whether it is online or offline. An owner 266 can also be specified for the tracker. The channel can then be saved using the save option.

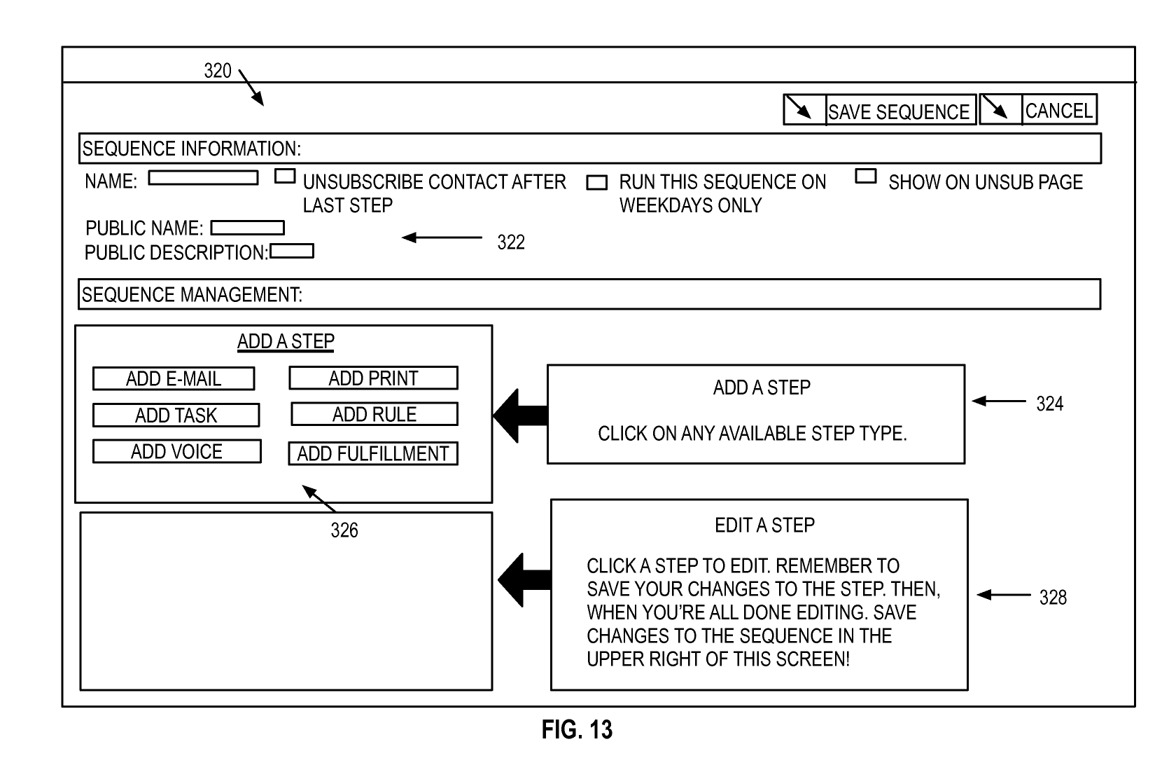

FIGS. 12A-12B are simulated screens 280 for one implementation that illustrate various follow-up activities that can be assigned to follow-up with one or more contacts. Step sequences 282 can be added using the add sequence option 284. Date sequences 286 can be added using the add date sequence option 288. An active response 290 can be added by selecting the add response option 292. Each of these will be discussed in further detail in FIGS. 13-22.

FIG. 13 is a simulated screen 320 for one implementation that illustrates adding a new step sequence. Details about the sequence 322, such as name, public name, and public description can be specified. One or more steps can then be added 324 to specify what type of follow-up should happen. For example, options 326 can be selected to add a step for email, print, task, rule, voice, or fulfillment. Any existing steps can be edited 328 by selecting the existing step from the list.

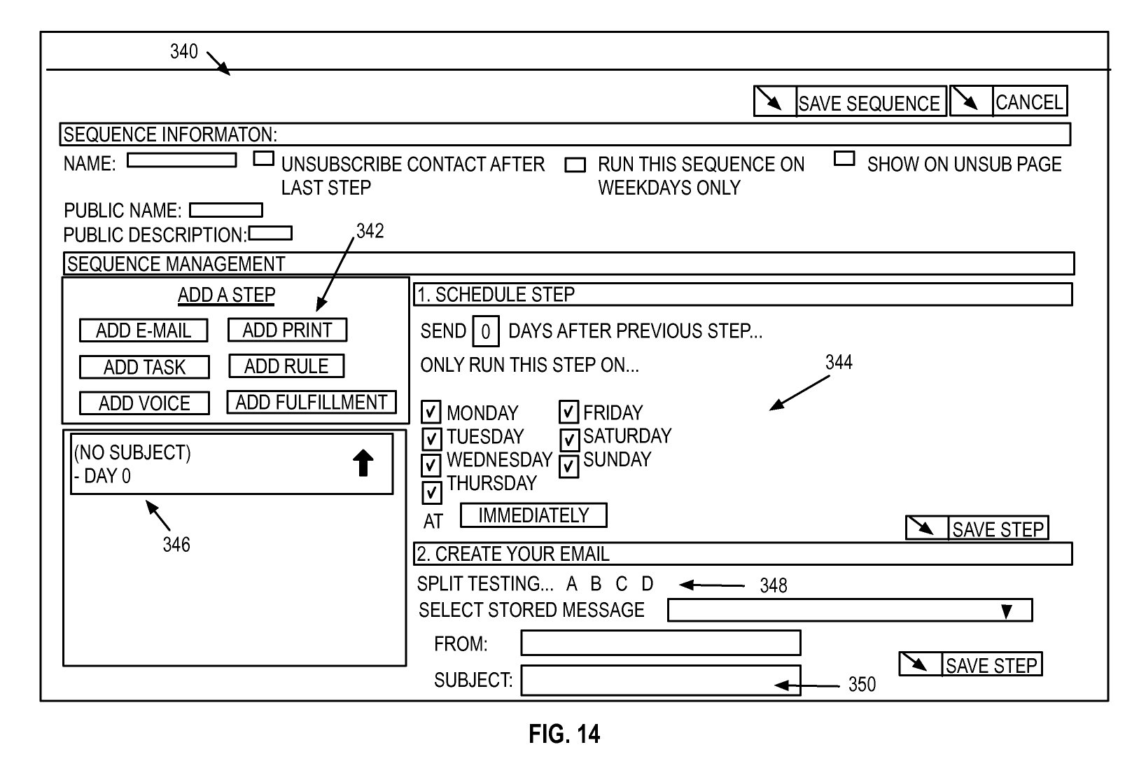

FIG. 14 is a simulated screen 340 for one implementation that illustrates adding an email to a sequence. Upon selecting email 342 as the step, the new email 346 is then created. Scheduling details 344 can be specified for the email, as well as split testing options 348, and other email details 350, such as HTML body, text body, attachments, etc.

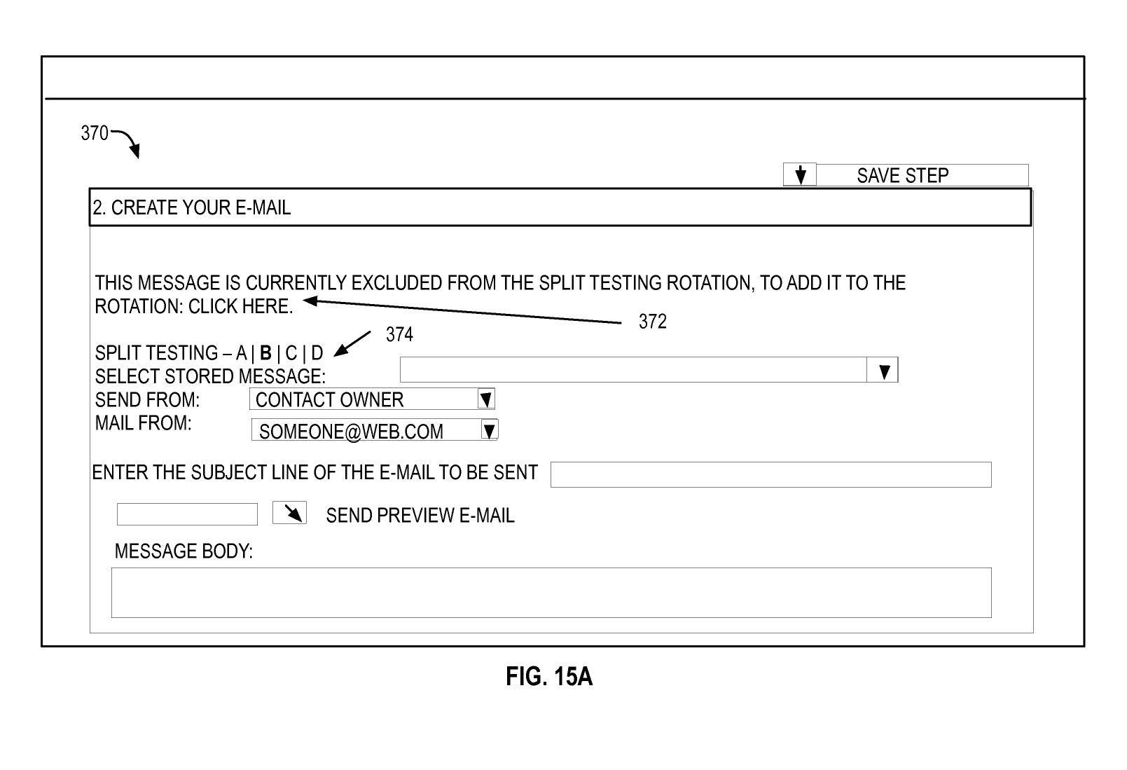

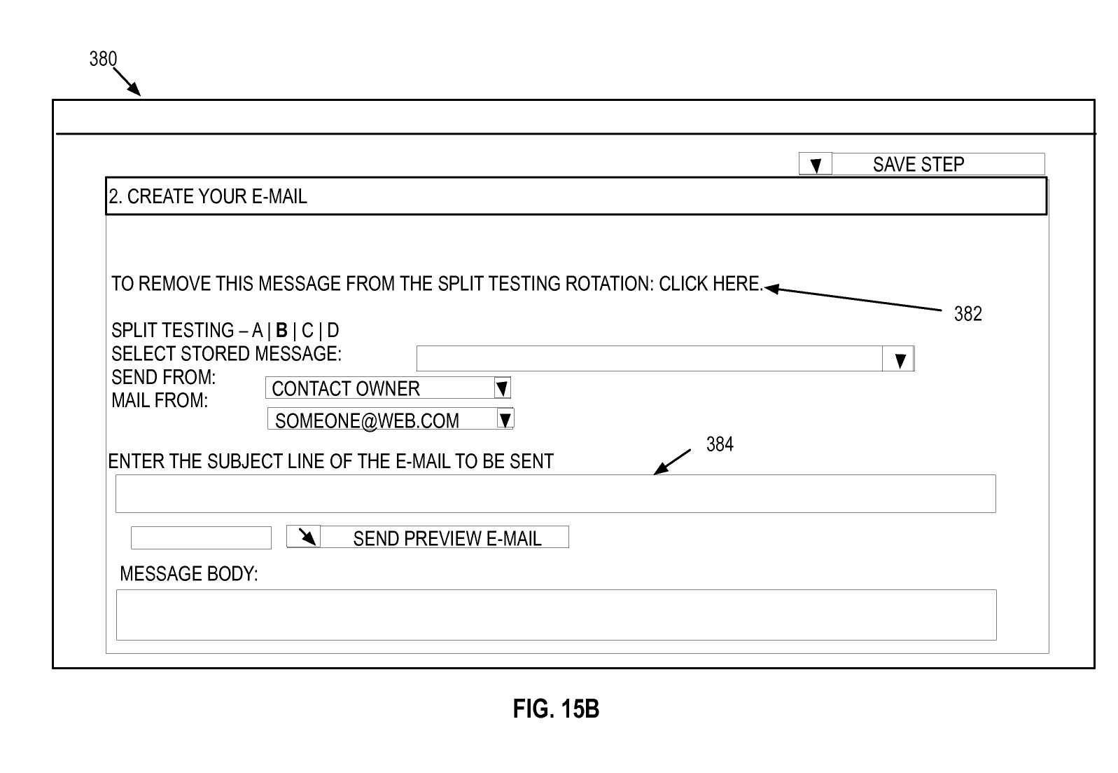

FIGS. 15A-B are simulated screens for one implementation that illustrate adding split testing to an email of a sequence. The simulated screen 370 of FIG. 15A illustrates adding a second email to split test 374. To add the email to the split testing rotation, select the add option 372. As shown in simulated screen 380 of FIG. 15B, once the new message has been added to the split testing rotation, it can be removed from selecting the remove option 382. Other details about the message 384 can then be specified for the variations that are being split tested. Split testing allows different variations of a message, which in this example is an email, to be tested to see which one performs better. In one implementation, the system tracks which messages win the split testing rotations, and then automatically sends those winning messages most frequently.

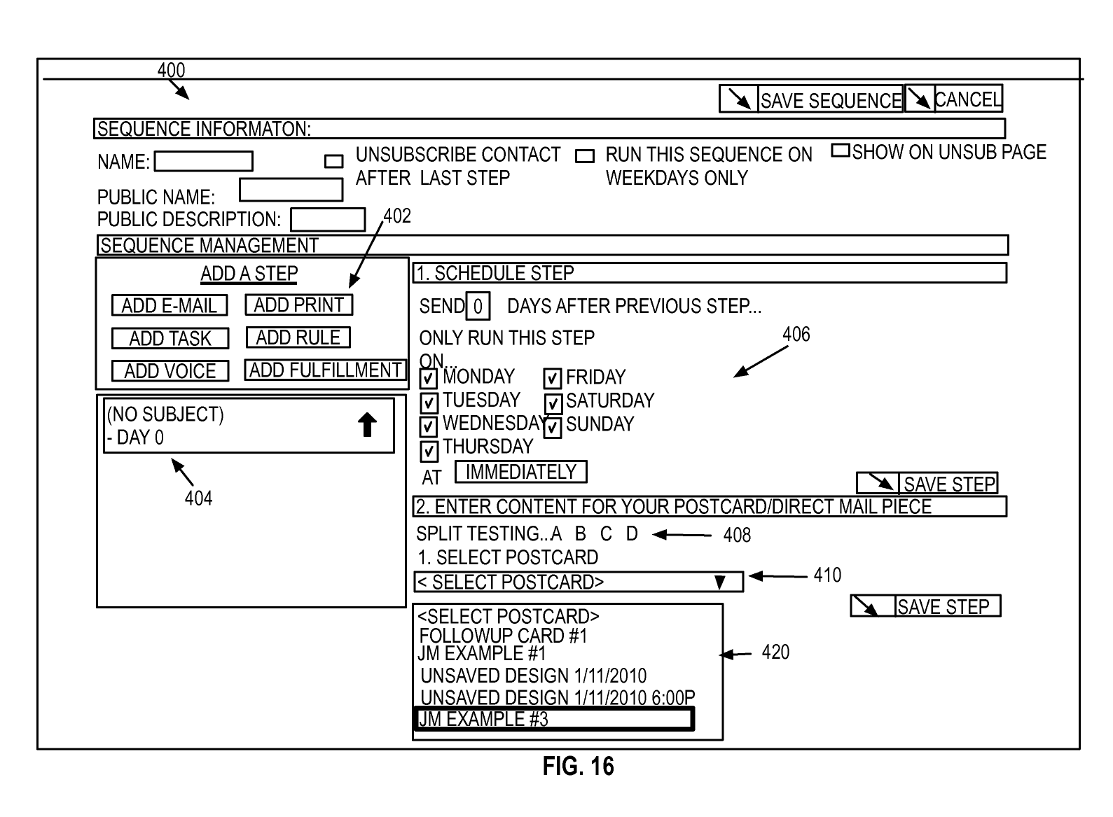

FIG. 16 is a simulated screen 400 for one implementation that illustrate adding a print piece (e.g. direct mail piece) to a sequence, such as a post card or newsletter. Print step 402 is selected, and then a new print step is displayed 404. Scheduling details 406 are displayed for the step, as well as the split testing option 408, and the stored design 410 to use for the print media. In this example, the stored design 410 is a post card, but in other implementations, numerous other types of print media could be used. Various sample post cards 420 that were created by direct mail module 112 are shown in the list and can be selected as the design to use for this print piece.

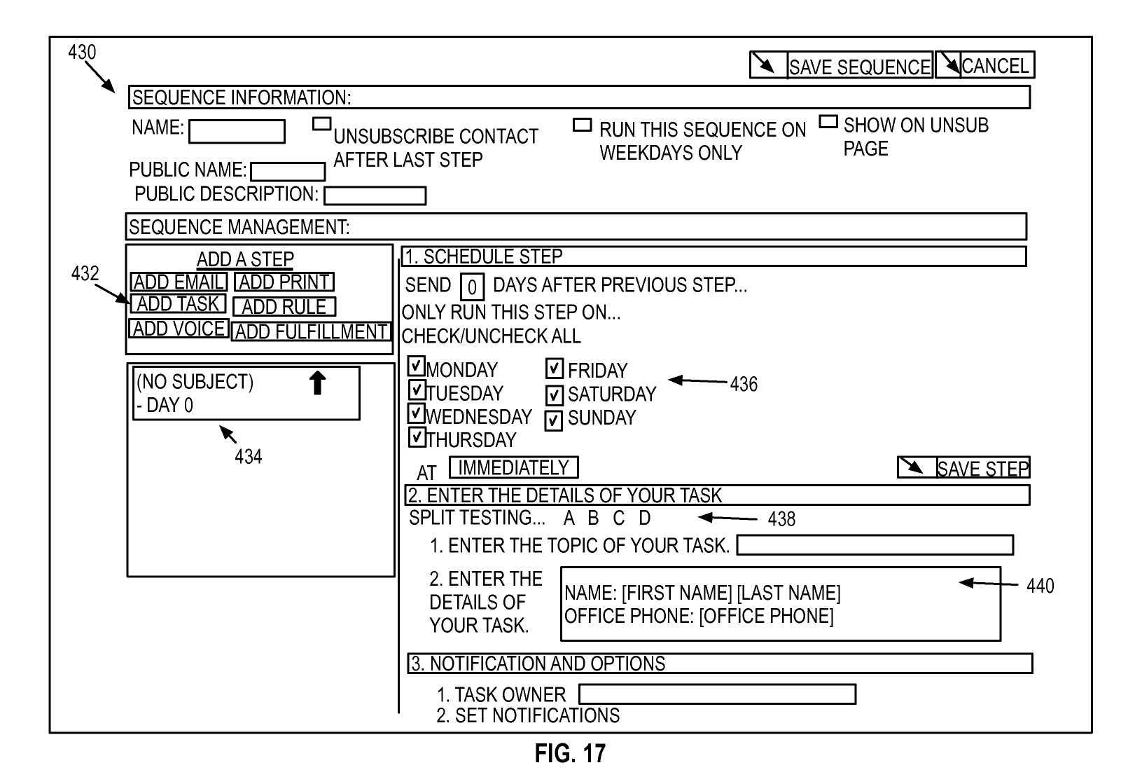

FIG. 17 is a simulated screen 430 for one implementation that illustrates adding a task to a sequence. In the example shown, a task step 432 has been selected, and a new task 434 created. Scheduling details 436 for the task can be specified, as well as split testing options 438, and other details for the task 440, such as a description of the task, who the task owner is, who should be notified regarding the task, etc. As one non-limiting example, a task may be assigned to a system user if a particular contact has visited a certain sales page 3 or more times, so that the system user (who may be a sales rep or customer service rep) can follow-up with the contact (such as by phone or email) to try and close a sale with that contact.

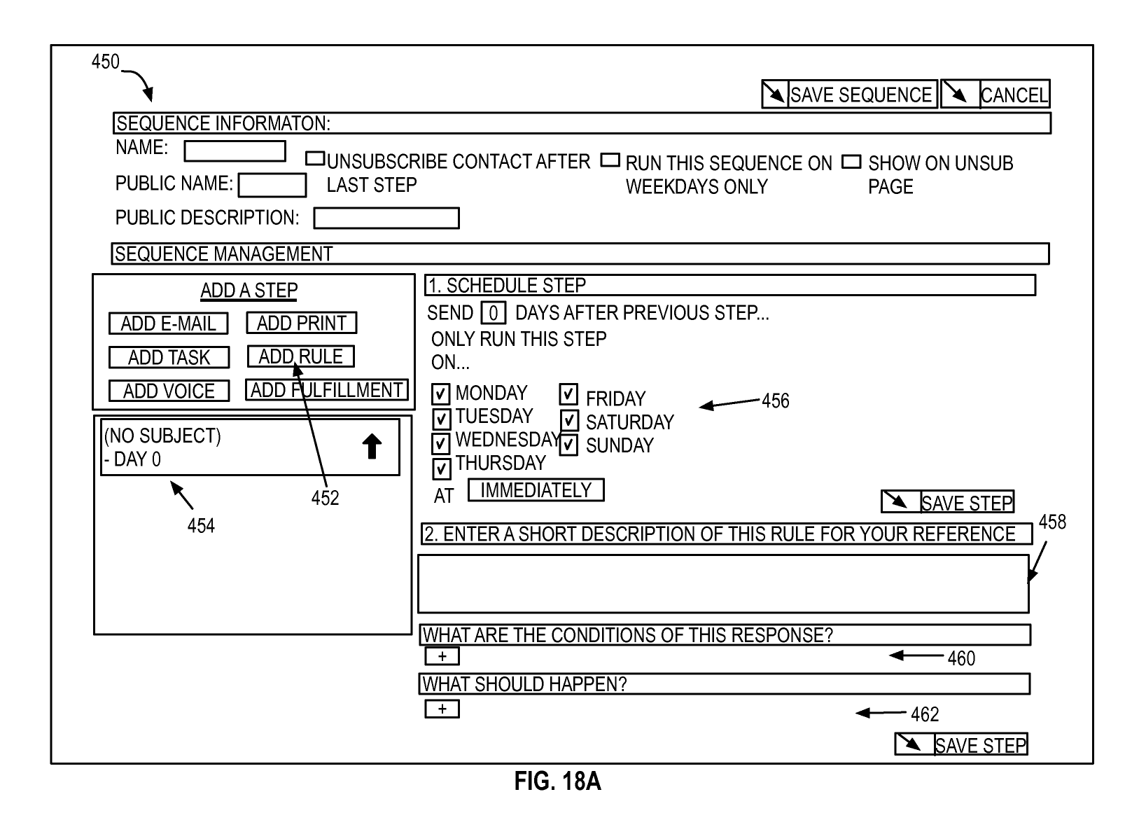

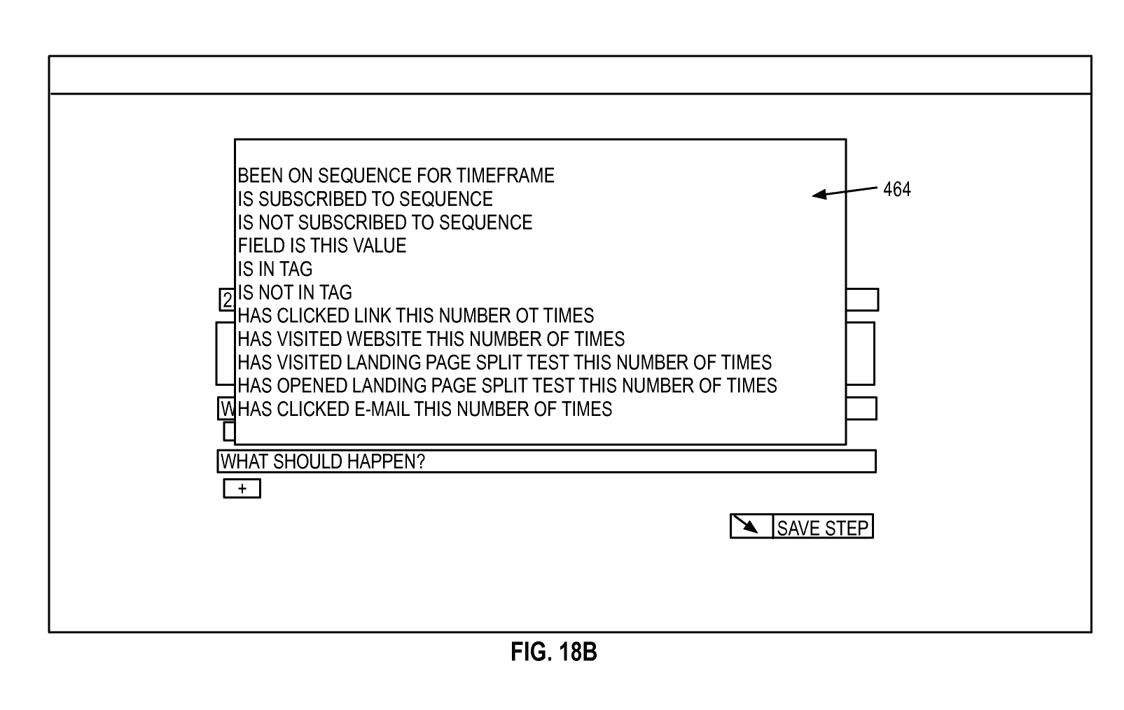

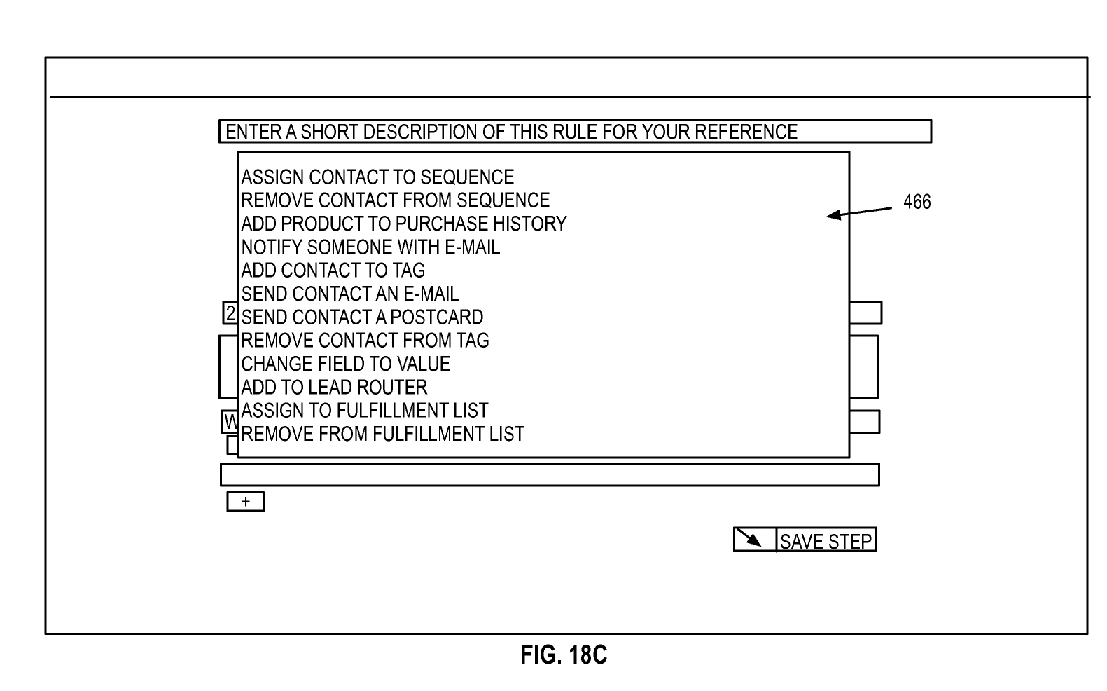

FIG. 18 is a simulated screen 450 for one implementation that illustrates adding a rule to a sequence. The rule step 452 is selected, and then a new rule 454 is displayed. Scheduling details 456 can be specified for the rule. A description of the rule 458 can also be specified, along with the conditions 460 and what should happen 462. Some sample conditions 464 are shown in FIG. 18B, and some sample criteria of what can happen 466 are shown in FIG. 18C.

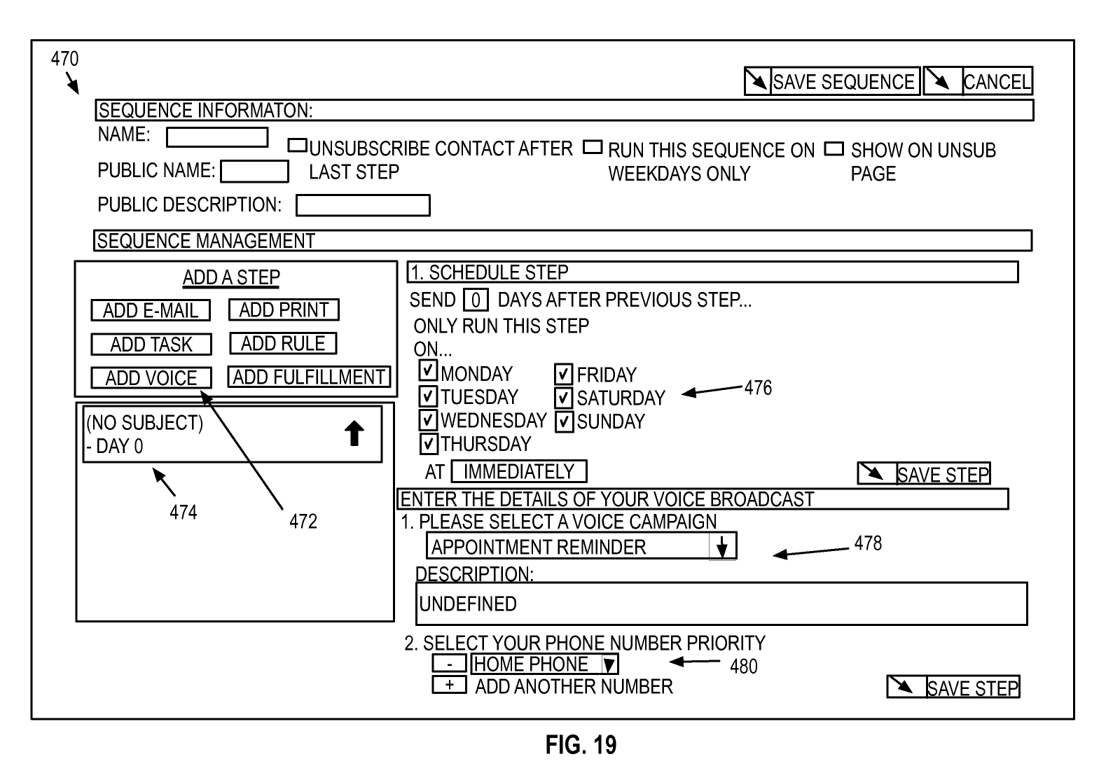

FIG. 19 is a simulated screen 470 for one implementation that illustrates adding a voice broadcast to a sequence. The voice step 472 can be selected, and a new voice step 474 is added. Scheduling details 476 about the voice broadcast can be specified. A particular voice campaign 478 can be selected, along with the phone number priority 480.

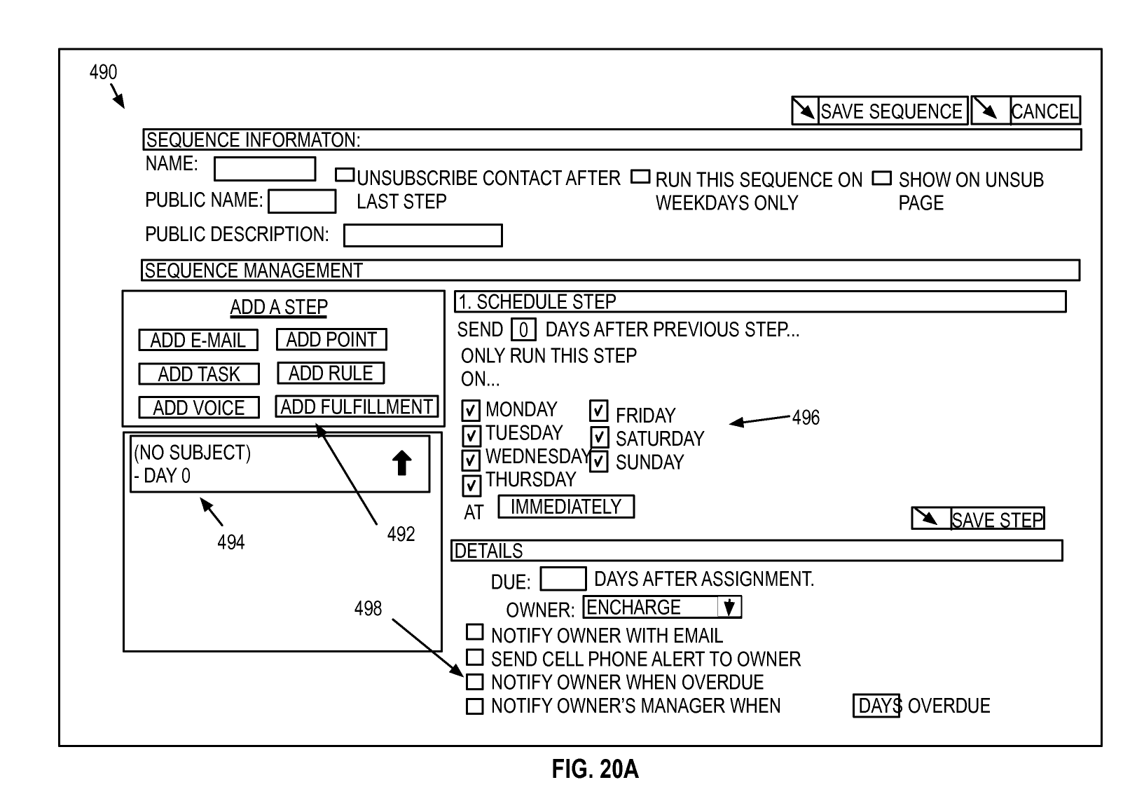

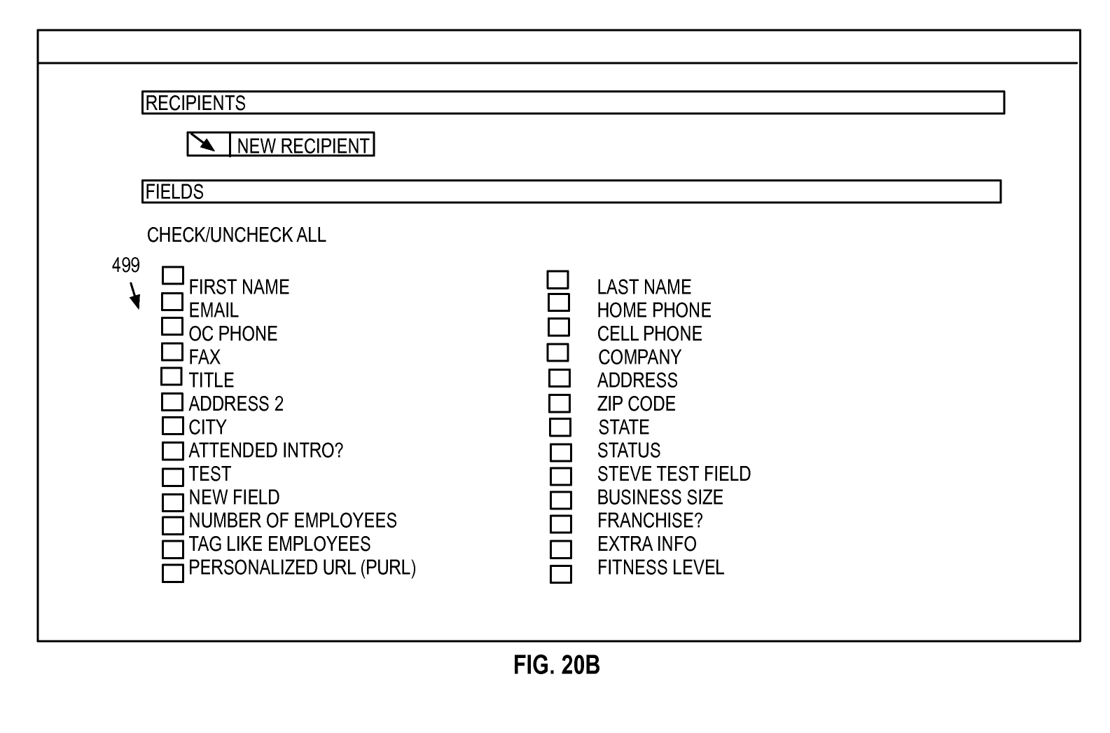

FIGS. 20A-20B are simulated screens 490 for one implementation that illustrate adding a fulfillment item to a sequence. The fulfillment step 492 is selected, and a new fulfillment step 494 is created. Scheduling details 496 about the fulfillment item can be specified, as well as various other details 498 about the fulfillment item, such as notification options, frequency, which fields to include 499 (on FIG. 20B), who to send the fulfillment request to, and so on. The fulfillment step can be used to specify when a certain item needs to be processed manually by a person, such as to mail a customer a physical item, or to send the customer something electronically.

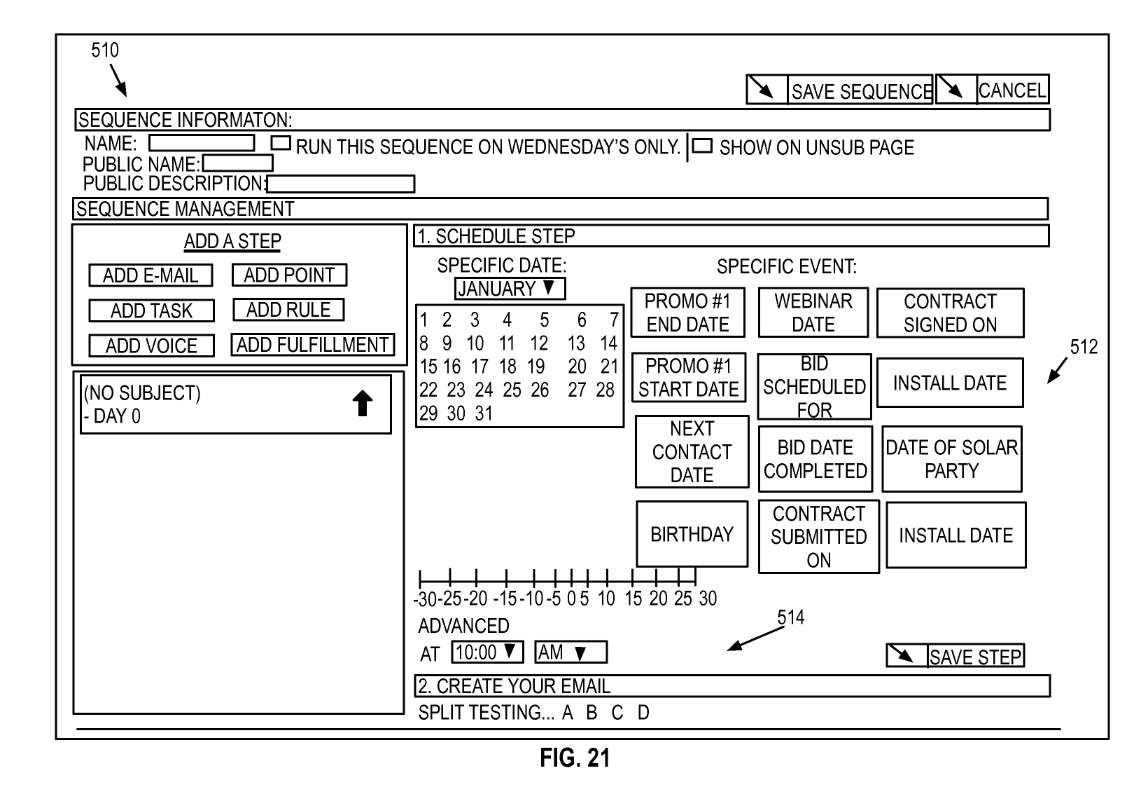

FIG. 21 is a simulated screen 510 for one implementation that illustrates adding a new date sequence. When adding steps to date sequences, the options are very similar to those discussed in the prior screens on adding a standard sequence. One of the differences with date sequences is that different types of scheduling options 512 are available that are specific to certain date options. Some examples of date options include certain promotion start or end dates, install date, birthday, to name a few non-limiting examples. Other details 514 about the date sequence can also be specified, depending on the type of step being added or edited.

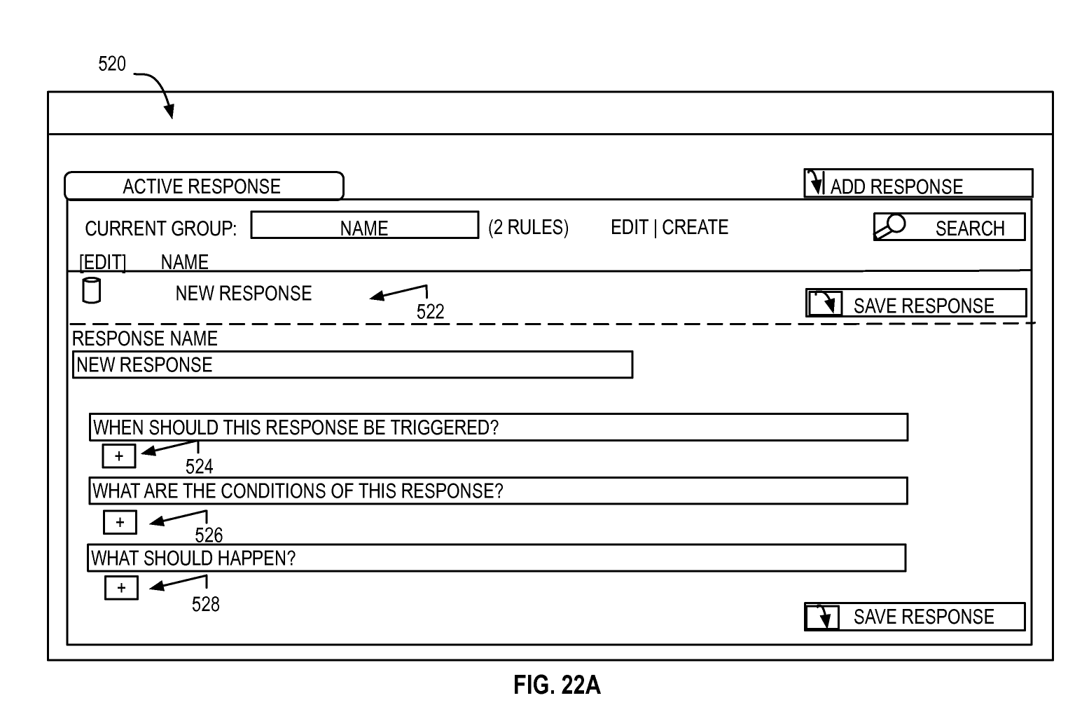

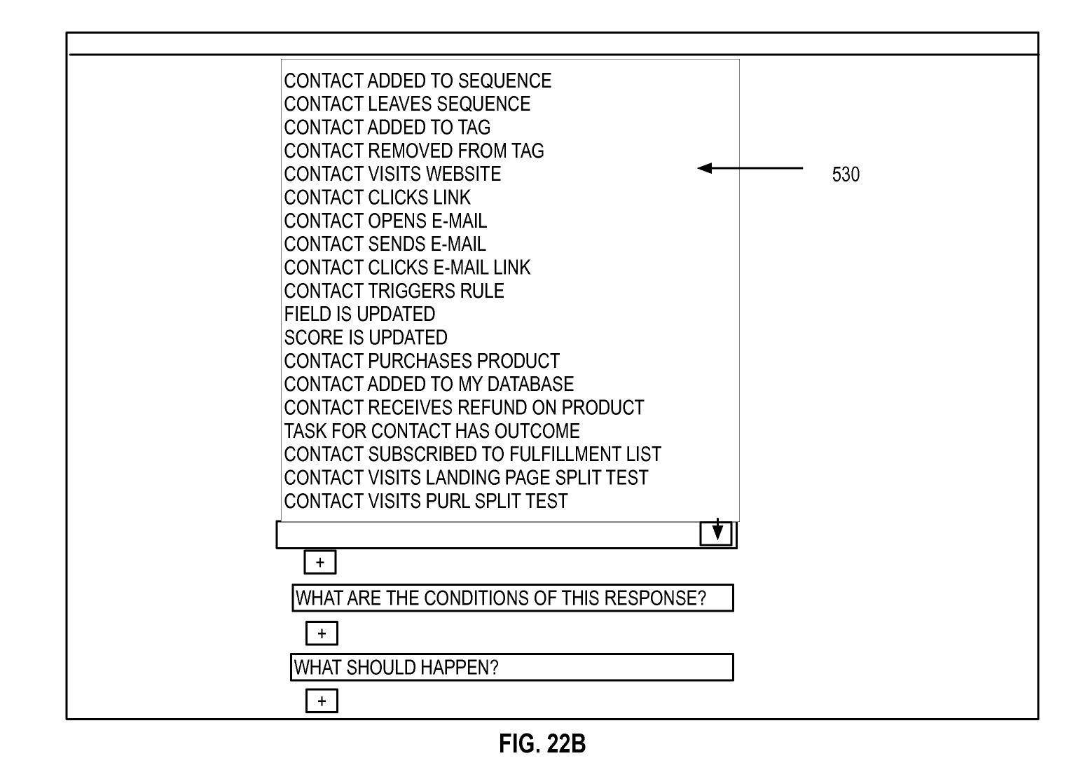

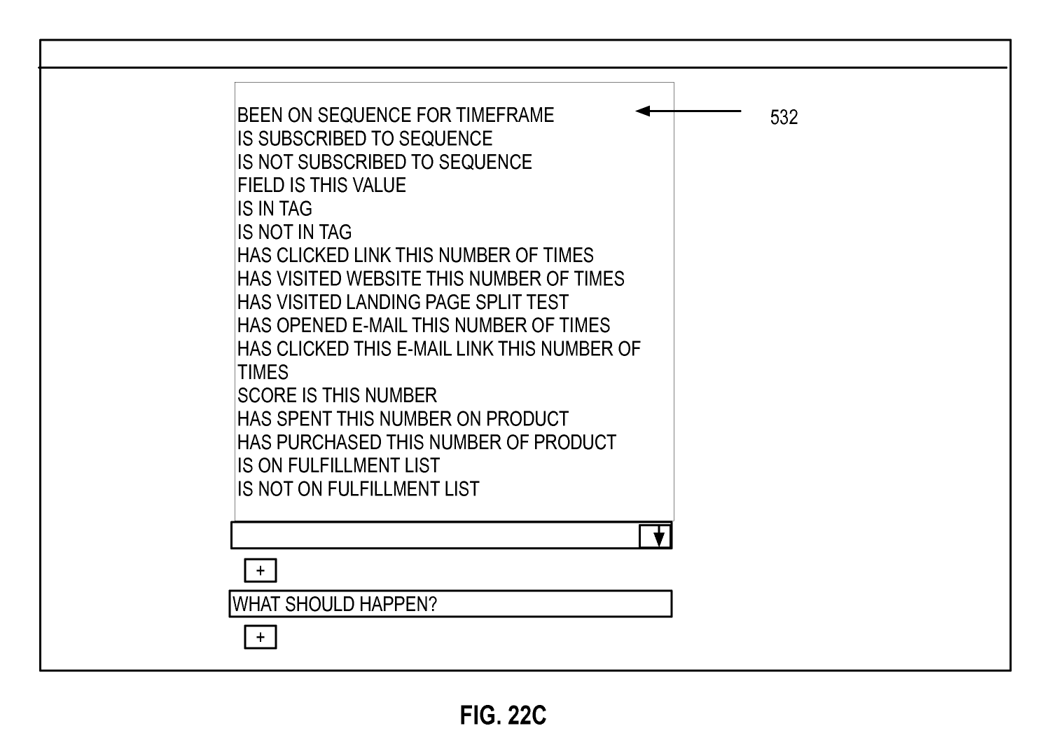

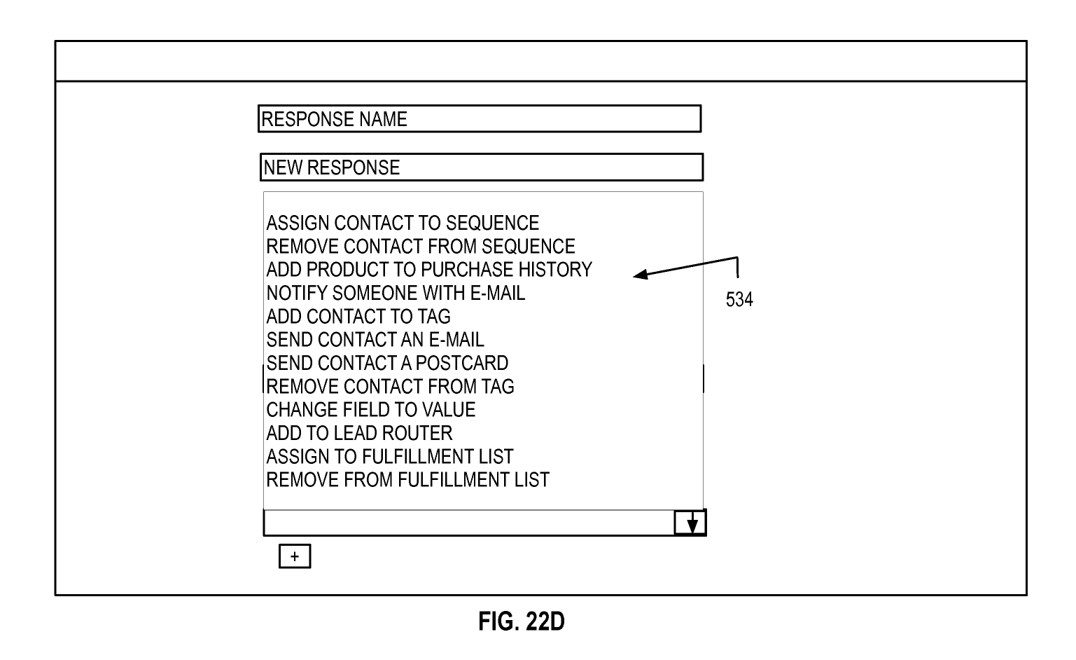

FIGS. 22A-D are simulated screens for one implementation that illustrate adding a new response. As shown in simulated screen 520 in FIG. 22A, the name 522 of the response can be specified, as well as the criteria for when the response should be triggered 524, the conditions of the response 526, and what should happen 528 when the response is triggered. Some examples of criteria for when the response should be triggered are shown in simulated screen 530 of FIG. 22B. Some examples of conditions of the response are shown in simulated screen 532 of FIG. 22C. And some examples of what should happen when the response is triggered are shown in simulated screen 534 of FIG. 22D.

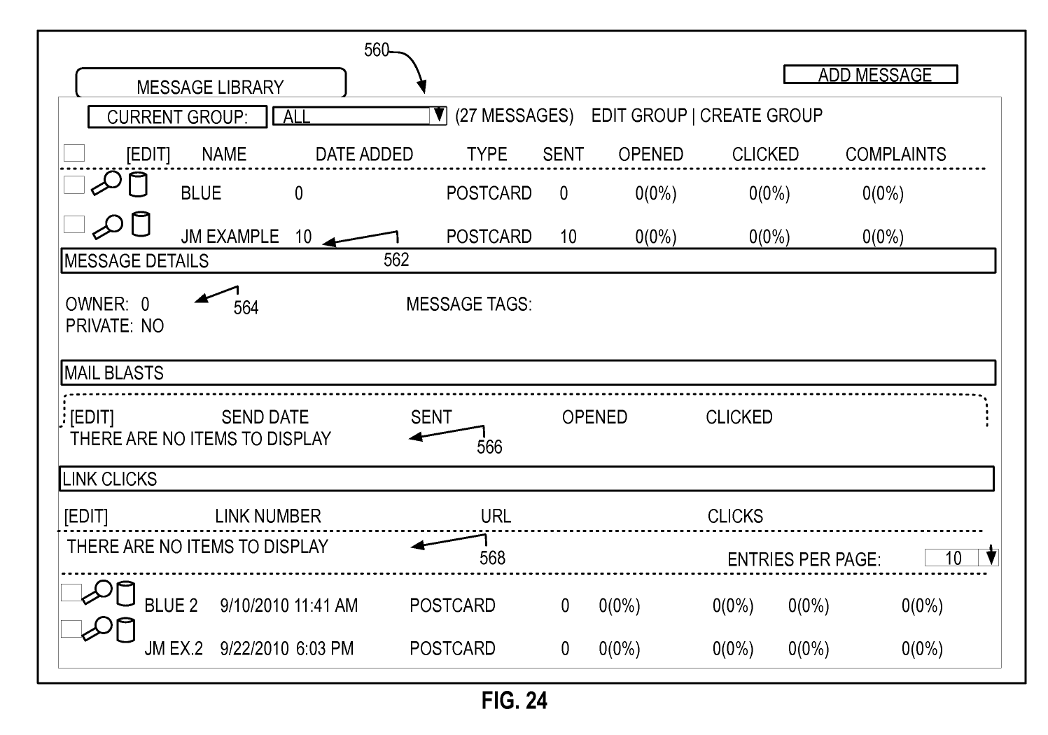

FIG. 23 is a simulated screen 550 for one implementation that illustrates a list of messages that are used to follow-up with contacts. Various details 552 about the messages are displayed, including the message name, date it was added, type of message it is, number of messages sent, number clicked, number of complaints, and number of opt-outs. These details 552 make it easier to see which messages are performing well and which ones are not. Upon clicking the add message option 554, as screen similar to FIG. 24 is displayed.

FIG. 24 is a simulated screen 560 for one implementation that illustrates viewing details about a selected post card 562 in the list of messages. In the example shown, message details 564, mail blast details 566, and link click details 568 are displayed for the post card.

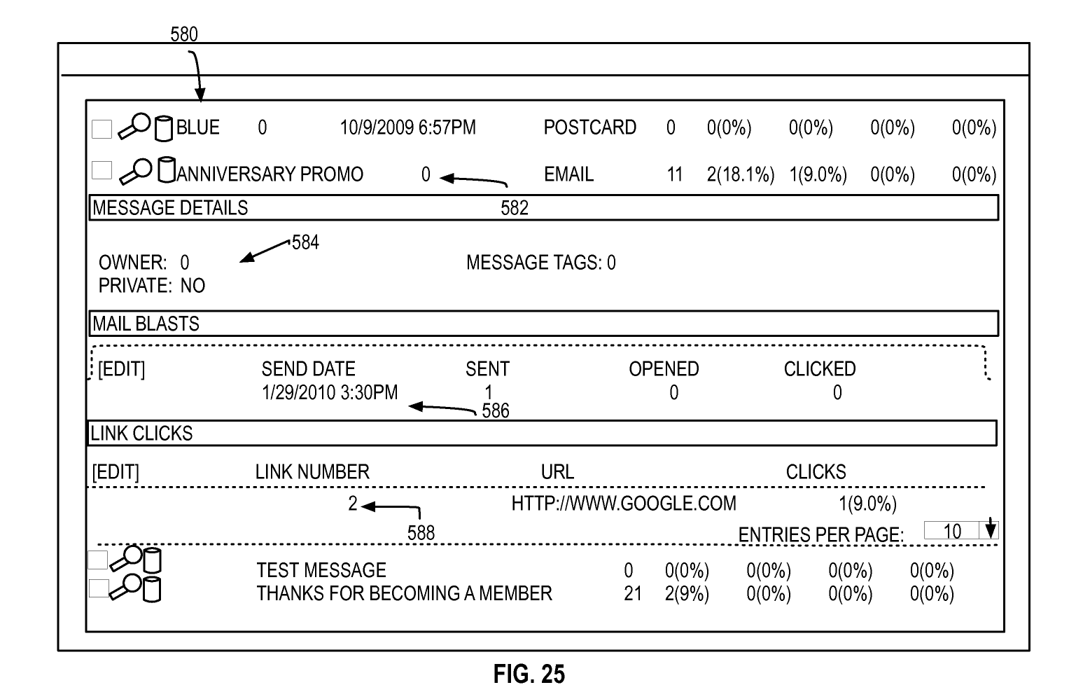

Similarly, FIG. 25 is a simulated screen 580 for one implementation that illustrates viewing details about a selected email 582 in the list of messages. Message details 584, mail blast details 586, and link click details 588 are displayed. In this example, link click details 588 show where the clicks came from.

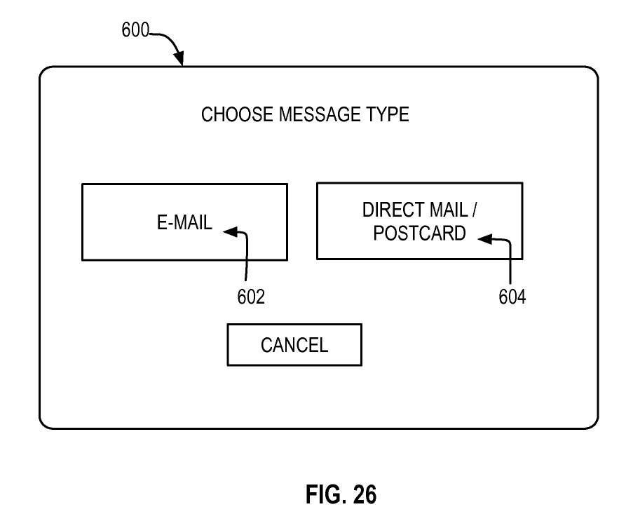

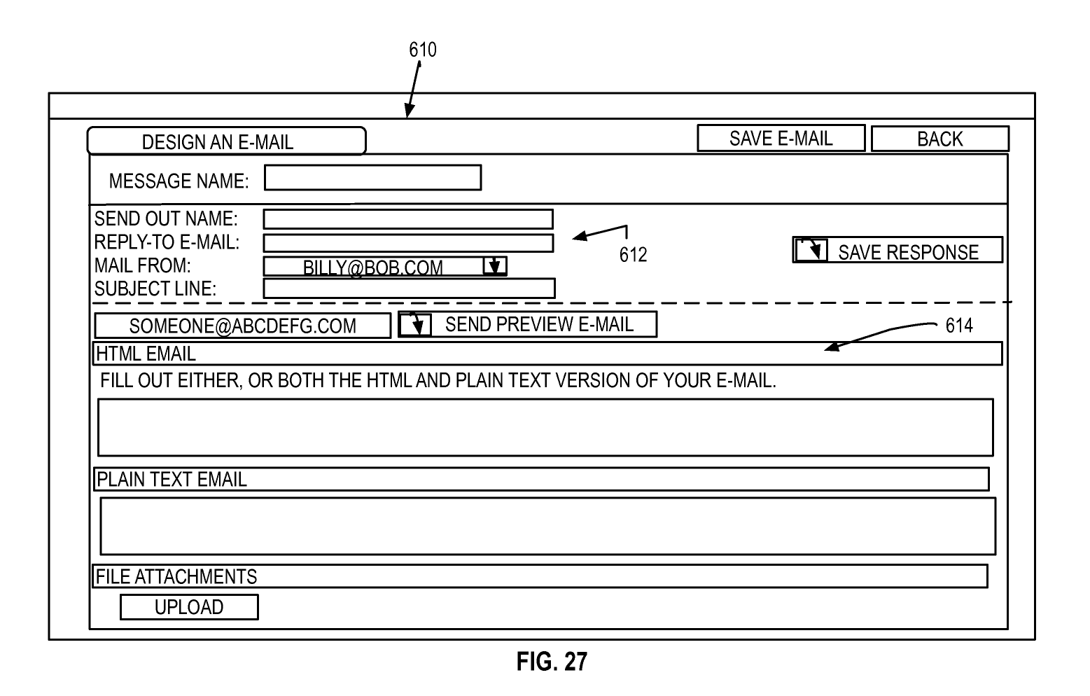

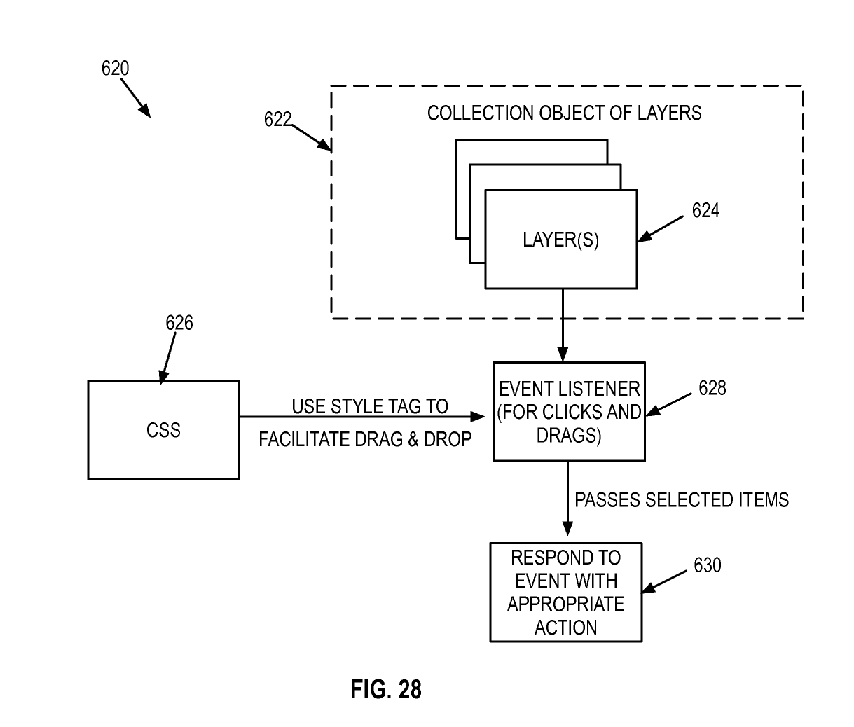

FIG. 26 is a simulated screen 600 for one implementation that illustrates options for adding a new message. A message type can be selected, such as an email 602 or post card 604. The creation of an email is described in FIG. 27, and the creation of a post card or other print media is described in FIGS. 28-45.

FIG. 27 is a simulated screen 610 for one implementation that illustrates creating a new email message. Basic details about the message 612 can be specified, such as sender name, reply email, from email, and subject. The body of the email 614 can also be specified, along with other email details.

FIG. 28 is a diagrammatic view 620 of a designer that allows certain content for the business automation system 100 to be created in a graphic format. A collection object 622 is used for tracking each layer 624. In one implementation, the collection object is created in a script language, such as JavaScript. Style tags of the cascading style sheets 626 are used to facilitate drag and drop operations. An event listener 628 listens for click and drags that occur on any of the layers in the designer. The event listener 628 responds to the events that are raised with the appropriate action 630. In one implementation, the event listener 628 takes the appropriate action 630 by delegating the performance of the action(s) to the appropriate layer(s). The layer(s) can then perform one or more appropriate actions depending on the context and current state of the application. This facilitates the ability to take action on multiple layers at once, such as to move 3 graphic layers at the same time, to name one non-limiting example.

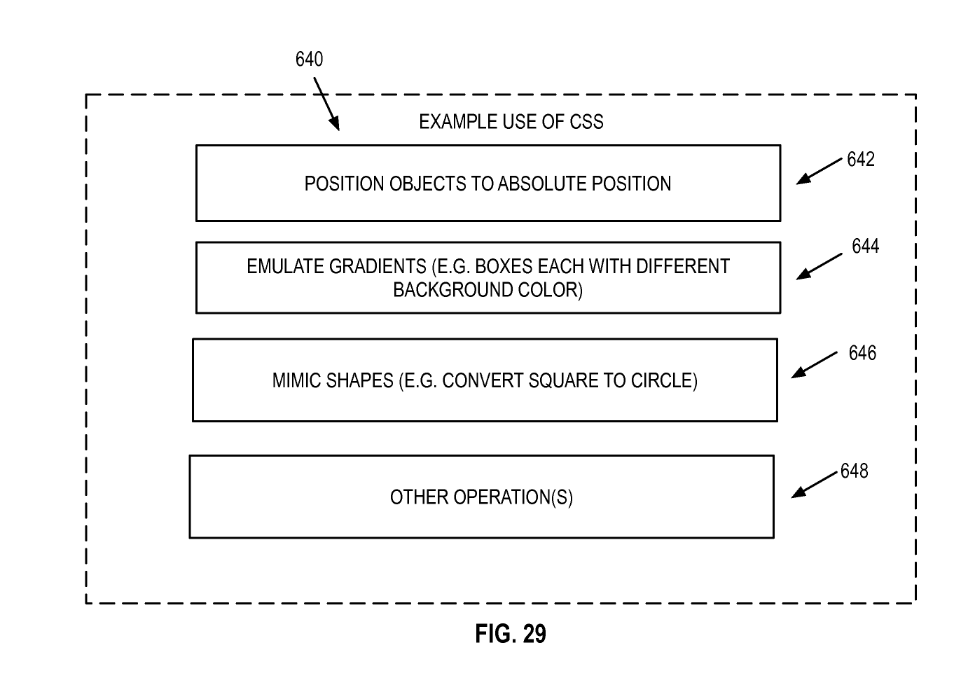

FIG. 29 is a diagrammatic view 640 of some exemplary ways that cascading style sheets are used by the designer to help create a graphical designer interface that feels a lot like a typical desktop designer experience. In one implementation, cascading style sheets are used to position objects to an absolute position 642 in the designer. In another implementation, cascading style sheets are used to emulate gradients 644. For example, a certain number of boxes (such as 50 boxes that are 1 pixel tall) can be lined up in a row, each with a different color. They can be stacked to form a square or other shape. Since each box has a different color that is slightly different than the one before, a gradient effect can be achieved.

In another implementation, cascading style sheets are used to mimic shapes 646. For example, shapes can be broken down into a certain number of boxes (such as 50 boxes that are 1 pixel tall). At a given Y point, the system determines how wide the circle can be, and then adjusts the particular box accordingly. Cascading style sheets can also be used for other operations 648 in the designer. As one non-limiting example, other operations 648 can include stylizing and controlling the appearance and shape of layers. This can include setting the color of a box or other layer to a certain color, formatting the font size, type, and/or style (bold, underline, etc.), and/or specifying where the graphic or other object is located on the page (post card or otherwise), to name a few examples.

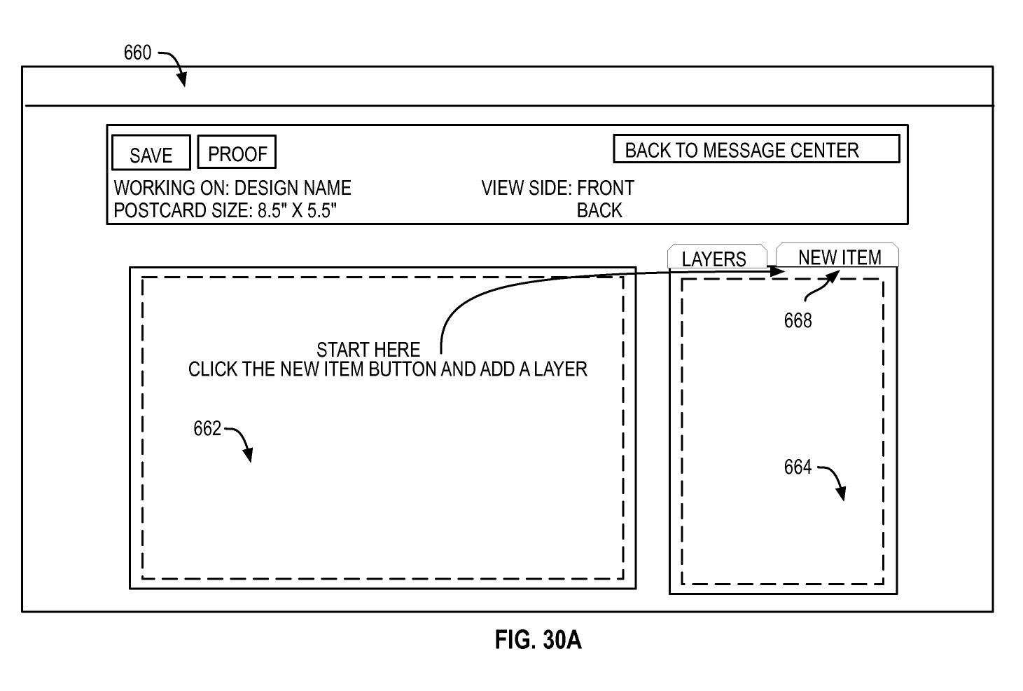

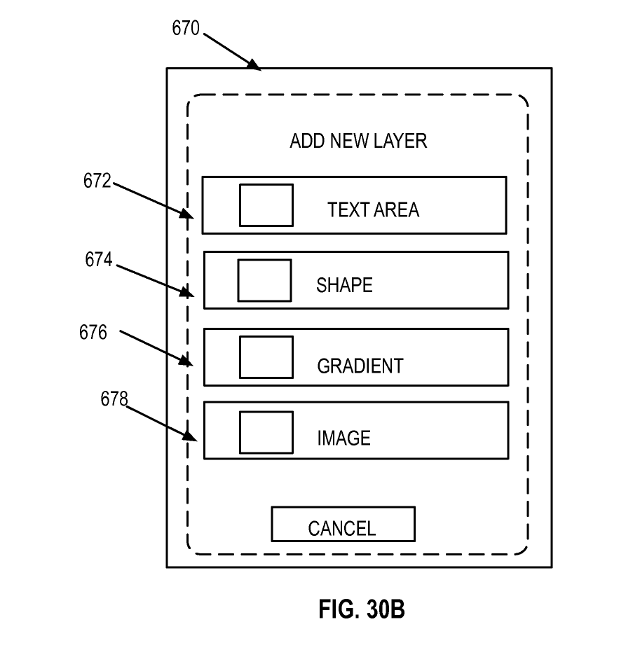

FIG. 30A is a simulated screen 660 for one implementation that illustrates a designer that allows a post card or other direct mail piece to be created. The design area 662 is displayed, along with the layers area 664. The layers area 664 allows you to drag and drop individual layers to control which one is “on top”, to select a certain layer for editing, etc. To add a new layer, the new item option 668 can be selected. General options for the print material (e.g. post card or newsletter) are displayed above the designer. This can include horizontal or vertical orientation, etc. A toolbar to affect design changes to individual layers is located above the designer.

FIG. 30B is a simulated screen 670 for one implementation that illustrates adding a new layer to the post card or other direct mail piece in the designer. In one implementation, layers that can be added include a text area 672, shape 674, gradient 676, and image 678.

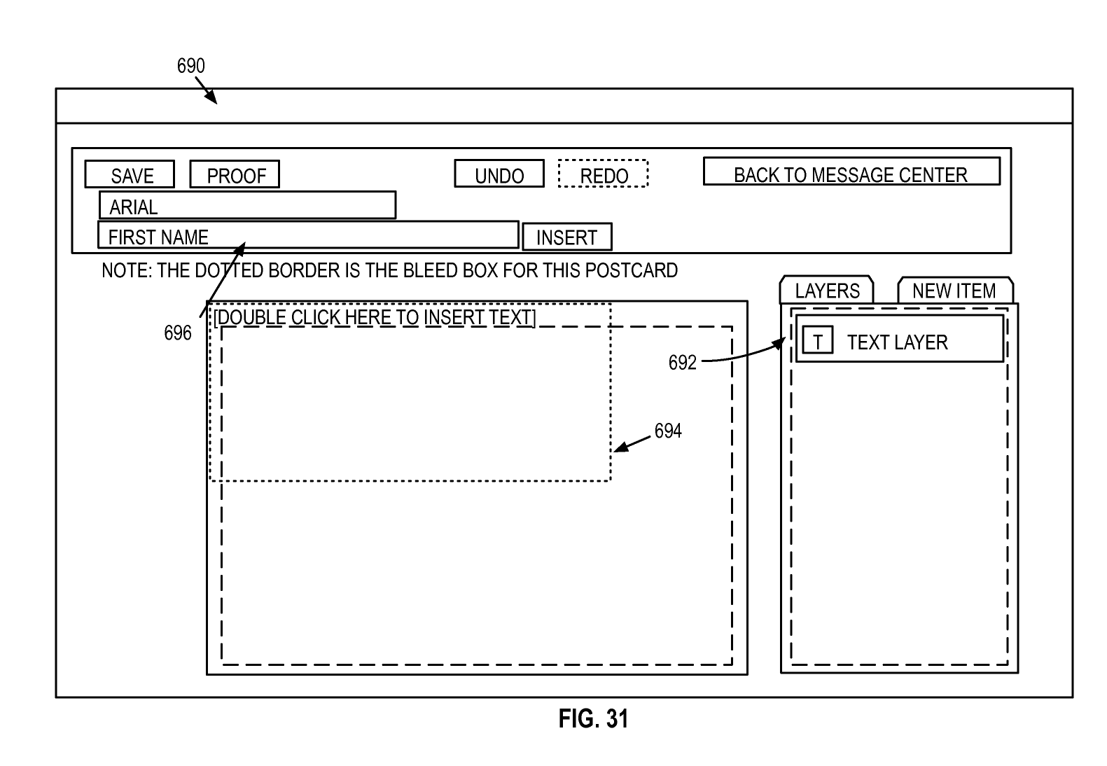

FIG. 31 is a simulated screen 690 for one implementation that illustrates adding a text layer 692 to a post card. The contents 694 of the text layer can be selected and edited. The text layer can also be re-sized.

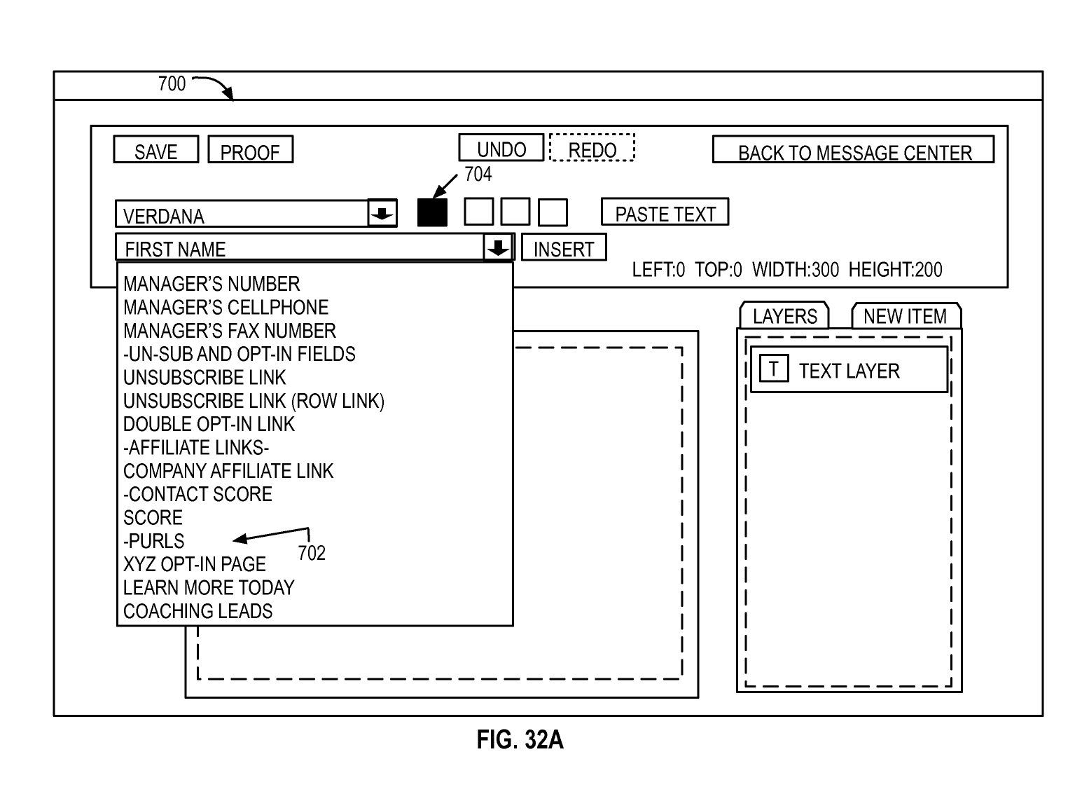

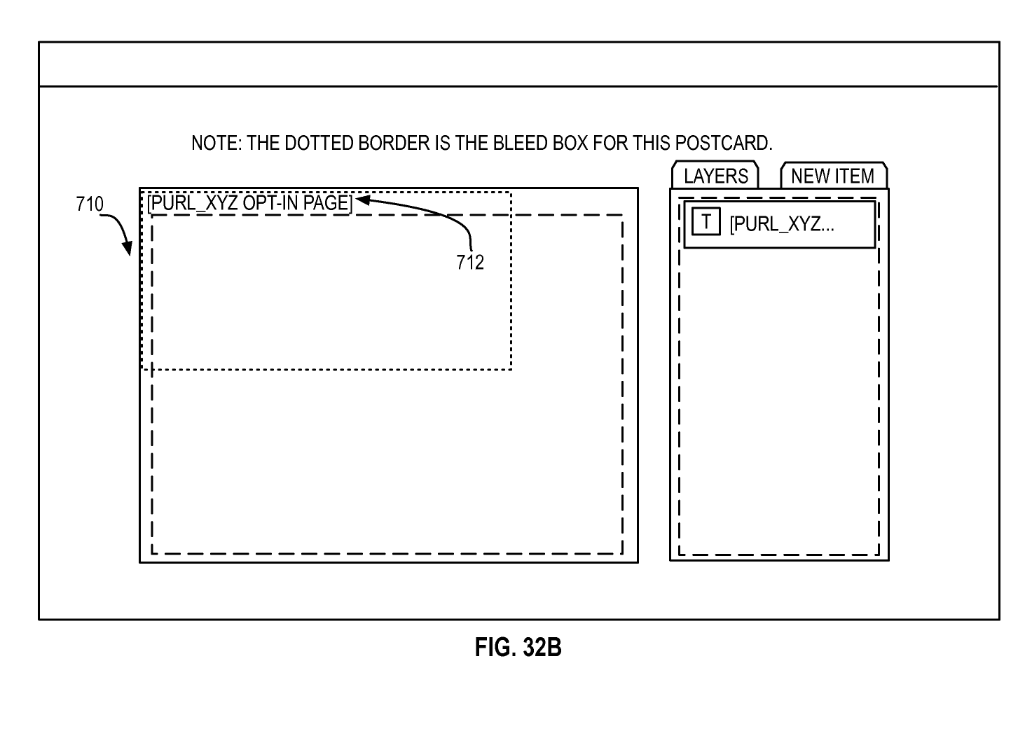

FIGS. 32A-32B are simulated screens for one implementation that illustrate adding database merge fields, such as a personalized URL, into a selected layer. In the simulated screen 700 of FIG. 32A, a personalized URL database merge field 702 is being selected and inserted into the selected text layer. As shown in simulated screen 710, the personalized URL database merge field 712 has been inserted into the text layer. In other words, when the post card is generated, the merge field will be replaced with the corresponding data from the database, such as a personalized URL that contains the name of the person to whom the post card is being sent. Color option 704 and other formatting and style options are available for each layer.

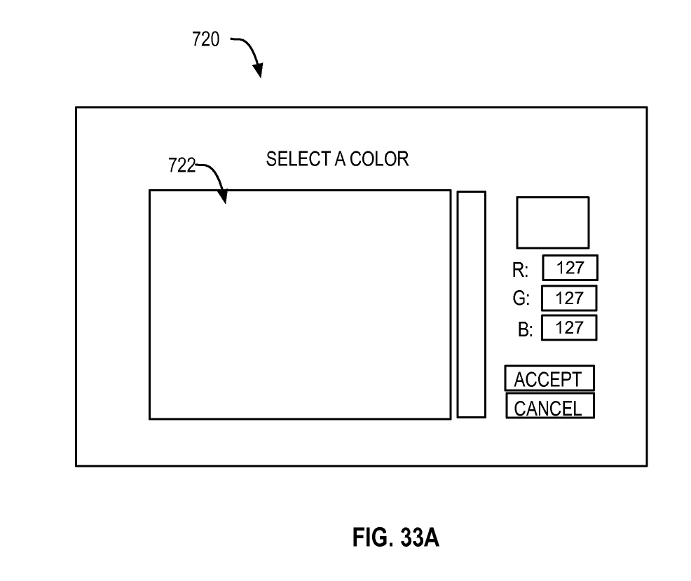

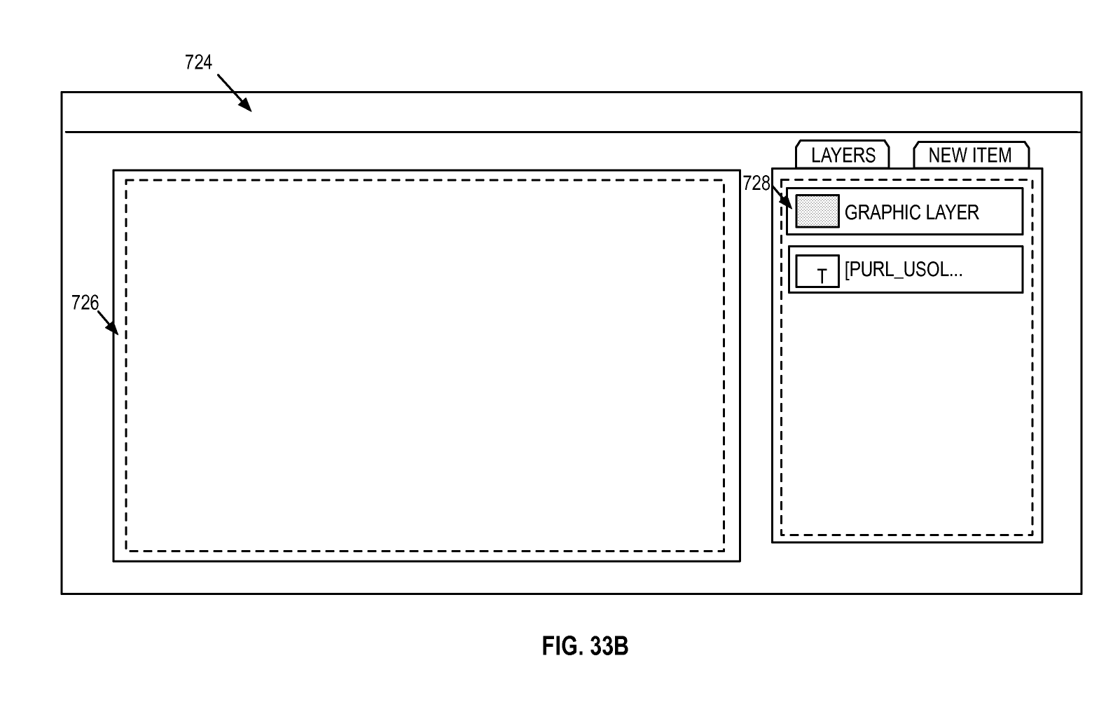

FIG. 33A-33B are simulated screens for one implementation that illustrate changing the color of a selected graphic layer in the designer. In simulated screen 720 of FIG. 33A, a new color 722 has been selected, and applied to the rectangle 726 in the selected graphic layer 728 that is shown in simulated screen 724 of FIG. 33B.

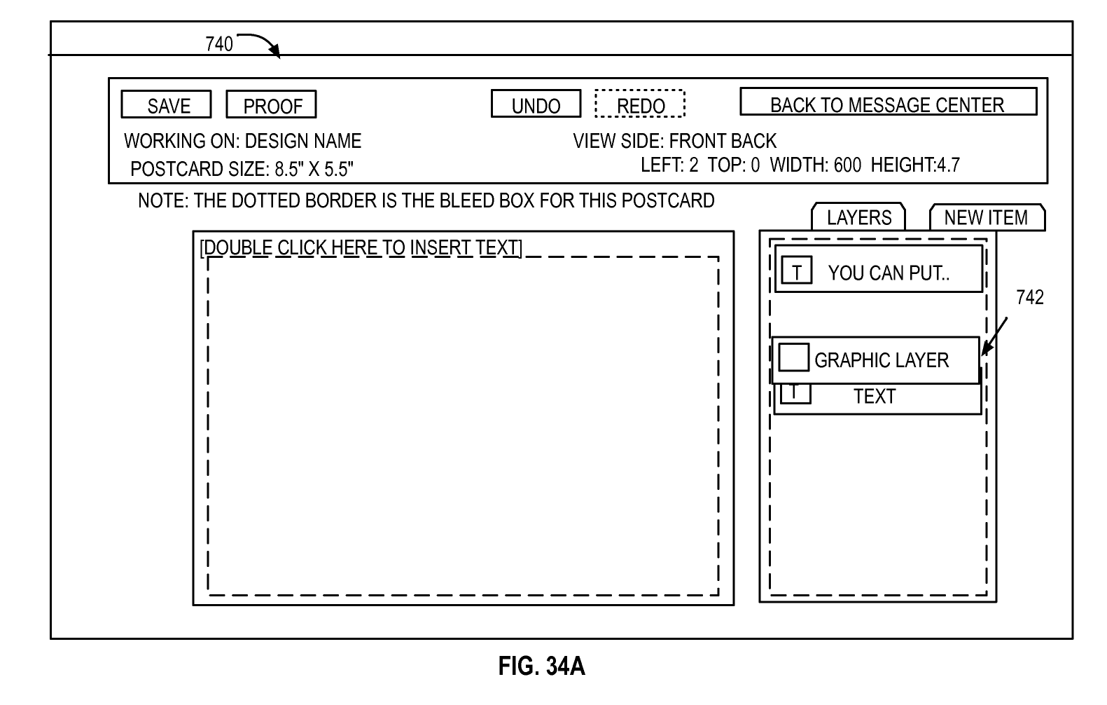

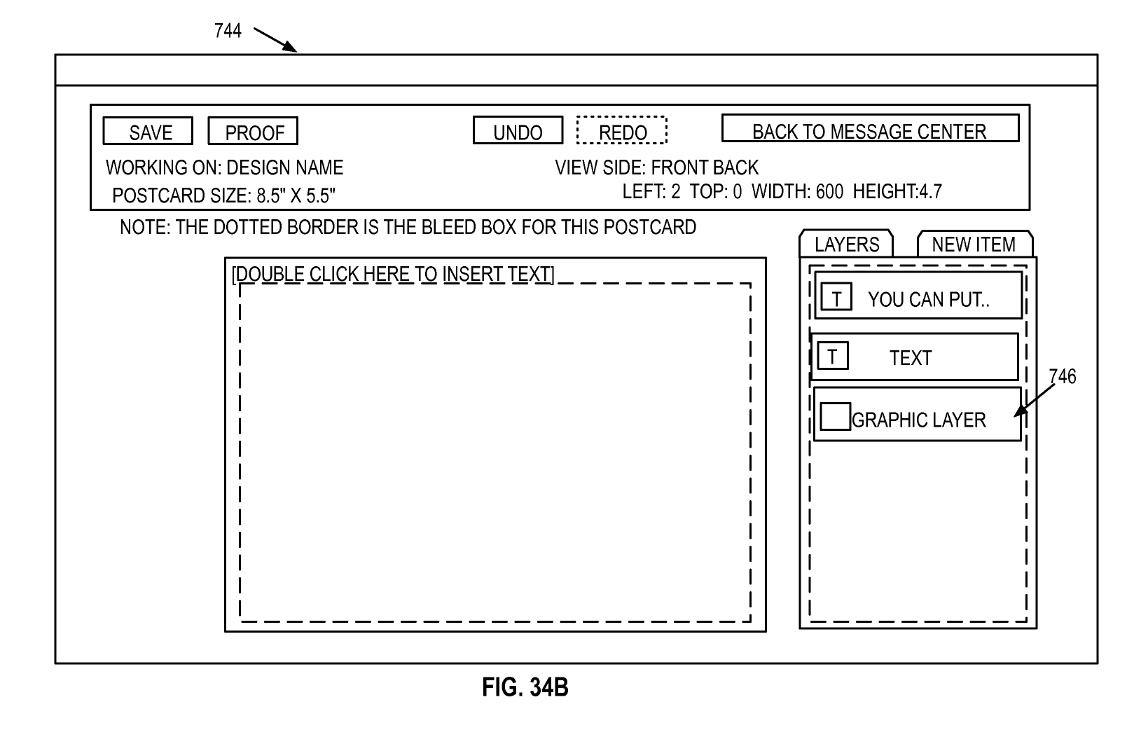

FIGS. 34A-34B are simulated screens for one implementation that illustrates re-ordering the layers in the designer. In simulated screen 740 of FIG. 34A, a selected graphic layer 742 is being dragged in a different direction to change the ordering of the layers. In simulated screen 744 of FIG. 34B, the selected graphic layer 746 is now placed in a new position underneath the text layers. Dragging and dropping of layers can impact the visibility of certain content on the post card. In this example, some of the text was hidden until the layers were re-ordered.

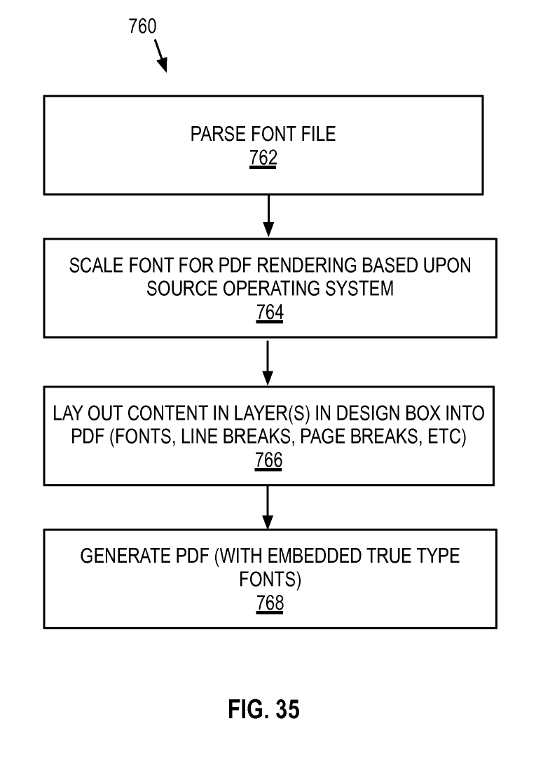

FIG. 35 is a process flow diagram 760 that illustrates one implementation of the stages involved in generating a PDF proof of the print material (e.g. direct mail piece) from the designer. A font file is parsed (stage 762) to retrieve details about the true type fonts that will be used to generate the PDF. The font(s) is/are scaled for PDF rendering based upon the source of the operating system (stage 764). For example, the way a computer that runs Microsoft Windows displays a PDF is different than the way a Mac computer might display a PDF, etc.

The content that is contained in the layers in the design box in the post card designer is then laid out in the PDF (stage 766). The fonts, page breaks, line breaks, and other formatting are applied. The PDF is generated with true type fonts embedded in the file (stage 768). In one implementation, the PDF proof is generated and sent to the user for downloading while part of the PDF is still being created. In another implementation, the PDF proof is sent to the user for downloading after the PDF is fully generated. In other implementations, the proof can be generated in one or more other formats instead of, or in addition to a PDF format (such as a Word document, JPG file, etc.)

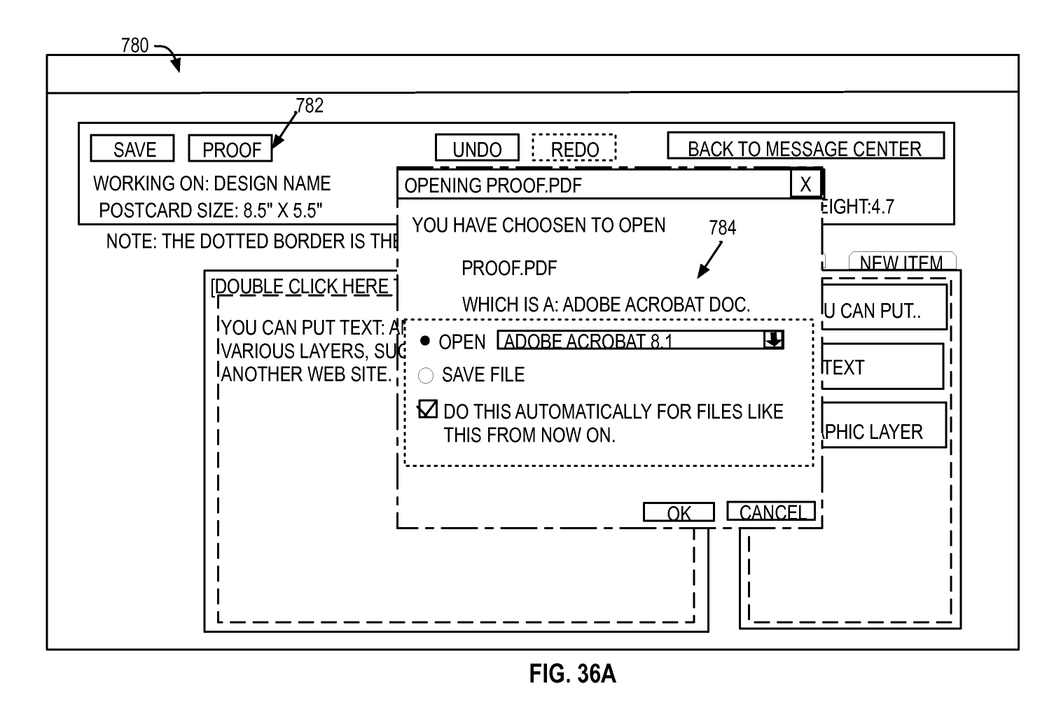

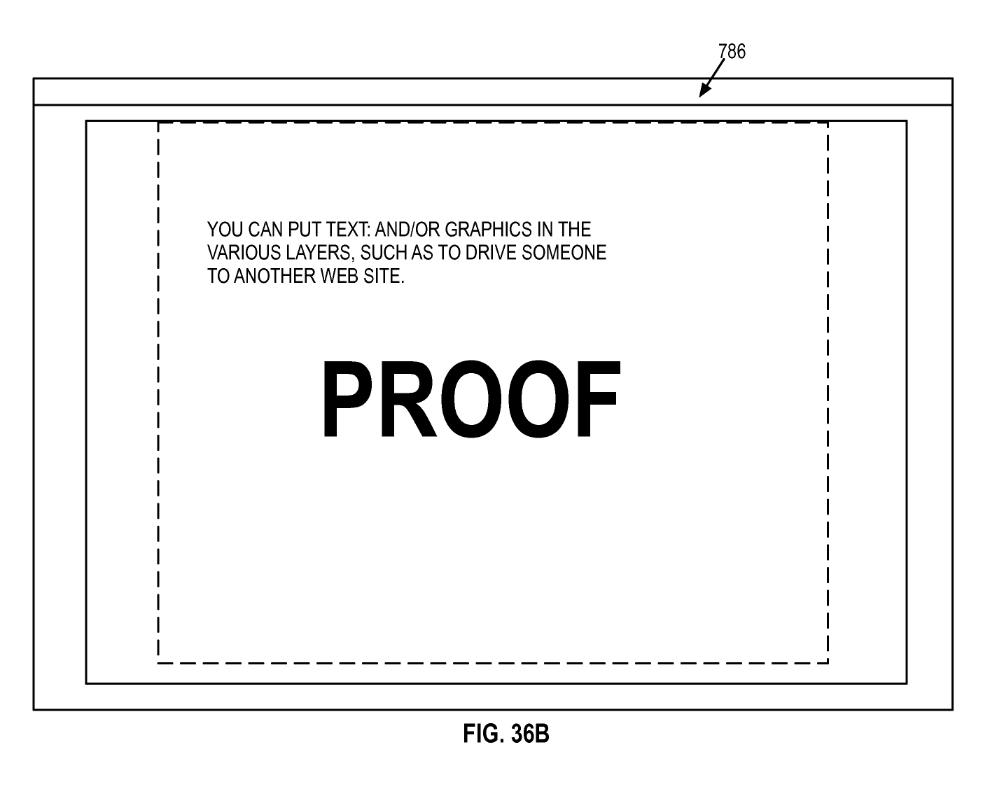

FIGS. 36A-36B are simulated screens for one implementation that illustrate creating a proof from the designer and viewing it. In the simulated screen 780 of FIG. 36A, the user can select the proof option 782, and the proof is generated using the process described in FIG. 35. An option 784 to download or view the resulting PDF proof is then displayed. Upon selecting to open the PDF, a simulated screen 786 of FIG. 36B is then displayed to display the contents of the post card or other direct mail piece in a proof format.

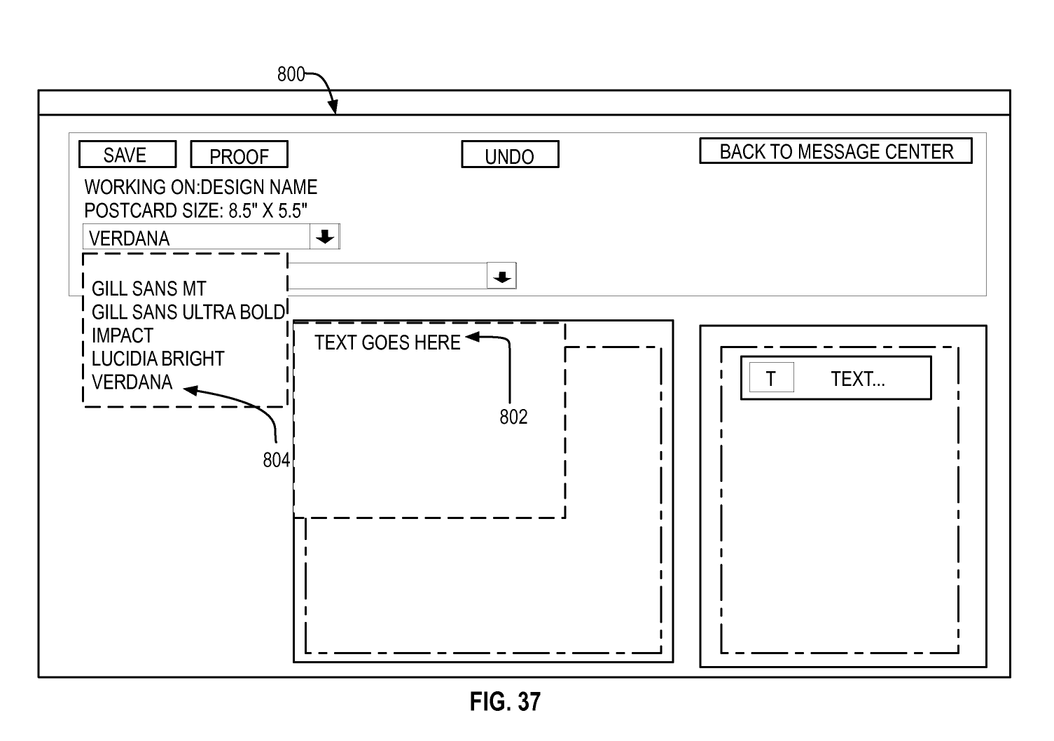

FIG. 37 is a simulated screen 800 for one implementation that illustrates changing the font 804 of selected text 802 in a text layer in the designer. Other text options are also available, such as font color, font size, etc.

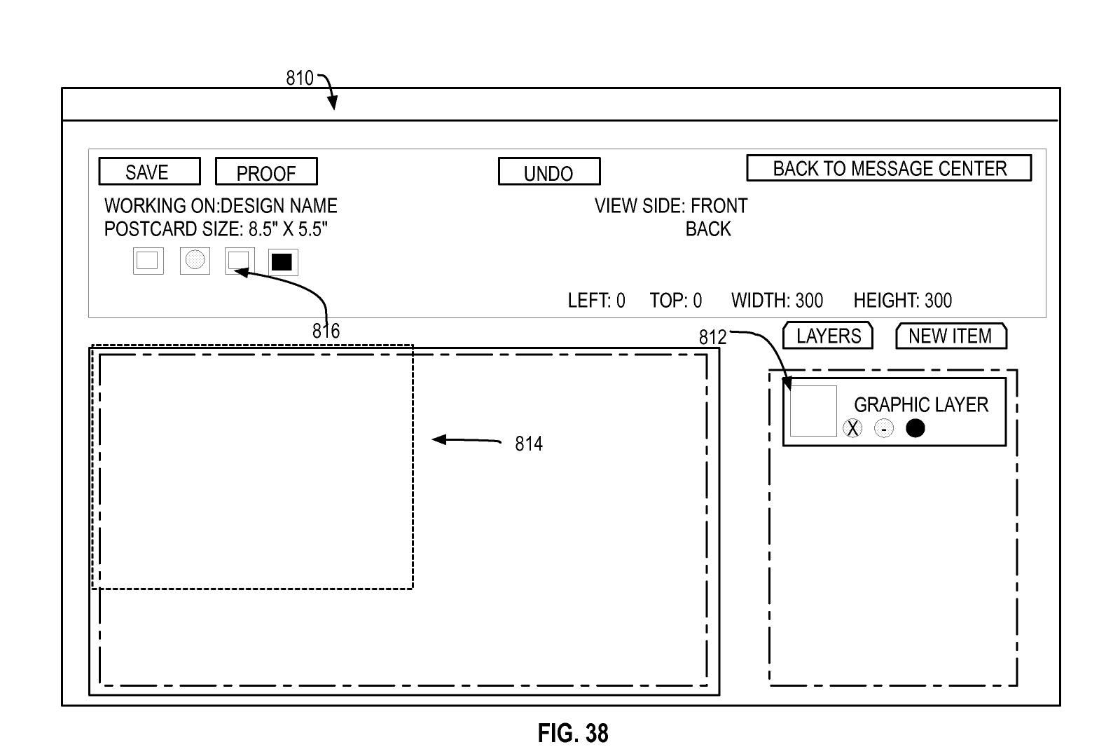

FIG. 38 is a simulated screen 810 for one implementation that illustrates creating a new graphic layer in the designer. In this example, the graphic layer 812 is a rectangle 814. The rectangle 814 can be edited in various ways with editing options 816, such as to convert rectangle 814 to a circle, change its color, change its opacity, etc.

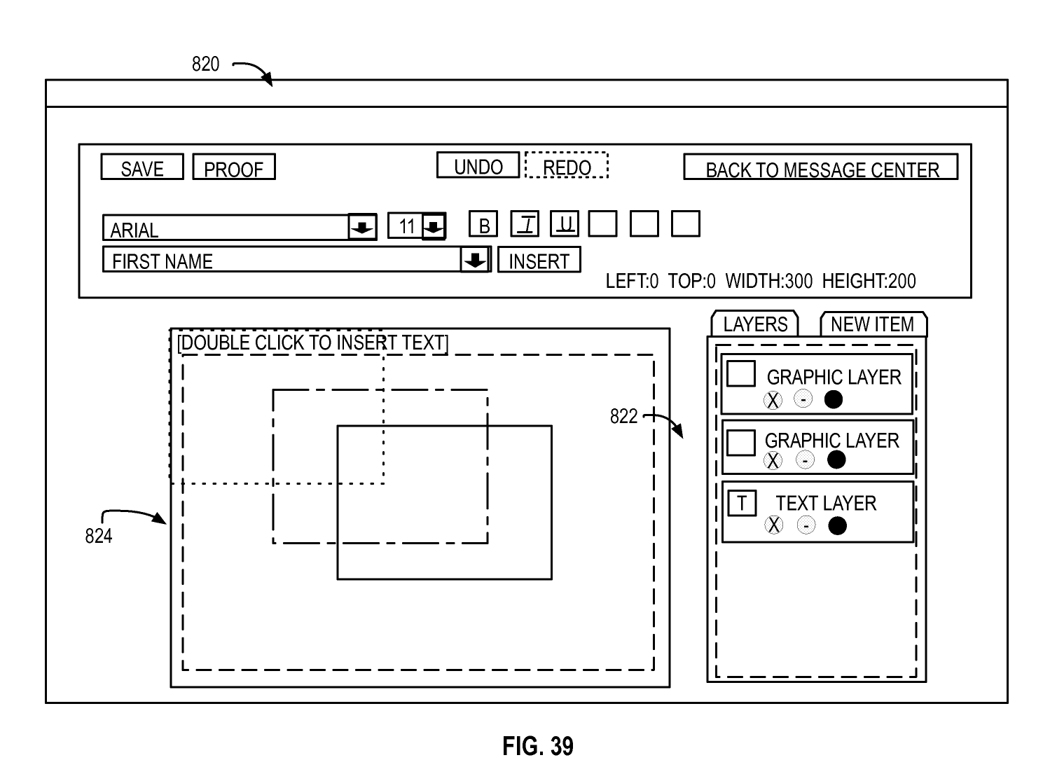

FIG. 39 is a simulated screen 820 for one implementation that illustrates multiple layers 822 in the designer that can each be selected and/or edited 824.

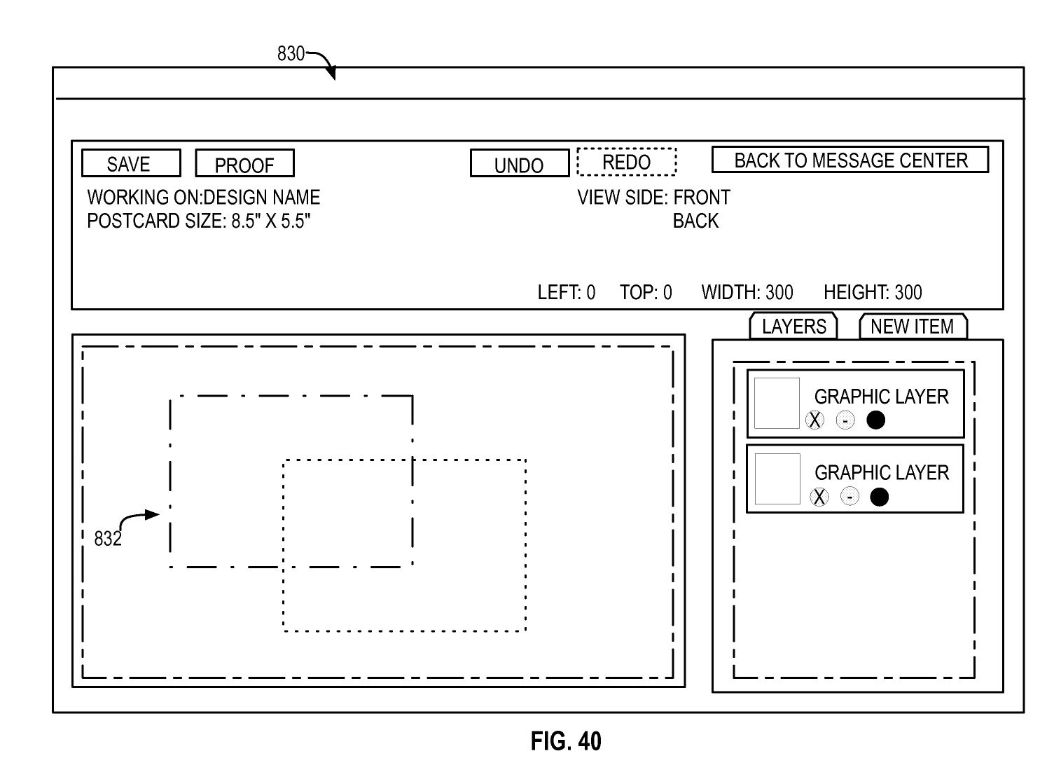

FIG. 40 is a simulated screen 830 for one implementation that illustrates two graphic layers in the designer that are rectangles 832.

FIG. 41 is a simulated screen 840 for one implementation that illustrates deleting the selected layer 842 from the designer. In one implementation, the selected layer 842 can be deleted by pressing the delete key on a keyboard. In another implementation, the selected layer 842 can be deleted by selecting the delete layer option on the layer itself.

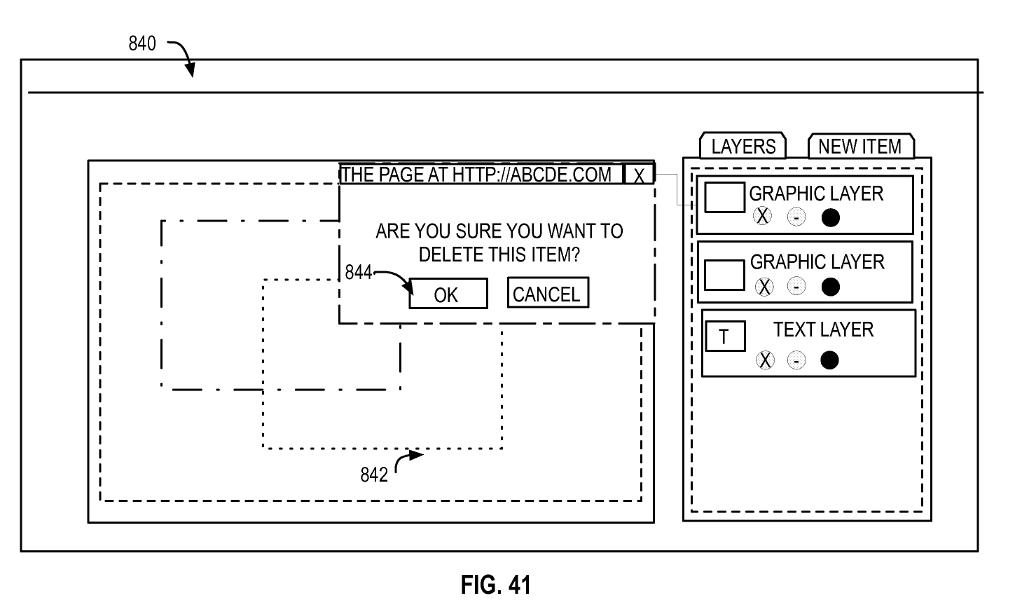

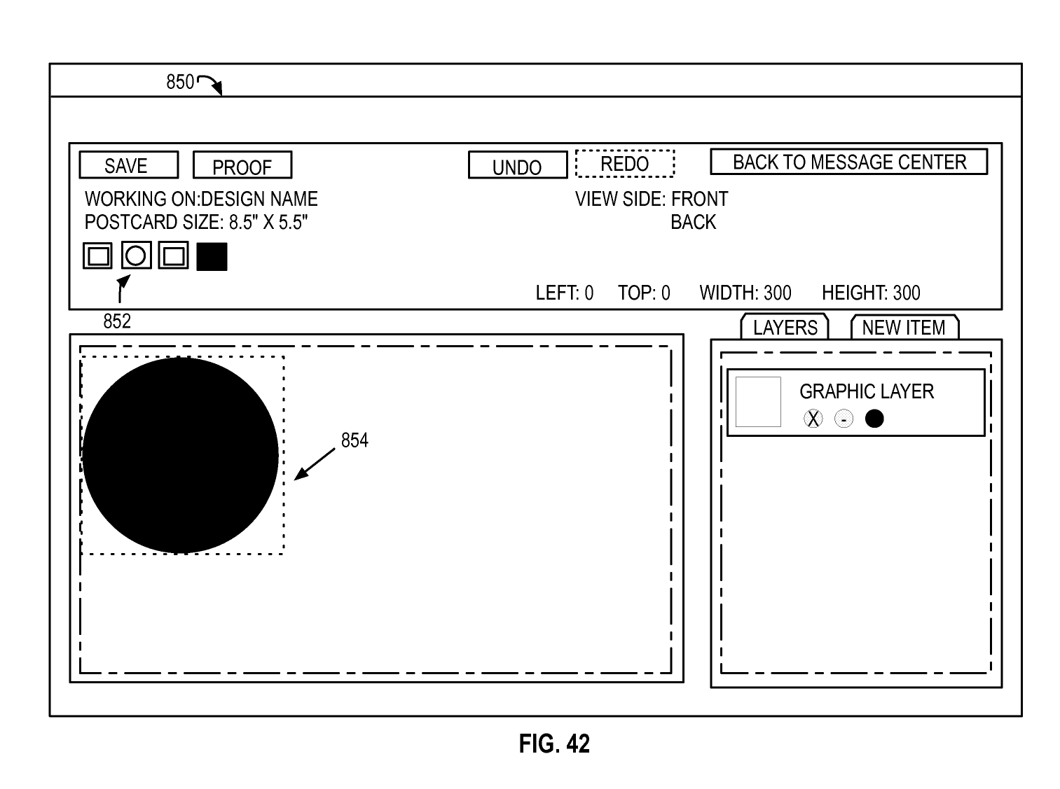

FIG. 42 is a simulated screen 850 for one implementation that illustrates changing 852 a rectangle graphic layer to a circle 854 in the designer.

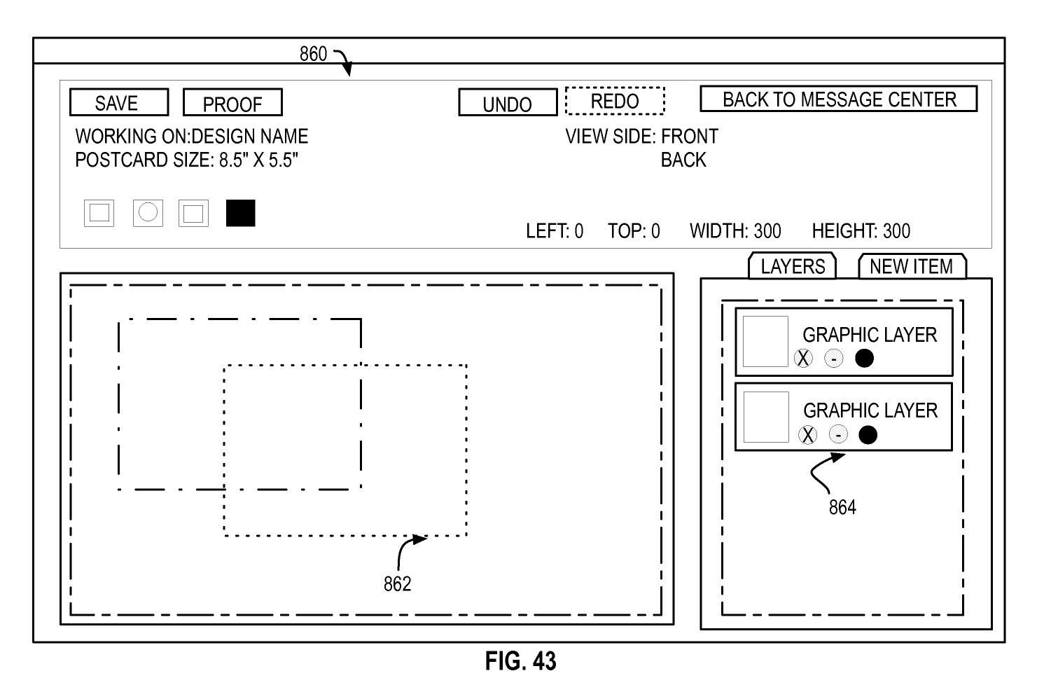

FIG. 43 is a simulated screen 860 for one implementation that illustrates hiding a selected layer 862 in the designer by selecting the hide option 864.

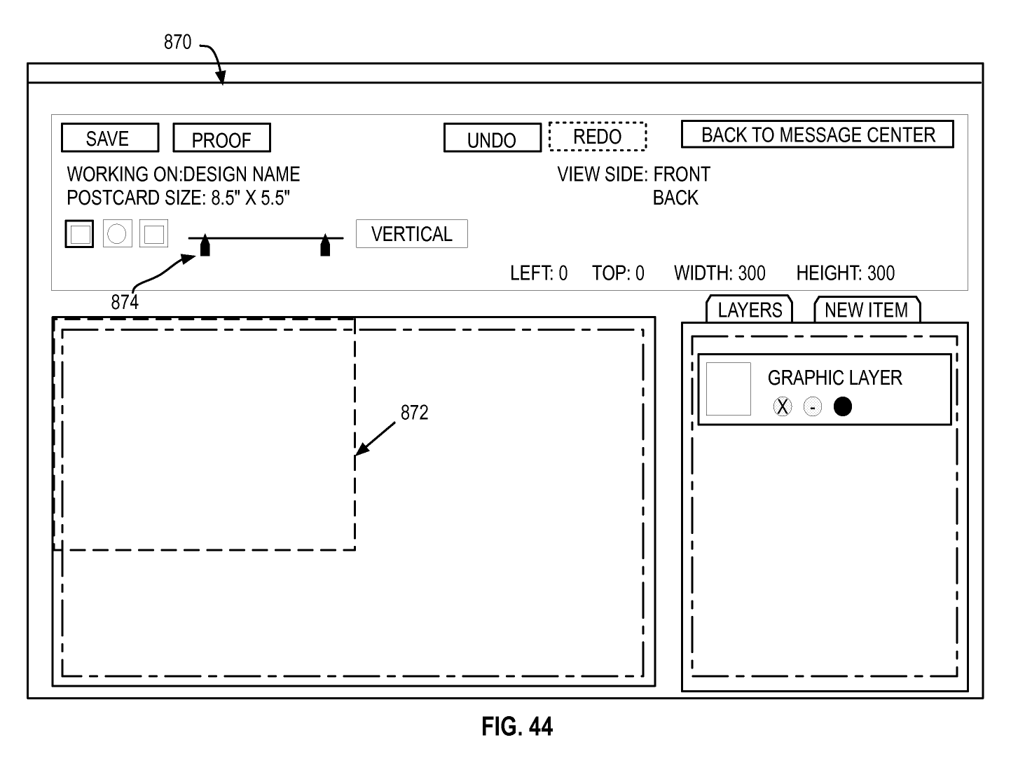

FIG. 44 is a simulated screen 870 for one implementation that illustrates adding a graphic layer that has a gradient effect. The gradient level of the rectangular graphic 872 can be adjusted using the gradient adjuster 874.

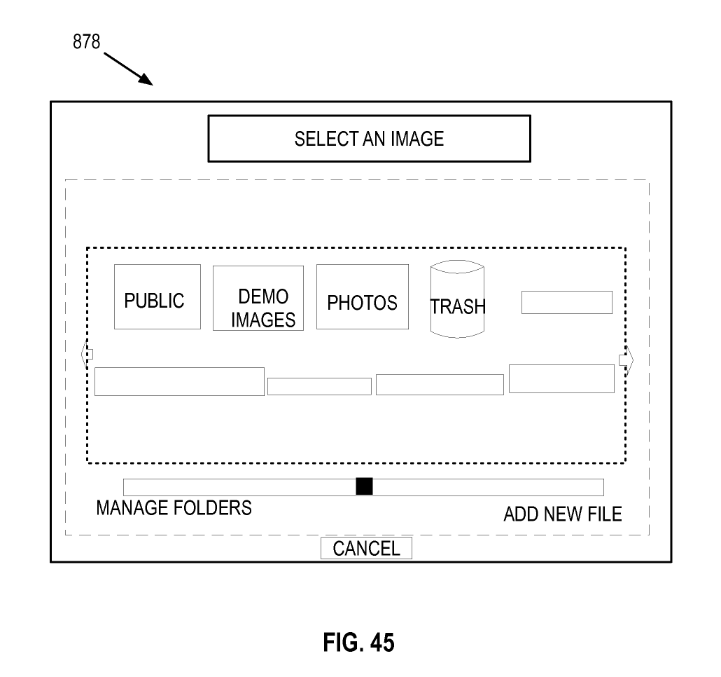

FIG. 45 is a simulated screen 878 for one implementation that illustrates selecting an image to insert in the designer. Once added, the selected image will be added to a new layer in the designer.

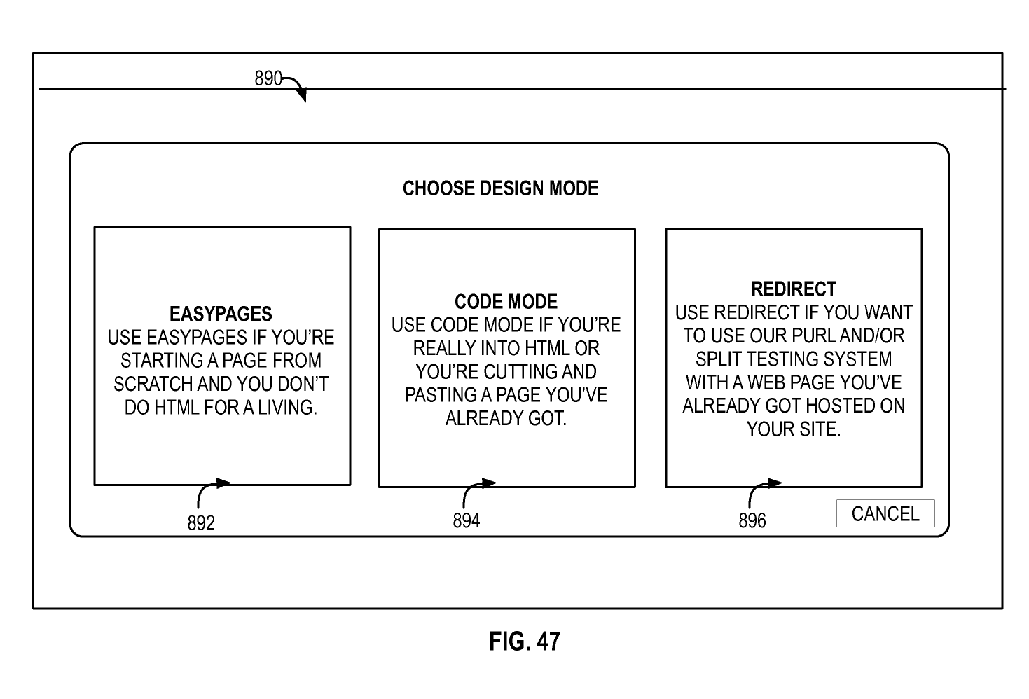

FIG. 46 is a simulated screen 880 for one implementation that illustrates a list of landing pages 882 that currently exist in the system. The list of landing pages 882 shows various details about each landing page, such as name, domain, number of visits, and percentage of conversions. Landing pages allow visitors of the site to view and/or request information that is tracked (at least in some part) by business automation system 100. Upon selecting an option to create a new landing page, a screen similar to FIG. 47 is displayed.

FIG. 47 is a simulated screen 890 for one implementation that illustrates selecting a type of landing page to create. In the example shown, there are three options: generate easy pages 892, code mode 894, and redirect 896. Each of these options will be described in the figures that follow.

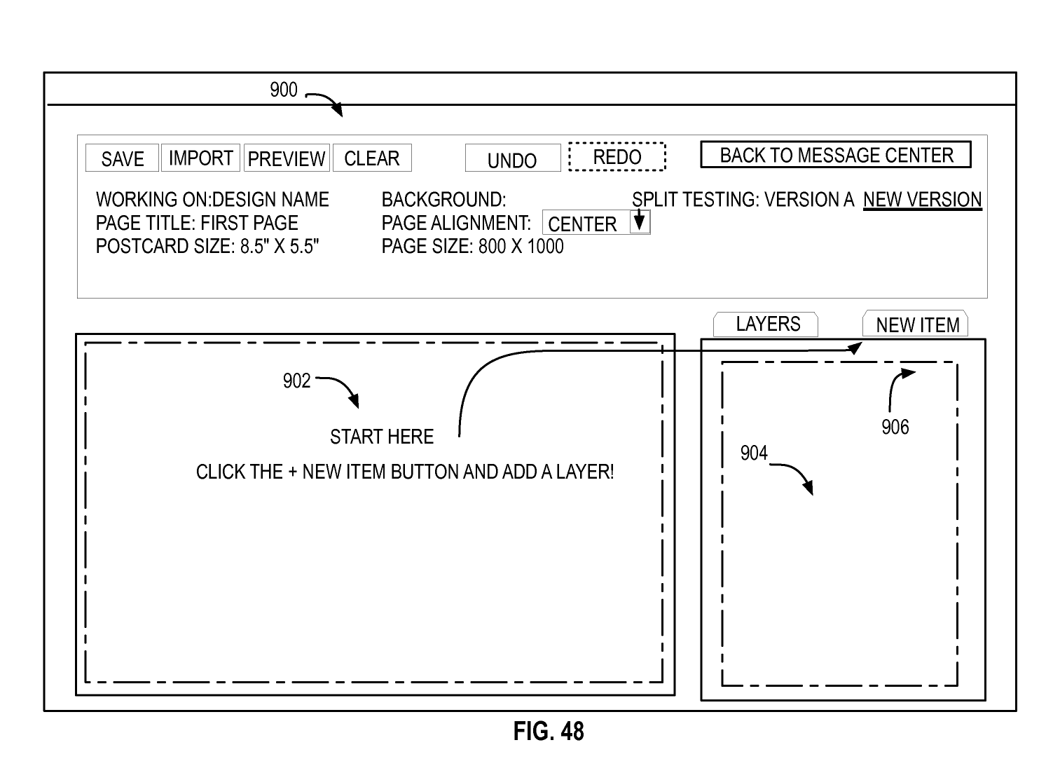

FIG. 48 is a simulated screen 900 for one implementation that illustrates a designer that can be used for creating a new landing page. The landing page designer contains a content area 902, the layers area 904, and add new item option 906, just as the designer for the post card included. In the examples shown herein, the landing page designer and the post card designer are different designers that are accessed from separate parts of business automation system 100. In other implementations, the two designers can be the same designer, and adapts depending on whether a landing page, post card, or other type of content is being generated.

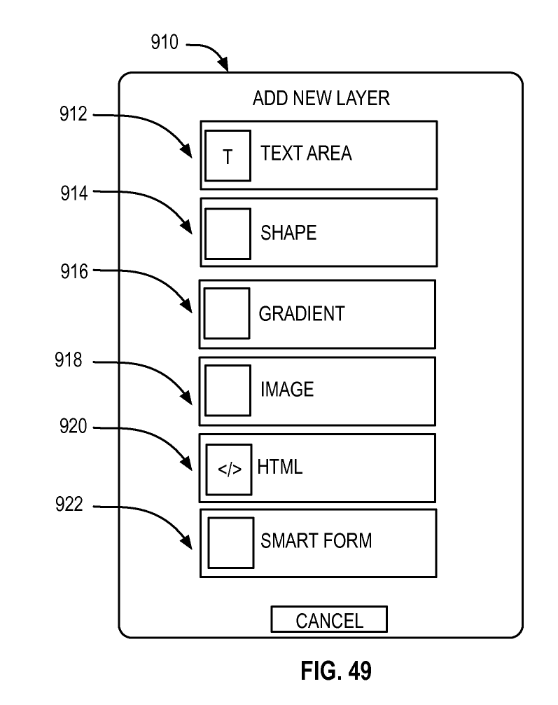

FIG. 49 is a simulated screen 910 for one implementation that illustrates adding a new layer into the designer for the landing page. The available layers that can be added to a landing page include a text area 912, shape 914, gradient 916, image 918, HTML code 920, and a smart form 922. The majority of these layers were already discussed in detail in earlier figures. Thus, the layers for HTML code 920 and smart form 922 will be discussed next.

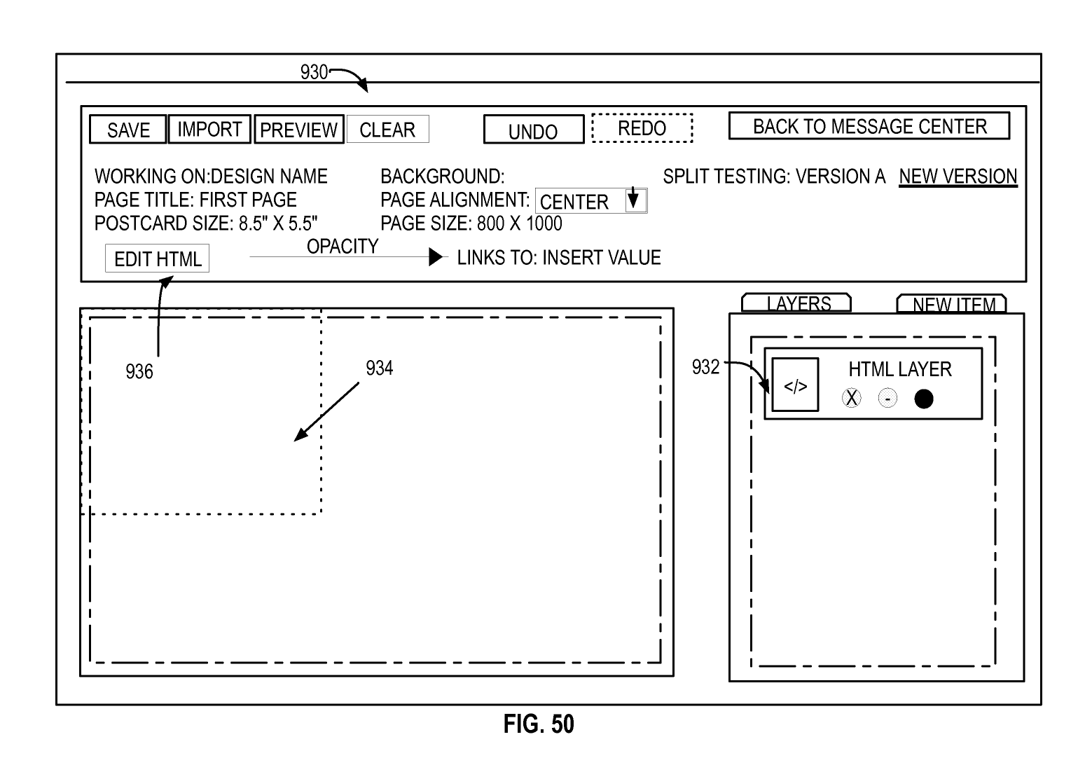

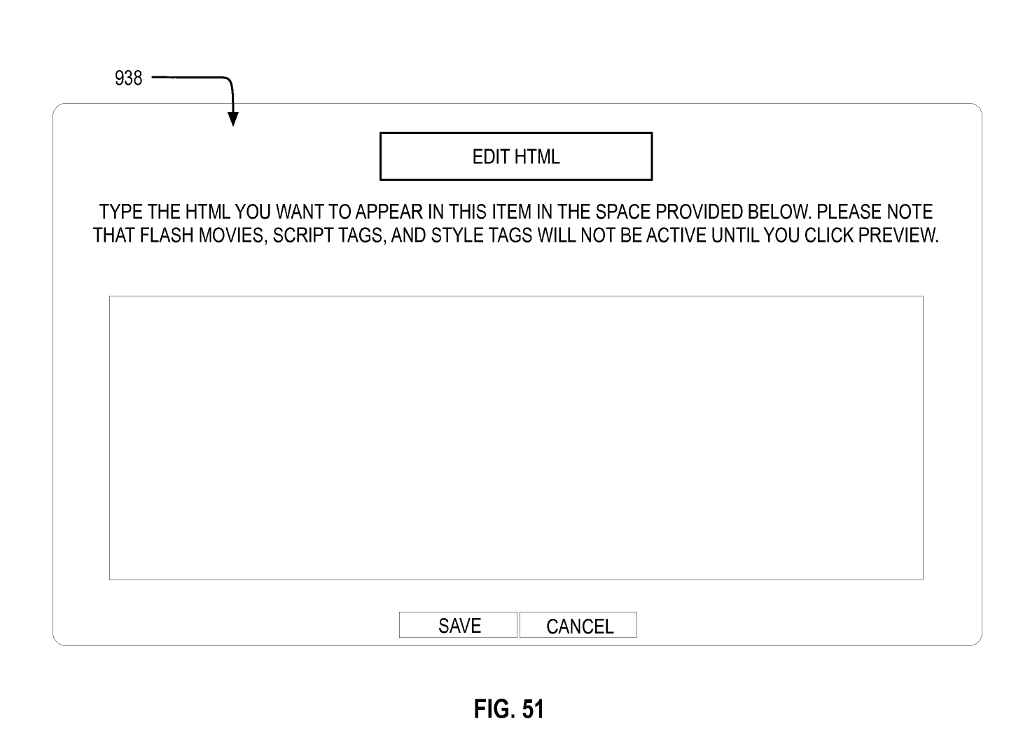

FIG. 50 is a simulated screen 930 for one implementation that illustrates adding an HTML layer 932 in the designer for the landing page. The contents 934 of the HTML layer 932 can be edited using one or more editing options 936. Upon double-clicking the contents 934 or selecting the edit HTML option, a screen similar to FIG. 51 is displayed to allow the HTML to be modified.

FIG. 51 is a simulated screen 938 for one implementation that illustrates adding HTML code to a selected HTML layer in the designer.

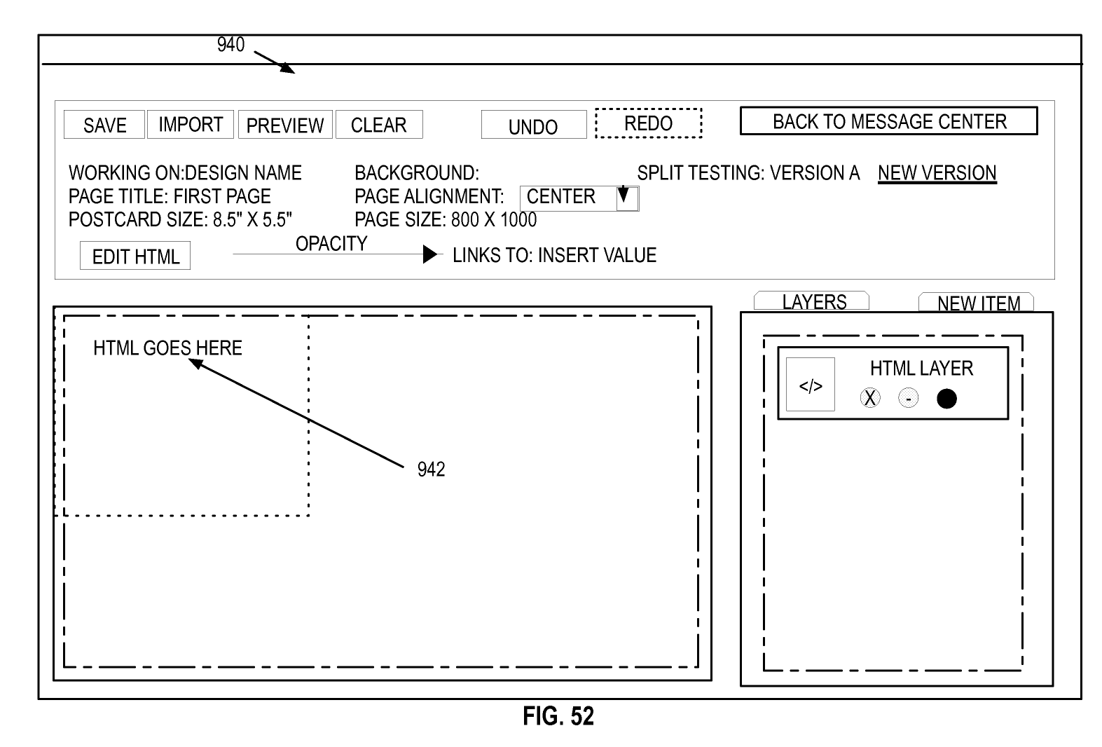

FIG. 52 is a simulated screen 940 for one implementation that illustrates the HTML being added to contents 942 of the layer.

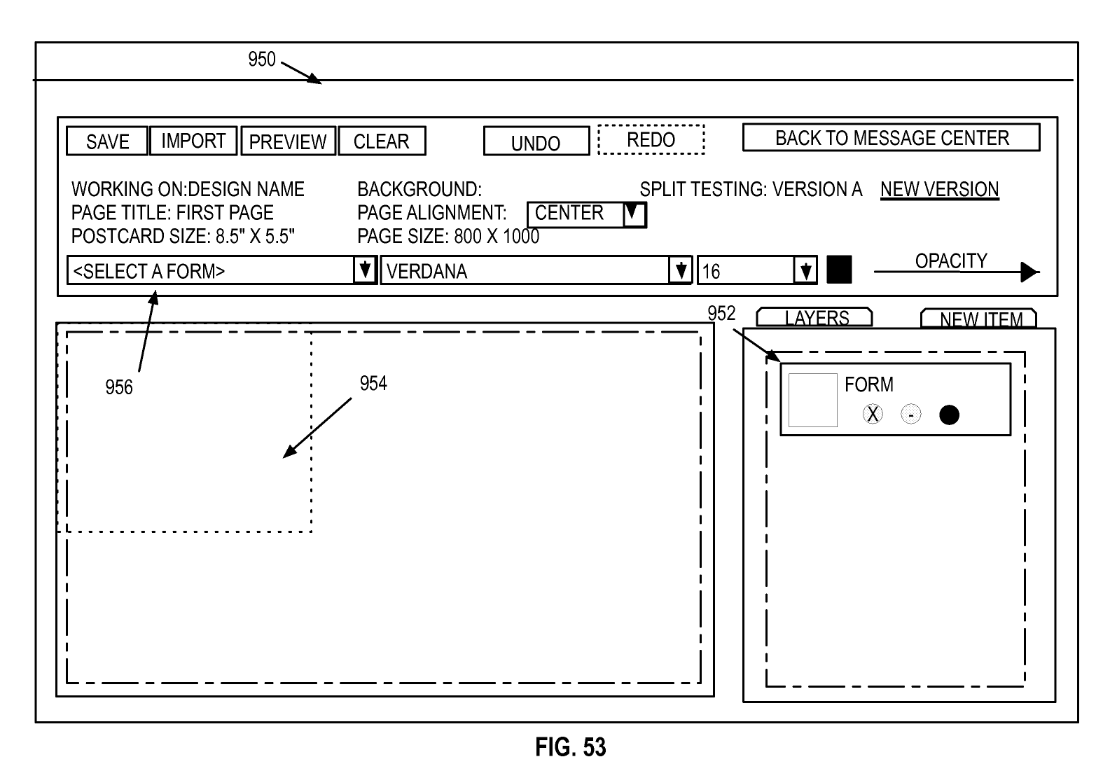

FIG. 53 is a simulated screen 950 for one implementation that illustrates adding a form layer 952 in the designer for the landing page. The contents 954 of the form layer 952 can be edited using one or more of the editing options 956. For example, a form from the system to associate this form with can be selected.

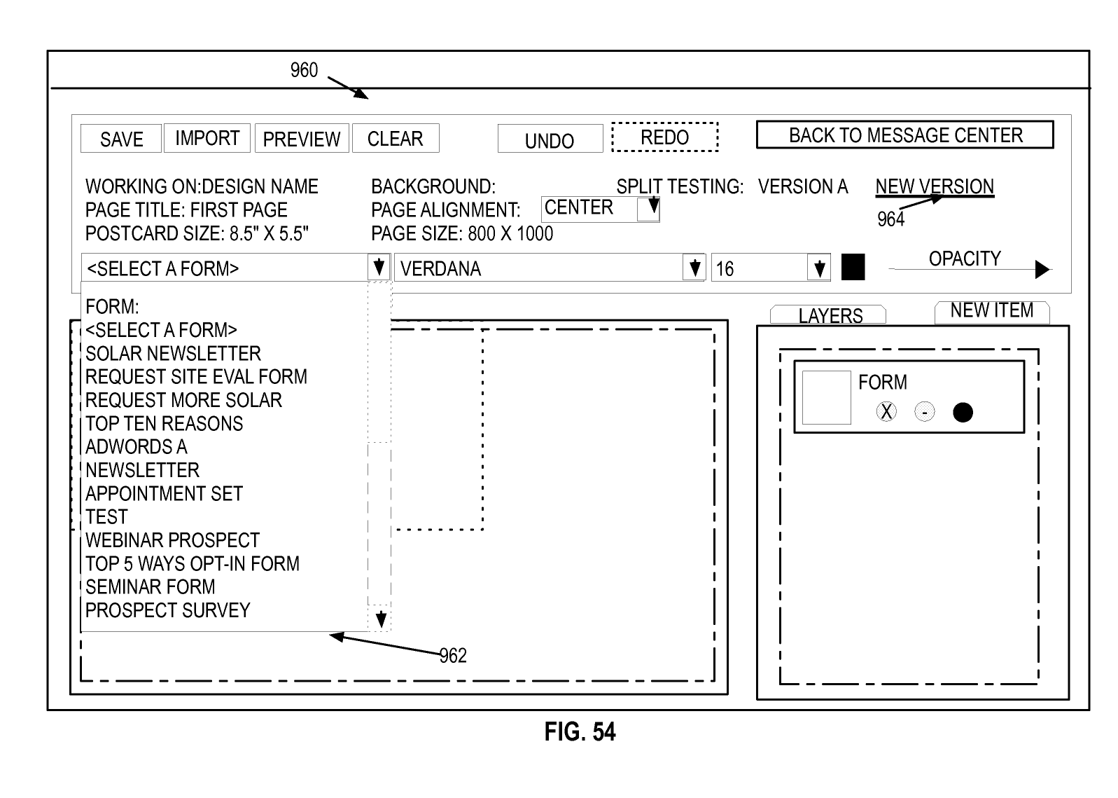

Some exemplary form options are displayed in simulated screen 960 in FIG. 54. In the example shown in FIG. 54, a form 962 to assign to the form layer is being specified. A split testing option is available for the form. Upon selecting new version option 964, a new version of the form can be created and used in split testing.

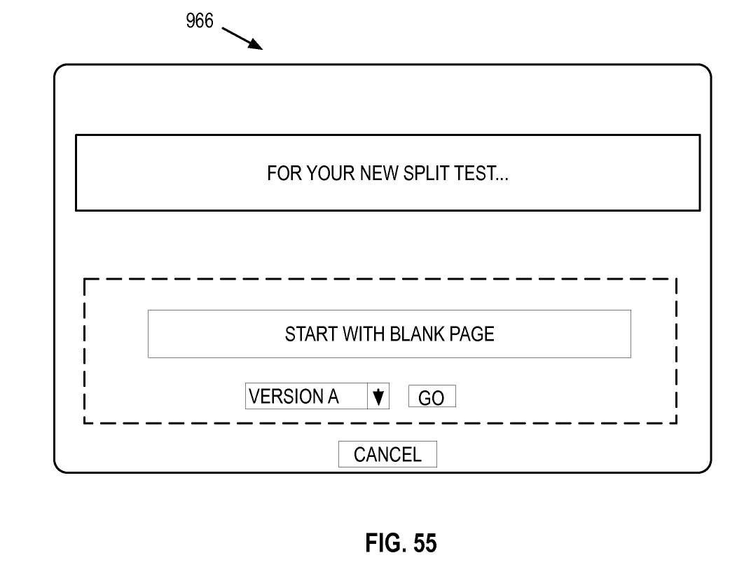

Simulated screen 966 of FIG. 55 is shown upon selecting the new version option 964. The options can then be specified for what to base the new split tested form on (a blank page, or another existing form).

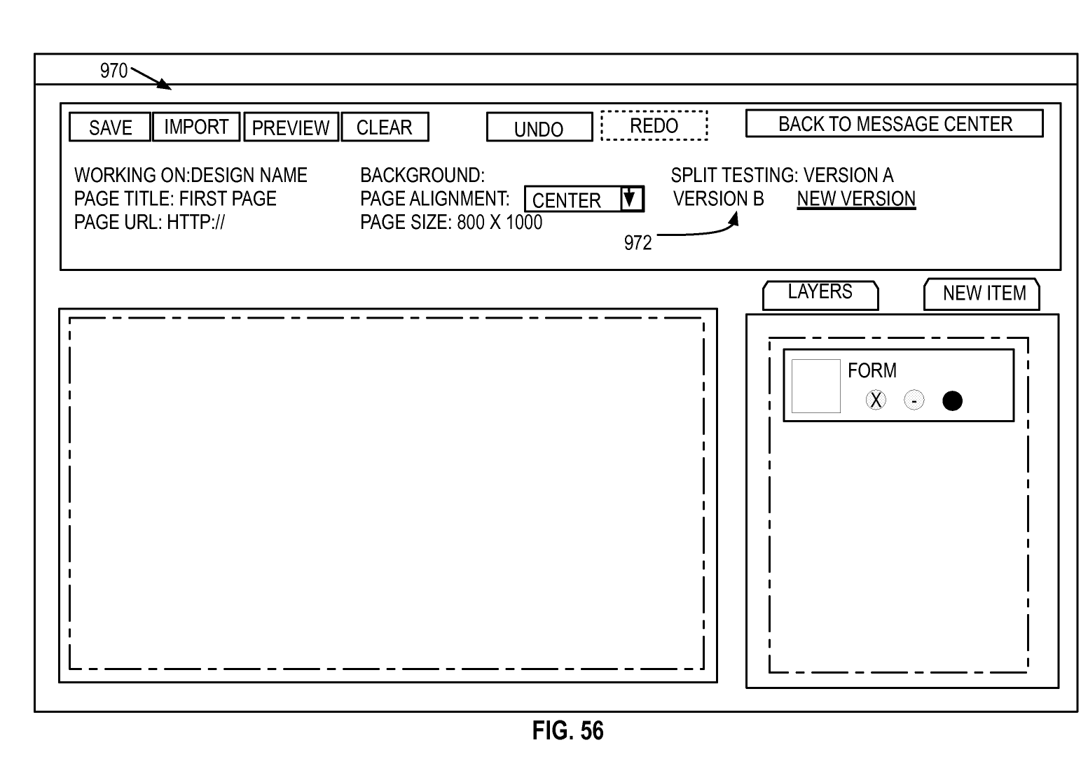

FIG. 56 is a simulated screen 970 for one implementation that illustrates the new landing page being added for the split test as version B 974. This version can be edited and saved, and tested against version A to see which one performs better.

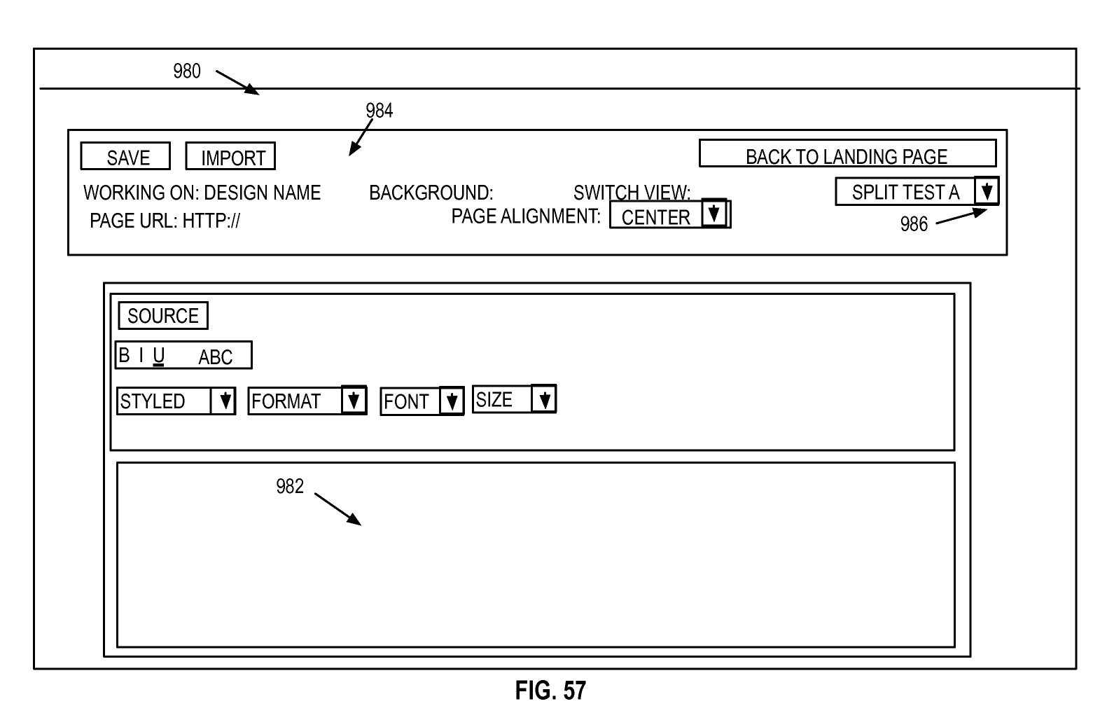

FIG. 57 is a simulated screen 980 for one implementation that illustrates creating a new HTML landing page. The HTML code 982 can be specified, along with various other page options 984. You can also split test the page and switch between pages 986 that are being tested.

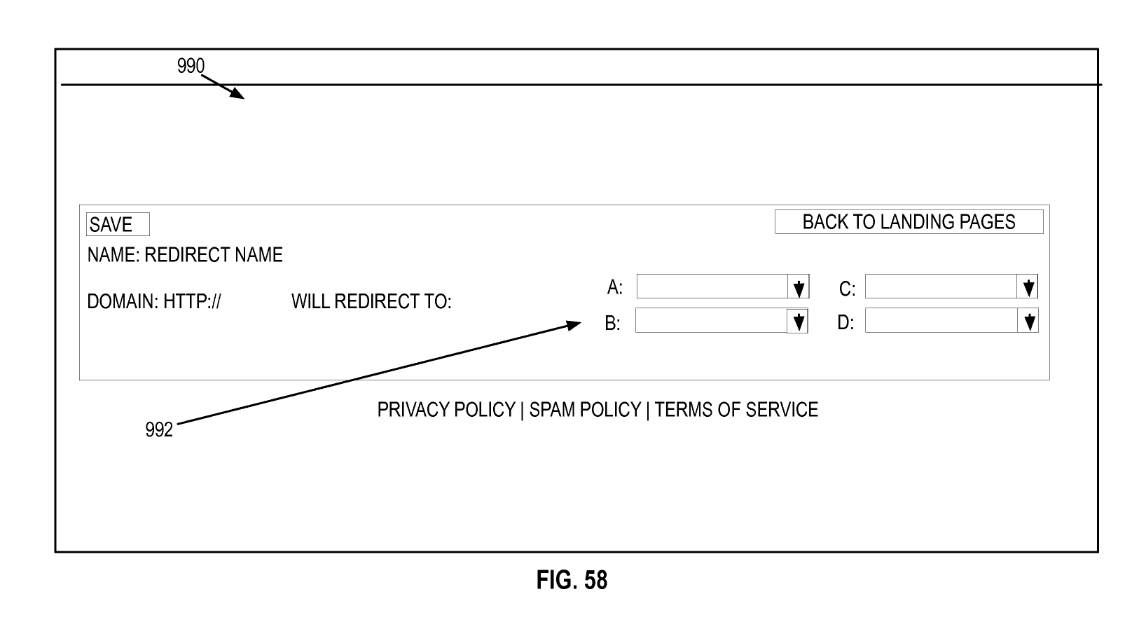

FIG. 58 is a simulated screen 990 for one implementation that illustrates creating a new landing page that redirects to one or more other pages 992. In the example shown, up to four redirects can be specified, and the business automation system 100 will perform split tests between any of the variations that are specified.

As shown in FIG. 59, an exemplary computer system to use for implementing one or more parts of the system includes a computing device, such as computing device 1000. In its most basic configuration, computing device 1000 typically includes at least one processing unit 1002 and memory 1004. Depending on the exact configuration and type of computing device, memory 1004 may be volatile (such as RAM), non-volatile (such as ROM, flash memory, etc.) or some combination of the two. This most basic configuration is illustrated in FIG. 59 by dashed line 1006.

Additionally, device 1000 may also have additional features/functionality. For example, device 1000 may also include additional storage (removable and/or non-removable) including, but not limited to, magnetic or optical disks or tape. Such additional storage is illustrated in FIG. 59 by removable storage 1008 and non-removable storage 1010. Computer storage media includes volatile and nonvolatile, removable and non-removable media implemented in any method or technology for storage of information such as computer readable instructions, data structures, program modules or other data. Memory 1004, removable storage 1008 and non-removable storage 1010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 1000. Any such computer storage media may be part of device 1000.

Computing device 1000 includes one or more communication connections 1014 that allow computing device 1000 to communicate with other computers/applications 1015. Device 1000 may also have input device(s) 1012 such as keyboard, mouse, pen, voice input device, touch input device, etc. Output device(s) 1011 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A system for automating business communications comprising:
a tracking module that is operable to track activity information regarding activities that are performed by a plurality of visitors to at least one web page being tracked, the tracking module being further operable to track a plurality of advertising channels that are used to send traffic to the at least one web page being tracked;
a contacts module that is operable to manage contact information for a plurality of contacts, the contacts module being further operable to present a display of at least a portion of the activity information that is related to at least one of the plurality of contacts;
an autopilot module that is operable to generate follow-up messages, including generating follow-up messages to at least one of the plurality of contacts; and
a tasks module that is operable to assign at least one task to at least one system user when a pre-defined event occurs.

2. The system of claim 1, wherein the activity information includes one or more activities that were performed by a respective contact of the plurality of contacts before the respective contact has provided any of the contact information.

3. The system of claim 2, wherein the activity information includes details about a particular web page that was visited by the respective one of the plurality of contacts, wherein the particular web page is one of the at least one web page that is being tracked.

4. The system of claim 2, wherein the activity information includes details about at least one product purchased by the respective contact.

5. The system of claim 2, wherein the activity information includes details about at least one incentive that was given to the respective contact in exchange for the contact information being provided by the respective contact.

6. The system of claim 2, wherein the contacts module is further operable to assign a lead score to at least a portion of the activity information that is being tracked for the respective contact, the lead score being assigned based upon pre-defined scoring criteria, and wherein further action is initiated related to the respective contact when the lead score reaches a pre-defined threshold.

7. The system of claim 1, wherein the autopilot module is operable to generate follow-up messages that are selected from the group consisting of email, print, task, rule, voice broadcast, and fulfillment item.

8. The system of claim 1, wherein the autopilot module is further operable to split test at least some of the follow-up messages so that a plurality of variations of a particular one of the follow-up messages can be sent to at least a portion of the plurality of contacts, and a respective performance of each of the plurality of variations can be tracked.

9. The system of claim 1, wherein the autopilot module is further operable to include a personalized URL on a particular one of the follow-up messages.

10. The system of claim 1, further comprising:
a messages module that allows at least one message to be defined that can be sent when a pre-defined criteria has been met; and
a pages module that allows at least one landing page to be created using a graphical user interface, and wherein the at least one landing page is operable to allow at least a portion of the contact information to be captured from at least one of the plurality of contacts.

11. The system of claim 1, further comprising:
an order module that is operable to allow at least one product to be ordered by at least one of the plurality of contacts;
an affiliate module that is operable to allow at least one affiliate to be credited with a sales commission; and
a membership site module that is operable to allow at least one of the plurality of contacts to access content on at least one membership site.

12. The system of claim 1, further comprising:
a dashboard module that is operable to present data for display that has been summarized from at least the order module and the autopilot module.

13. The system of claim 1, further comprising:
a messages module that allows at least one message to be defined that can be sent when a pre-defined criteria has been met;
a pages module that allows at least one landing page to be created using a graphical user interface, and wherein the at least one landing page is operable to allow at least a portion of the contact information to be captured from at least one of the plurality of contacts;
an order module that is operable to allow at least one product to be ordered by at least one of the plurality of contacts;
an affiliate module that is operable to allow at least one affiliate to be credited with a sales commission;
a membership site module that is operable to allow at least one of the plurality of contacts to access content on at least one membership site;
a direct mail module that is operable to allow at least one direct mail piece to be created using a graphical user interface and utilized by the autopilot module; and
a dashboard module that is operable to present data for display that has been summarized from at least the order module and the autopilot module.

14. A computer-readable medium having computer-executable instructions for causing a computer to perform steps comprising:
tracking activity information regarding activities that are performed by a plurality of visitors to at least one web page being tracked;
when a particular visitor of the plurality of visitors provides at least some contact information, associating the activity information for the particular visitor with a contact record of the particular visitor;
assigning a lead score to at least a portion of the activity information that is being tracked for the particular visitor, the lead score being assigned based upon pre-defined scoring criteria; and
initiating further action related to the particular visitor when the lead score reaches a pre-defined threshold.

15. The computer-readable medium of claim 14, wherein a communication is received from a tracking script that is installed on the at least one web page being tracked when the at least one web page is accessed by the particular visitor.

16. The computer-readable medium of claim 14, wherein the lead score for the particular visitor is decreased over time upon applying pre-defined degradation criteria.

17. The computer-readable medium of claim 14, wherein the further action includes assigning a task to a system user to request that the system user follow-up with the particular visitor to try and close a sale.

18. A computer-readable medium having computer-executable instructions for causing a computer to perform steps comprising:
providing a designer that enables the creation of at least one piece of content using a web browser, wherein a collection object is created in a script language and the collection object is used to track a plurality of layers of the piece of content, wherein style tags of a plurality of cascading style sheets are used to facilitate drag and drop operations, wherein an event listener listens for clicks and drags that occur on any of the plurality of layers in the piece of content, and wherein the event listener responds with an appropriate action based upon the events that are raised.

19. The computer-readable medium of claim 18, further having computer-executable instructions for causing a computer to perform steps comprising:
when the piece of content is a direct mail piece, making the direct mail piece available to an autopilot module that can generate follow-up messages to be sent to at least one contact.

20. The computer-readable medium of claim 19, further having computer-executable instructions for causing a computer to perform steps comprising:
upon receiving a request to generate a PDF proof of the direct mail piece, performing steps comprising:
parsing a font file;
scaling a font to be used in a PDF rendering based upon a source operating system;
laying out content that is contained in layers in the designer into the PDF proof; and
generating the PDF proof with embedded true type fonts.
